(19) United States
(12) Patent Application Publication
(10) Pub. No.: US 2015/0205930 A1
(43) Pub. Date: Jul. 23, 2015

(54) USER INTERFACE FOR ANALYTE MONITORING SYSTEMS

(71) Applicant: YOFIMETER, LLC, La Jolla, CA (US)

(72) Inventors: Jessica Shaanan, San Diego, CA (US); Marc Goldman, San Diego, CA (US); Kevin Bartig, San Diego, CA (US); Inhoe Kim, San Diego, CA (US); Gad Shaanan, San Diego, CA (US)

(21) Appl. No.: 14/418,918

(22) PCT Filed: Aug. 1, 2013
(86) PCT No.: PCT/US2013/053299

§ 371 Date: Jan. 30, 2015

Related U.S. Application Data
(60) Provisional application No. 61/678,570, filed on Aug. 1, 2012.

(51) Int. Cl. G06F 19/00; G06Q 50/22

(52) U.S. Cl. CPC G06F 19/3418; G06Q 50/22

(57) ABSTRACT

Methods, devices and systems are disclosed for implementing a user interface for analyte monitoring systems. In one aspect, the analyte monitoring systems of the present technology include an interactive graphical and audio user interface that enables a user to identify individual patterns and changes in the level of analytical substances found in a bodily fluid (e.g., blood, saliva, or urine) of a patient, as well as guide the patient as to what actions to take based on the analyte level, e.g., such as the timing and dosage of a medication, meal planning, physical activities, or other interventions.

### CROSS REFERENCE TO RELATED APPLICATIONS

This patent document claims the benefit of priority of U.S. Provisional Patent Application No. 61/678,570, entitled “ANALYTE MONITORING SYSTEMS,” filed on Aug. 1, 2012. The entire content of the aforementioned patent application is incorporated by reference as part of the disclosure of this application.

### TECHNICAL FIELD

This patent document relates to analyte monitoring technologies, including analyte monitoring systems designed for portable analyte measurement kits used by patients.

### BACKGROUND

Analyte testing and monitoring devices play a critical role in modern diagnosis and management of health-related issues. An analyte, or component (in clinical chemistry), is a substance or chemical constituent that is of interest in an analytical procedure. For example, a sample of human blood, urine, and/or saliva can be tested for glucose, fructosamine, hematocrit, hemoglobin blood oxygen saturation, lactates, iron, pH, cholesterol, liver enzymes (e.g., aspartate aminotransferase (AST), alanine aminotransferase (ALT), alkaline phosphatase (ALP)/gamma glutamyl transferase (GGT), lactate dehydrogenase (LDH), bilirubin, etc.), hormones, and/or other compounds.

### SUMMARY

Techniques, systems, and devices are disclosed for implementing a user interface for analyte monitoring systems.

In one aspect, a method for presenting patient information on a computing device includes processing health information of a patient using one or more computer processors of a computer or computer system in a communication network operating a web portal, in which the health information includes the patient's analyte levels measured from an analyte meter device and health-related factors, and providing an interactive user interface based on the web portal to present at least some of the processed health information on a computing device of a user and to enable user interaction, the interactive user interface including a plurality of data modules that organize the processed health information. The data modules include an analyte level module to provide one or both of a recent measurement and a history of the measured analyte levels, a medication module to provide medication data of one or more medications being taken by the patient including at least one of a medication name or identifier, medication type taken, a date and time taken, and a dosage taken, a nutrition module to provide carbohydrate intake data by the patient, and a fitness module to provide fitness data including at least one of a number of steps taken or duration of exercise performed by the user.

Implementations of the method can optionally include one or more of the following features. For example, the user can include one of the patient, a healthcare provider, a caregiver, a health data manager, and/or a healthcare payer. For example, the computing device of the user can include a desktop or laptop computer device, a mobile communications device including a smartphone or tablet, and/or an analyte meter device. For example, the interactive user interface can enable the user to (1) select a data history of the health information based on a user-selected time span, (2) personalize settings of the analyte meter device, (3) flag particular data of the health information in the data modules, and/or (4) submit questions related to particular data of the health information in the data modules. In some implementations, for example, the method can further include receiving patient goal information including a threshold corresponding to the health information in at least one of the data modules, and processing the patient goal information to analyze the threshold with respect to the corresponding health information. For example, the patient goal information can be organized in a goal module of the plurality of data modules. In some implementations, for example, the method can include generating an alert when a data value of the health information exceeds the corresponding threshold of the patient goal information. In some implementations of the method, for example, providing the interactive user interface can include displaying on a display screen of the computing device (i) summarized health information for each of the data modules, (ii) a graphical analysis of the health information from one or more of the data modules, and/or (iii) selection buttons corresponding to the data modules for selection of the health information to be displayed as the graphical analysis. For example, the displayed graphical analysis can include user-interactive tags that allow for the user to add at least one of text, images, or audio data. For example, the medication data of the medication module can include instructions for taking the one or more medications by the patient. In some implementations of the method, for example, acquiring the health information can include collecting step data obtained by a pedometer unit of the analyte meter device that records the number of steps taken, e.g., in which the collected step data organized in the fitness module. In some implementations, for example, the plurality of data modules can include a journal module to provide journal data including one or both of user input data including text, images, or audio data and a snapshot image of the interactive user interface displayed on a display screen of the computing device. For example, providing the interactive user interface can include displaying on a display screen of the computing device (i) a dialog box to allow a user to enter text of the user input data, (ii) a listing of the journal data having a corresponding time and date to when the journal data was entered in the journal module, and/and (iii) a search box to allow a user to enter text to be searched in the journal data. In some implementations, for example, the plurality of data modules can include a report module to export at least some of the health information based on user selection to an external file including tables, textual descriptions, graphs, or combinations thereof, wherein the user selects a time period and type of the health information to be included in the external file.

Implementations of the method can also optionally include one or more of the following features. For example, the measured analyte levels can include blood glucose levels and the one or more medications include insulin. In some implementations of the method, for example, processing the health information can include analyzing the health information to determine a correlation between actual measured glucose levels and their level of fluctuations and a correlation between the actual measured glucose levels and the health-related factors including one or more of carbohydrate consumption, amount of injected insulin, non-insulin medications taken by the patient, amount of exercise, an episode of stress, or an episode of an illness. For example, in some implementations, the method can further include processing the correlation to generate an alert when a particular data value (e.g., blood glucose level) exceeds a predetermined threshold. For example, the alert can be in the form of a text message, a phone call, an email, and/or a visual message or audio alarm on an application of the computing device or the analyte meter device. For example, in some implementations, the method can further include processing the correlation to generate an alert when an event does not occur when expected. For example, in some implementations, the method further can include monitoring the amount of consumable components in the analyte meter device. For example, in some implementations, the method can further include determining when the amount of consumable components reaches a predetermined minimum threshold, and ordering a quantity of the consumable components based on the amount, in which the ordering is performed by the analyte meter device, the computer or the computer system operating the web portal, or a mobile computer device operating an application in communication with the web portal. For example, in some implementations, the method can further include recognizing when the analyte meter device enters a different time zone, and updating programmed alerts and time stamping information based on the different time zone. For example, in some implementations, the method can further include transmitting data updates of data of the web portal to the analyte meter device, the data updates including at least one of prescription information, dietary information, patient goal information, or user settings or profile information. In some implementations, for example, the interactive user interface can include a patient-accessible interface for access by the patient to manage the health information of the patient, and a caregiver-accessible interface for access by a healthcare provider or caregiver to manage the health information of the patient and one or more other patients. For example, the interactive user interface can be an integrated graphical and audio user interface.

In another aspect, a computer program product comprising a computer-readable storage medium having code stored thereon is disclosed, in which the code, when executed, causes a processor of a computer or computer system in a communication network to implement a method for presenting patient information on a user device via a web portal. The computer program product, when implemented, is operated by the computer or computer system to cause the processing of health information of a patient including analyte levels measured from an analyte meter device and health-related factors, in which the health information is acquired by the computer or computer system in the communication network via a communications link, and the providing of an interactive user interface based on the web portal to present at least some of the processed health information on a computing device operated by a user and to enable user interaction, the interactive user interface including a plurality of data modules that organize the processed health information. The data modules include an analyte level module to provide one or both of a recent measurement and a history of the measured analyte levels, a medication module to provide medication data of one or more medications being taken by the patient including at least one of a medication name or identifier, medication type taken, a date and time taken, and a dosage taken, a nutrition module to provide carbohydrate intake data by the patient, and a fitness module to provide fitness data including at least one of a number of steps taken or duration of exercise performed by the user. In some implementations of the computer program product, the computer program product, when implemented, is operated by the computer or computer system to cause the displaying on a display screen of the computing device of (i) summarized health information for each of the data modules, (ii) a graphical analysis of the health information from one or more of the data modules, (iii) a selection list of tags corresponding to the data modules that allow for the user to add at least one of text, images, or audio data as time-tagged data presented proximate the graphical analysis, and (iv) selection buttons corresponding to the data modules for selection of the health information to be displayed as the graphical analysis.

In another aspect, a health management system includes an analyte monitoring device to measure a concentration level of an analyte and a computing system in communication with the analyte monitoring device. The computing system includes a memory unit and a processor configured to process data including health information of a patient comprising measured analyte concentration levels and health-related factors. The computing system is configured to provide an interactive user interface to present at least some of the processed health information on a computing device of a user and enable user interaction, the interactive user interface including a plurality of data modules that organize the processed health information, in which the data modules include an analyte level module to provide one or both of a recent measurement and a history of the measured analyte levels, medication module to provide medication data of one or more medications being taken by the patient including at least one of a medication name or identifier, medication type taken, a date and time taken, and a dosage taken, a nutrition module to provide carbohydrate intake data by the patient, and a fitness module to provide fitness data including at least one of a number of steps taken or duration of exercise performed by the user.

The subject matter described in this patent document can be implemented in specific ways that provide, among other features, one or more of the following features. For example, the disclosed embodiments can include a glucose monitoring and insulin treatment system that includes a glucose meter (e.g., glucometer) device that can be configured to have a compact, all-in-one (e.g., lancet/strip/meter) structure, be cassette based, include web-based tracking services, and include wireless communication devices and components that are seamlessly integrated to enhance the user's interaction and usage of the system. For example, the glucose monitoring and insulin treatment system includes a devices that can be utilized discretely in public settings. The disclosed embodiments include a user interface that can be accessed by each of a variety of users, e.g., including a patient (e.g., a diabetic person), a healthcare provider and/or caregiver (e.g., a doctor, nurse, medical assistant, or family member), a health data manager, and a payer (e.g., an insurance company) to facilitate the sharing of information and to enhance the quality of care. For example, the analyte monitoring user interface of the disclosed embodiments can enable the user to identify individual patterns and changes in the level of analytical substances found in a bodily fluid (e.g., blood, saliva, or urine) of a patient, as well as guide (e.g., provide pertinent info/test data to support guidance) the user (e.g., patient, care taker, doctor, etc.) as to what actions to take based on the analyte level, e.g., such as the timing and dosage of a medication, meal planning, physical activities, or other interventions.

### BRIEF DESCRIPTION OF THE DRAWINGS

FIG. 1 shows a diagram of an exemplary multi-step process to monitor an analyte level in one's blood using conventional monitoring techniques, devices, and systems.

FIG. 2A shows diagram of an exemplary analyte meter device of the disclosed embodiments for monitoring at least one analyte level in a user's blood.

FIG. 2B shows a diagram of an exemplary process to implement the exemplary analyte meter device shown in FIG. 2A to monitor an analyte level in the blood.

FIG. 3A shows a diagram of an exemplary analyte meter device in communication with a mobile device and computer device operating a web portal.

FIG. 3B shows a diagram of the exemplary analyte meter device of FIG. 3A that includes a user interface for analyte level monitoring and health information management.

FIG. 3C shows a diagram of the exemplary mobile device of FIG. 3A that includes a user interface for analyte level monitoring and health information management.

FIG. 3D shows a diagram of the exemplary computer device of FIG. 3A that includes a user interface for analyte level monitoring and health information management.

FIG. 3E shows an exemplary login page of the exemplary user interface shown on the display screen of the computer device in FIG. 3D.

FIG. 4 shows a diagram of an exemplary user interface on a display screen of an exemplary analyte meter showing instructive steps of an exemplary glucose monitoring process.

FIG. 5 shows a diagram of an exemplary user interface on a display screen of the analyte meter showing a main menu interface.

FIG. 6 shows an exemplary interactive user interface showing a functional interactive interface for a user to manage health information.

FIGS. 7A-7J show exemplary display screens of an exemplary account set-up and management module of the exemplary interactive user interface.

FIGS. 8A and 8B show exemplary display screens of an exemplary patients list module of the exemplary interactive user interface.

FIGS. 9A-9E show exemplary display screens of an exemplary measured analyte level module of the exemplary interactive user interface.

FIGS. 10A-10E show exemplary display screens of an exemplary medication module of the exemplary interactive user interface.

FIGS. 11A and 11B show exemplary display screens of an exemplary nutrition module of the exemplary interactive user interface.

FIGS. 12A-12E show exemplary display screens of an exemplary fitness module of the exemplary interactive user interface.

FIGS. 13A-13D show exemplary display screens of an exemplary goals module of the exemplary interactive user interface.

FIGS. 14A and 14B show exemplary display screens of an exemplary journal module of the exemplary interactive user interface.

FIGS. 15A-15H show exemplary display screens of an exemplary reports module of the exemplary interactive user interface.

FIGS. 16A-16F show exemplary display screens of an exemplary meter interface module of the exemplary interactive user interface.

FIGS. 17A-17D show exemplary display screens of an exemplary patient information module of the exemplary interactive user interface.

FIG. 18 shows an exemplary display screen of an exemplary help module of the exemplary interactive user interface.

FIGS. 19A and 19B show exemplary display screens of an exemplary account and billing information module of the exemplary interactive user interface.

FIGS. 20A and 20B show exemplary display screens of an exemplary mobile software application to implement the disclosed interactive user interface on a mobile device.

FIGS. 21A-21J show examples of display screens of the exemplary interactive user interface implemented on a mobile device.

FIGS. 22A-22C show schematic diagrams of an exemplary analyte meter device showing some of the internal components of the device.

FIG. 23A and 23B show exemplary software block diagrams for an analyte monitoring system.

FIG. 24 shows a process diagram of an exemplary method for providing an interactive user interface to present analyte test level data, medication, nutrition, activity, and other health-related information.

Like reference symbols and designations in the various drawings indicate like elements. Additionally, in some of the exemplary graphs and images shown in the figures, the data shown does not represent actual data points, but rather is provided to illustrate the various functionalities and operations of the disclosed embodiments.

### DETAILED DESCRIPTION

The devices, systems and technologies described in this patent document can be implemented to measure properties of analytes such as glucose concentration in blood samples. Various glucose meters and lancing devices on the market today tend to involve multiple devices, components, and supplies, and often require numerous steps to monitor glucose levels. When such devices are designed for patient uses outside the clinical settings or hospitals, the complexity in operating the devices and performing the measurements may lead to patient operation errors and false data and may also cause patient frustration and reluctance in routine use of such devices. For example, some glucose monitoring systems may require numerous steps involving reading a test strip, readying a lancet, using the lancet, putting blood on the test strip and inserting the strip into the glucose meter, reading data from a meter, recording the data in a journal and remembering to bring the journal to the next doctor visit, and then putting away the strip and lancet packages, disposing of loose components, and storing the glucose meter. Thus, it would be beneficial to patients, caregivers, and payers to reduce steps, consolidate devices, and simplify user interfaces for monitoring analytes, e.g., such as glucose in the blood.

Techniques, systems, and devices are disclosed for implementing a user interface for analyte monitoring systems that are easy and convenient to use for patients to improve patient compliance in performing routine measurements, to reduce health risks to patients and to improve the well-being of patients.

In one aspect, the disclosed analyte monitoring user interface can enable a user to identify individual patterns and changes in the level of analytical substances (analytes) found in the patient's bodily fluid (e.g., blood, saliva, or urine), as well as present data and/or guide a user (e.g., patient, care taker, doctor, etc.) as to what actions to take based on the analyte level. For example, these actions can be based on, or include, the timing and dosage of a medication, meal planning, physical activities, or other interventions.

While the disclosed embodiments are described herein primarily based on glucose monitoring to facilitate understanding of the underlying concepts, it is understood that the disclosed embodiments can also include monitoring of other analytes that include, but are not limited to, fructosamine, hematocrit, hemoglobin blood oxygen saturation, lactates, iron, pH, cholesterol, liver enzymes (e.g., AST, ALT, ALP/GGT, LDH, bilirubin, etc.), hormones, and other compounds. For example, other biomolecular substances can also be monitored using analytical monitoring techniques of the disclosed embodiments, which include, but are not limited to, nucleic acids, lipids, carbohydrates, peptides, proteins, enzymes, hormones, antibodies, glycoproteins, glycolipids, organelles, endotoxins, and viruses, among other biological materials and biomarkers.

The disclosed interactive user interface can include functional modules implemented in software and executed on any of a variety of devices to be operated by one or more types of various users, e.g., such as a patient (e.g., a diabetic person), a healthcare provider and/or caregiver (e.g., a doctor, nurse, doctor's or nurse's aide, or a family member or friend), a health data manager, and a payer (e.g., an insurance company). For example, the disclosed interactive user interface can be managed by a computer system in a communication network in communication with user devices via wired and/or wireless communication links. For example, the types of devices to implement the user interface for analyte monitoring can include an analyte meter device, a mobile device (e.g., smart phone, tablet, laptop computer, etc.), and a semi-mobile or non-mobile device (e.g., personal computer (PC) such as a desktop, laptop, or other computer system) operating a web portal to facilitate the sharing of information between the devices and a database that stores user data. For example, the web portal can be implemented on a computing device via a web browser or a software application. For example, the web portal can also be implemented on the mobile device. In the simplest form, such a device includes at least one processor (e.g., a microprocessor) and at least one memory that is in communication with the processor. The memory can, for example, include processor executable code, which when executed by the processor, configures the device to perform various operations, such as receiving information, commands, and/or data, processing information and data, and transmitting or providing information/data to another entity or to a user.

Some of the exemplary embodiments described herein relate to analyte monitoring user interface illustrating exemplary features and functionality of various interface modules, as well as the interaction of the devices that can implement the user interface.

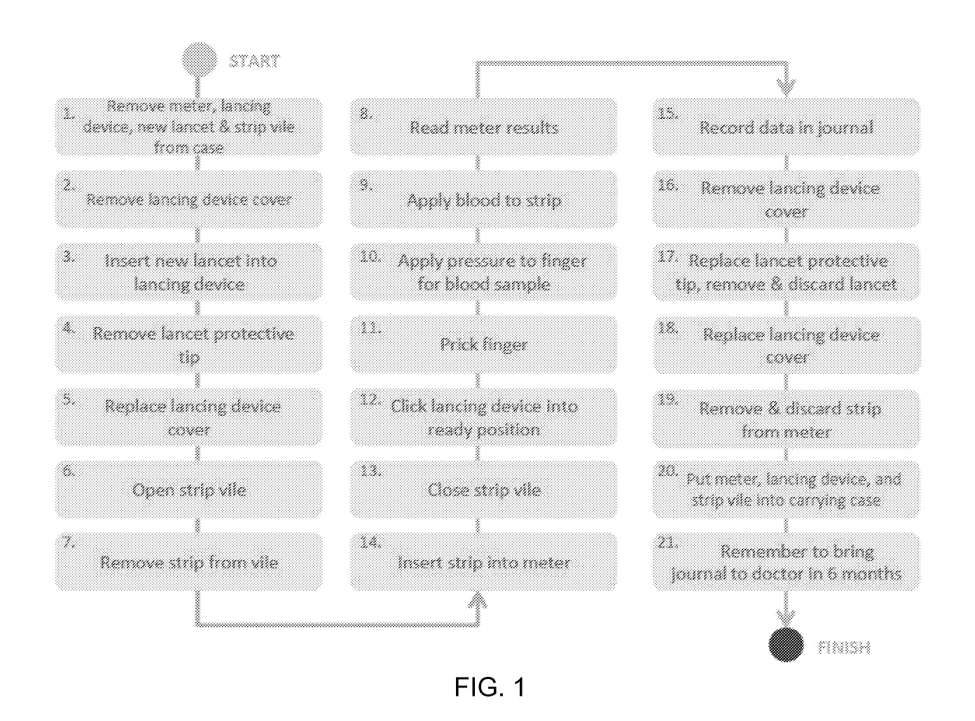

FIG. 1 shows a diagram of an exemplary multi-step process to monitor an analyte level in one's blood using conventional monitoring techniques, devices, and systems. For example, the exemplary multi-step process includes greater than 20 steps to monitor the analyte level in one monitoring instance (e.g., which may need to be implemented two to ten or more times per day).

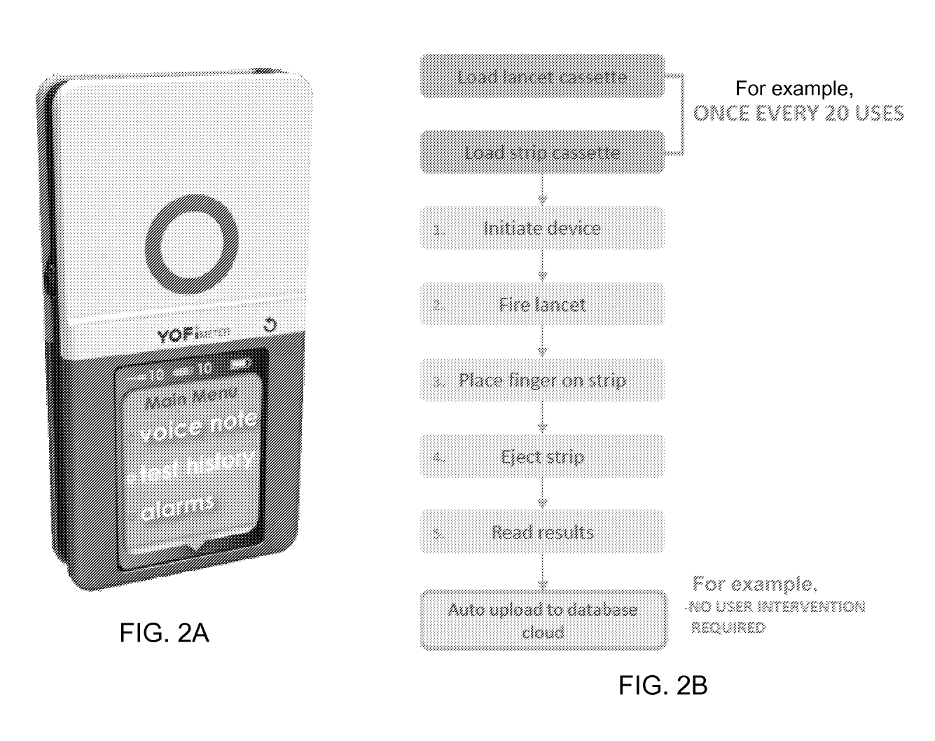

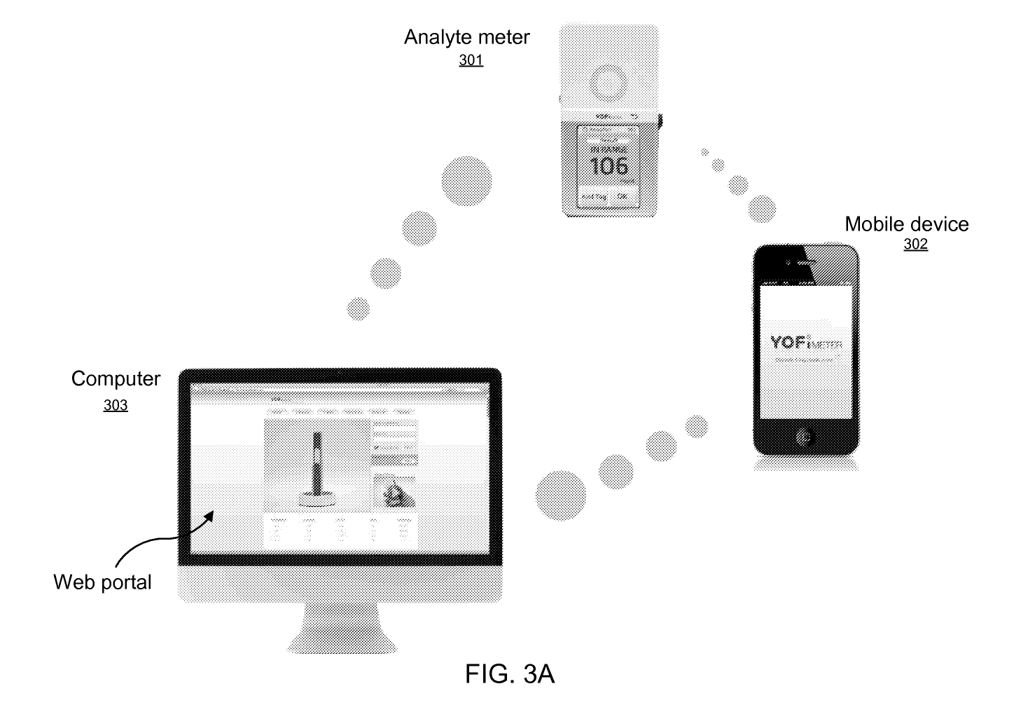

FIG. 2A shows a diagram of an exemplary analyte meter device of the disclosed embodiments for monitoring at least one analyte level in a user's blood. Some examples of the analyte meter devices of the present technology are disclosed in U.S. patent application Ser. No. 13/689,618 entitled “ANALYTE TESTING DEVICES”, filed on Nov. 29, 2012, which is incorporated by reference in its entirety as part of the disclosure in this patent document. In the example depicted in FIG. 2A, the exemplary analyte meter device includes a compartment for storing a lancet cartridge and a compartment for storing an analyte sensor cartridge. The analyte sensor cartridge contains test units each having an analyte sensor for contacting and sensing a particular analyte such as glucose. The lancet cartridge stores a plurality of lancets to allow a lancet to be protruded at a hole of the device during an analyte test. The exemplary analyte meter device includes an electronics compartment for housing conversion electronics communicatively coupled to an analyte sensor within analyte sensor cartridge. The conversion electronics is configured to convert a signal from analyte sensor into measured analyte level data (e.g., blood glucose levels). The conversion electronics is configured to display, e.g., an LCD display, that can be used to display analyte test results measured by the meter device (e.g., including recent test results and test history), as well as other data useful for monitoring analytes including, but not limited to, for example, supplies used/remaining (e.g., including test strips and lancets); estimated steps taken and/or calories burned by the user; time/date, history of medications administered (e.g., including insulin); device settings; alarms; and journal entries and notes (e.g., including voice/audio notes, text or image notes). Data processing of the analyte test results and other data useful for monitoring analytes can be offloaded to a computer or computer systems for processing and storage.

FIG. 2B shows a diagram of an exemplary process to utilize the exemplary analyte meter device shown in FIG. 2A to monitor an analyte level in the blood. For example, the process includes five steps to monitor the analyte level in one monitoring instance. For example, the analyte meter device can be implemented by initiating the device, firing a lancet of the device (and drawing a user's blood with the lancet), placing a finger on an analyte test strip of the device, ejecting the test strip, and reading the results. The results can be uploaded to a database of a computer system, e.g., a database including a data storage medium stored on the computer system, in a communication network (e.g., sometimes referred to as ‘the cloud’) and capable of operating the web portal. In some examples, the uploading can be performed automatically by the device. The ease of use and facility of the various embodiments that are described herein can be appreciated by comparing the number of steps (i.e., 20) in the conventional methodologies in FIG. 1 versus the number of steps (e.g., 5) associated with the exemplary embodiment of FIG. 2A.

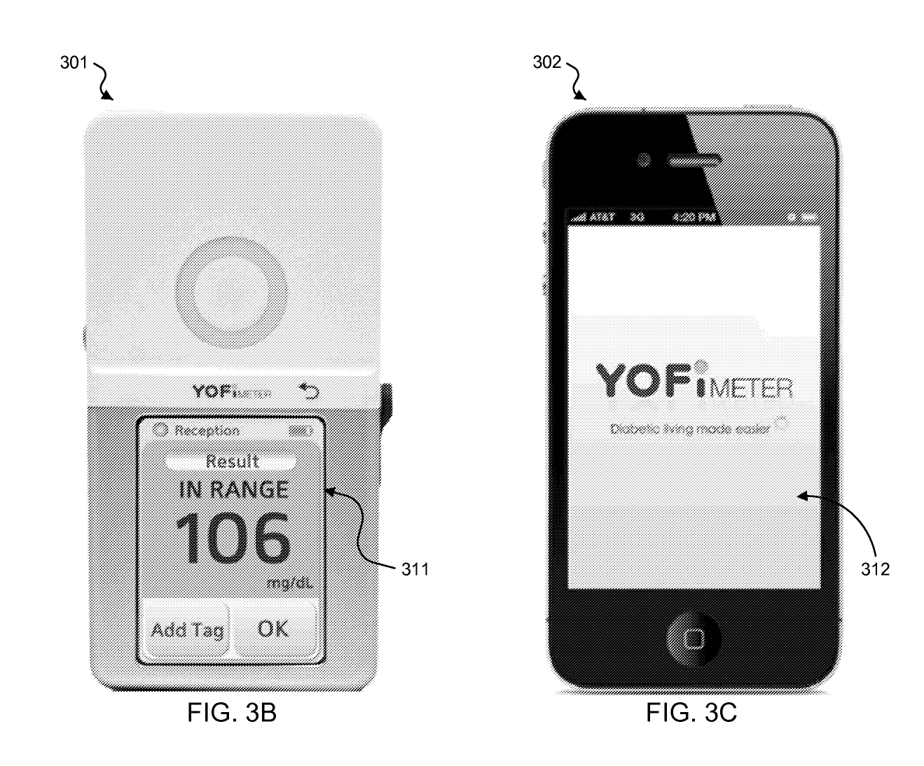

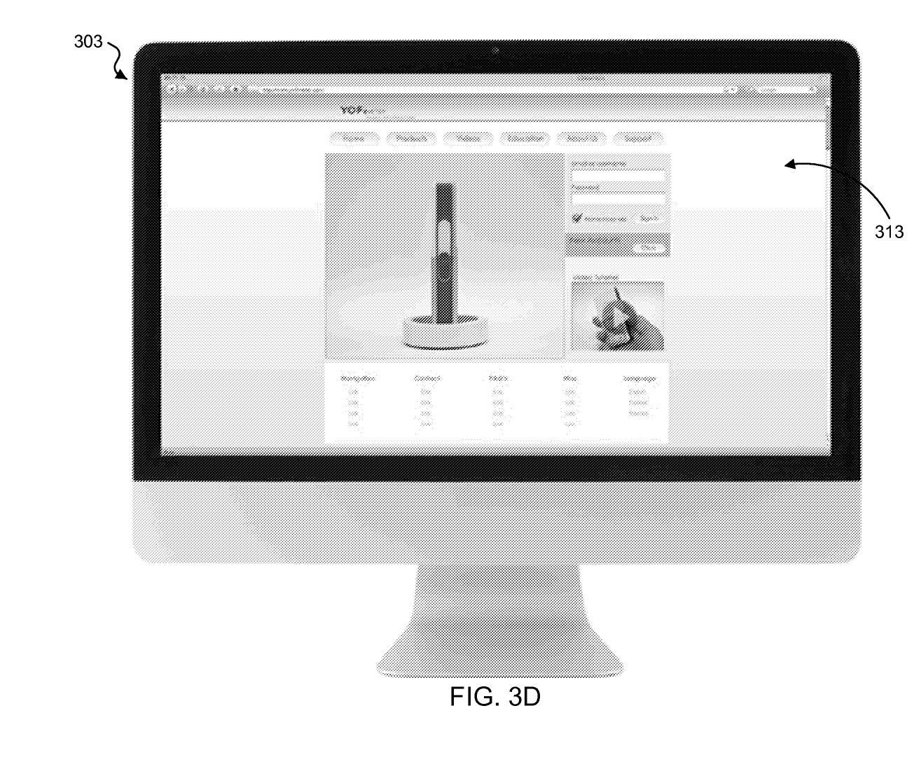

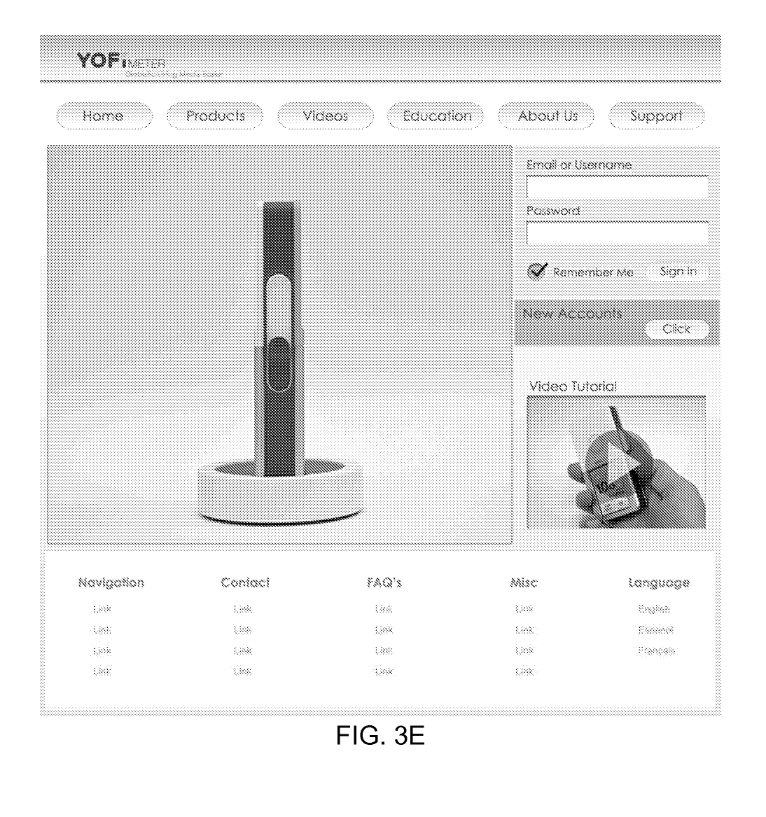

FIG. 3A shows a diagram of an exemplary analyte meter device 301 of the disclosed embodiments in communication with a mobile device 302 (e.g., smart phone, tablet, laptop computer, etc.) operating a mobile application including the disclosed user interface and a computer device 303 operating a web portal including the disclosed user interface. For example, the computer device 303 can be a personal computer (PC) such as a desktop, laptop, or other computer, as well as a smart phone, tablet, or other web portal medium. For example, the web portal can also be implemented on the mobile device 302, e.g., through the mobile application or a web browser application. For example, the exemplary analyte meter device 301, mobile device 302, and computer device 303 operating the web portal can be in communication through wired or wireless communications. Some examples for wireless communications include 3G wireless communication standards, 4G wireless communication standards including, LTE, WiFi, Bluetooth, and other suitable wireless communications via radio frequency waves and other electromagnetic waves.

The analyte meter device 301, the mobile device 302, and the computer device 303 can be included as part of a closed loop health management system. In some examples, the health management system can further include a medicine injection device in communication with at least one of the analyte monitoring device 301 or the computing system 303. Some examples of the medicine injection device are disclosed in Canadian Patent application CA2808738A1 entitled “PORTABLE MEDICINE INJECTION DEVICE AND ANALYTE METERING SYSTEM”, which is incorporated by reference in its entirety as part of the disclosure in this patent document.

FIG. 3B shows a diagram of the analyte meter device 301 that includes an interactive user interface for analyte level monitoring and health information management to enable a user to transmit and receive information to/from the database in the cloud. As depicted in FIG. 3B, the analyte meter device 301 includes a display screen 311 that can facilitate at least a portion of the described user interface of the disclosed embodiments. For example, the analyte meter device 301 can also include one or more audio speakers and microphone(s) as part of the described interactive user interface.

FIG. 3C shows a diagram of the mobile device 302 operating the web portal that includes an interactive user interface for analyte level monitoring and health information management to enable a user to transmit and receive information to/from the database in the cloud. For example, in some embodiments, the mobile device 302 can implement the interactive user interface using a mobile application as a software application stored on the mobile device 302 and configured to interact with the database via a wireless communication link. For example, the exemplary mobile software application can include all or at least some of the functionalities of the described user interface disclosed in other embodiments (e.g., such as the web portal). Also, for example, in some embodiments, the interactive user interface can be presented through a web portal (e.g., via a web browser application) on the mobile device 302. As depicted in FIG. 3C, the mobile device 302 includes a display screen 312 that can facilitate at least a portion of the described user interface of the disclosed embodiments. For example, the mobile device 302 can also include one or more audio speakers and microphone(s) as part of the described user interface.

FIG. 3D shows a diagram of the computer device 303 operating the web portal that includes an interactive user interface for analyte level monitoring and health information management to enable a user to transmit and receive information to/from the database in the cloud, e.g., via the web portal. As depicted in FIG. 3D, the computer device 303 includes a display screen 313 that can facilitate at least a portion of the described user interface of the disclosed embodiments. For example, the computer device 303 can also include one or more audio speakers and microphone(s) as part of the described user interface. FIG. 3E shows an exemplary login page of the exemplary user interface shown on the display screen 313 in FIG. 3D.

The disclosed interactive user interface can be implemented on a computing device including the analyte meter device 301, the mobile device 302, and the computer device 303 to present at least some of the processed health information on the computing device of the user to enable user interaction. The interactive user interface can be an integrated graphical and audio user interface that can display text and images to a user, receive inputted text and image data from the user, produce audio sounds to the user, and receive speech data and other auditory data from the user.

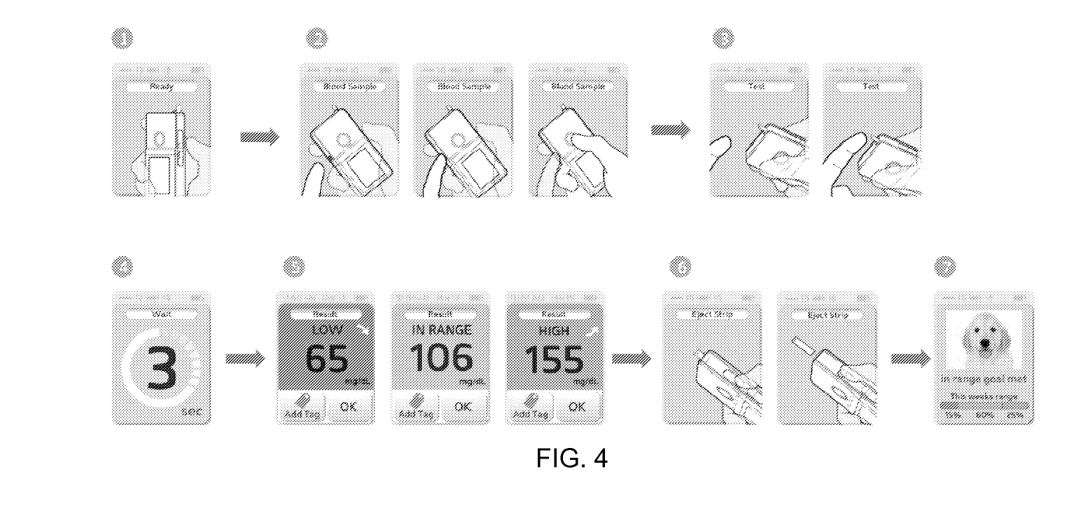

FIG. 4 shows a diagram of an exemplary user interface presented on the display screen 311 of the analyte meter device 301 showing instructive steps and real-time results of an exemplary process to monitor an analyte level (e.g., blood glucose level) in a user's blood by actively performing an analyte test using the device 301. In this example, the exemplary user interface presents image and textual information to instruct the user to (1) ready the device, (2) arm/ready and fire a lancet and an analyte testing strip and draw a blood sample from the user, (3) transfer blood to the testing strip to perform the analyte level test, (4) wait during the processing the analyte level test (e.g., which, in one example, can be performed in 5 sec for a 0.3 μL (micro liter) sample), (5) receive the results (e.g., quantitative analyte measurements and/or characterized levels (e.g., low, in target range, high)) via the display, (6) eject the testing strip and/or lancet, and (7) upload the results to a database (e.g., via a wireless communication link) and/or display the results among previously attained results. For example, the exemplary user interface can also present a clock (e.g., date and time) and information of the analyte meter device 301 including battery level, wireless communication transmission/reception level, and/or lancet and/or test strip quantity level, e.g. which can be presented as textual and/or graphical information.

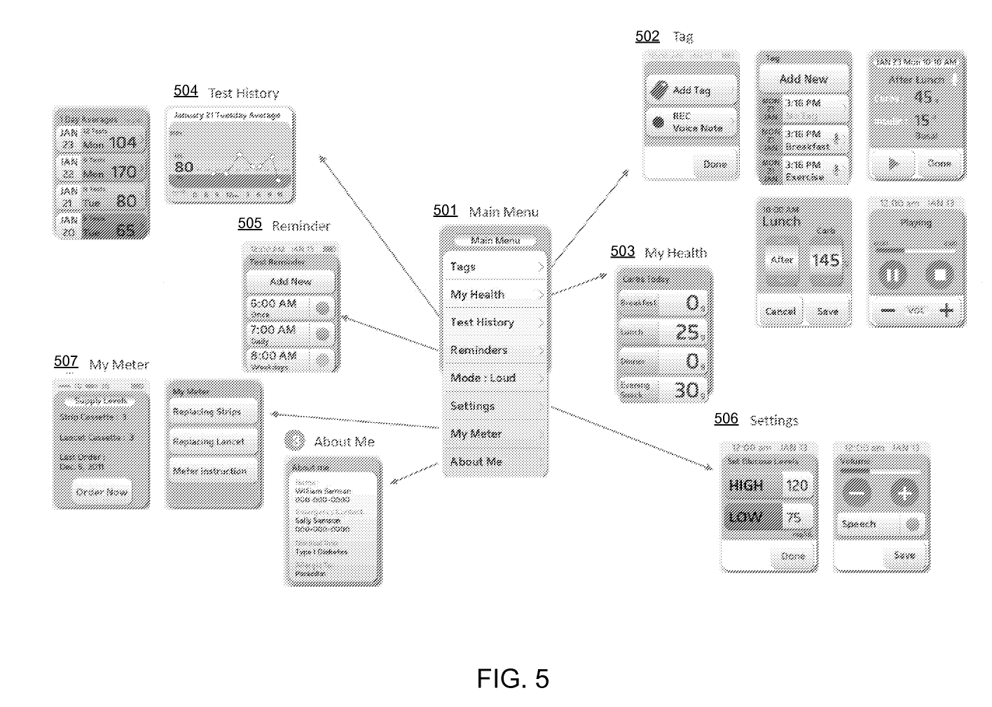

FIG. 5 shows a diagram of the exemplary user interface presented on the display screen 311 of the analyte meter device 301 showing a main menu interface. For example, the exemplary main menu interface 501 shows interactive menu options that a user can select to implement another interface or functionality in accordance with the selected option. For example, as shown in FIG. 5, the exemplary main menu interface 501 can include an event interface 502, e.g., which can enable the user to add or tag information (e.g., text, image, and/or audio data) to stored data in the meter or in the database (e.g., in the cloud), as well as retrieve tagged information for display (e.g., of graphical and/or textual information) and playback (e.g., of audio information). The exemplary main menu interface 501 can include a health interface 503 to display the additional health information to the user on the device 301. The exemplary main menu interface 501 can include a test history interface 504 to display the measured analyte levels of past analyte tests to the user. The exemplary main menu interface 501 can include a reminder interface 505, for example, to enable the user to enter reminder notes related to analyte monitoring and/or additional health information (e.g., including reminders to take medications or perform other tasks) as well as present the list of current and past reminders. The exemplary main menu interface 501 can include a settings interface 506, for example, to enable the user to enter threshold information related measured analyte levels and/or additional health information (e.g., nutrition levels, number of steps taken, etc.), as well as adjust other device settings including volume, brightness of display, etc. The exemplary main menu interface 501 can include a meter interface 507. The exemplary main menu interface 501 can include an About Me (the meter) interface 508 to provide the user with information about the meter device 301 and/or the user (registered user), e.g., including user name, user identification number, emergency contact person and number(s), user medication and allergy information, device registration/serial number, software version, device operational parameters, etc. The exemplary user interface provides an interactive graphical user interface that can also include an integrated interactive audio interface. For example, the exemplary user interface can include bright colors and large font sizes to display textual and image information on the display screen 311 of the analyte meter device 301. In some examples, the exemplary user interface can be presented as a speaking interface that provides audio information to the user through the meter.

The interactive user interface can include a plurality of data modules that organize the processed health information. For example, the data modules include an analyte level module to provide one or both of a recent measurement and a history of the measured analyte levels, a medication module to provide medication data of one or more medications being taken by the patient including at least one of a medication name or identifier, medication type taken, a date and time taken, and a dosage taken, a nutrition module to provide carbohydrate and other nutrient intake data by the patient, and/or a fitness module to provide fitness data including at least one of a number of steps taken or duration of exercise performed by the user. For example, the data modules can also include a patient goals module to receive patient goal and/or threshold information corresponding to the health information in any or all of the data modules and to process and present the patient goal and/or threshold information to analyze the goals and thresholds with respect to the corresponding health information. For example, the data modules can also include a journal module to provide journal data including user input data including text, images, and/or audio data and/or a snapshot image of the interactive user interface displayed on a display screen of the computing device, e.g., which can allow a user to make retrievable notes associated with events and/or particular health information that occurred at a particular date and time.

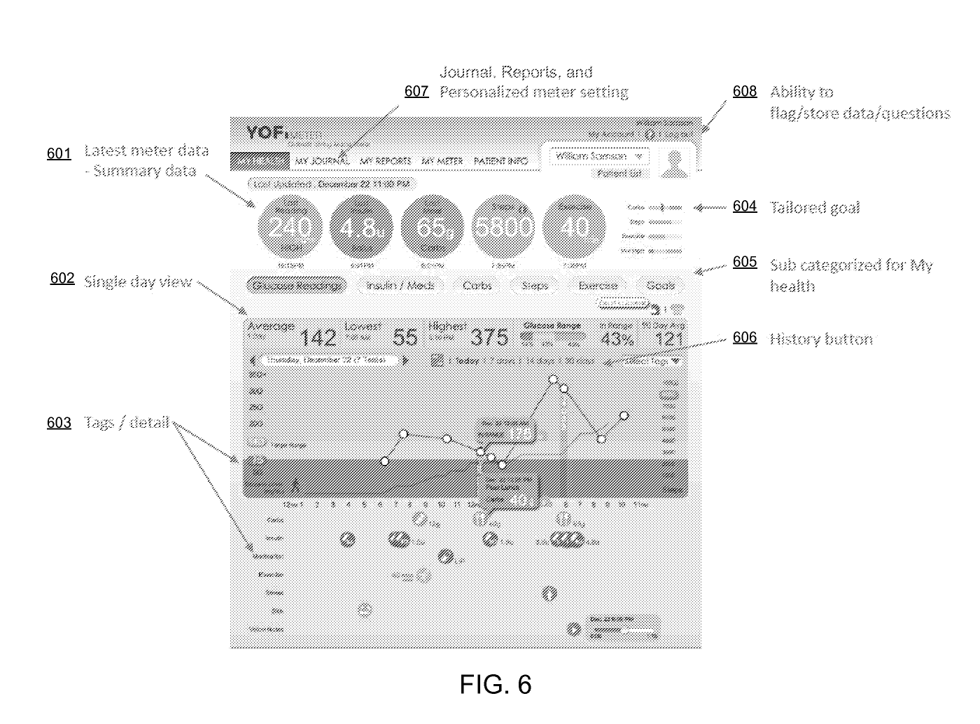

FIG. 6 shows an exemplary user interface showing a functional interactive interface for a user to manage health information. For example, the exemplary user health management interface can be presented on the display screen 313 of the computer device 303 via the web portal, and in some examples, also presented on the display screen 312 of the mobile device 302. For example, the exemplary health information and management interface shows several interactive features that display information, e.g., including analyzed health information. As shown in the example in FIG. 6, the exemplary user health management interface presents the latest meter data 601 (e.g., summary data of the measured analyte level, medication injection, nutrition information, and fitness information including steps taken and exercise duration); single day view information 602 (e.g., including daily average, lowest, and highest analyte level for the single day, calculated percentage within the low, target, and high level range, and extended average analyte level); user initiated tags and details of health information 603 (e.g., presented as graphical icons and textual data along a time scale of a day, week, etc., such as a medication injection of medicine X of 1.5 μL at 7:00 am); user goal information 604 (e.g., graphically displaying the patient's health information on a scale relative to a user-defined threshold); selectable categories of data modules 605 (e.g., including, but not limited to, measured analyte levels information (e.g., glucose readings), insulin/medicine information, nutrition information (e.g., carbohydrates), fitness information including steps and exercise, and goal information); selectable data history information 606 (e.g., for selection of the user health management interface over various time scale including a current day, a week, two weeks, a month, etc.); selectable categories of additional data modules 607 (e.g., including patient journal, patient data reports, personalized meter settings, and patient information); and account settings 608 (e.g., presenting account authorization information such as access to patient lists and enabling the user to adjust flagging/data storing/questions settings). The inclusion of such a variety of information on a single display greatly enhances the user's experience and provides functionalities that would not have been possible, or readily discernible, from data that is dispersed throughout multiple plots, or lists. For example, as evident from FIG. 6, actual glucose levels and fluctuations therein, as shown on the left hand side of the interface window, are displayed on a time scale and can be easily correlated to one or more of the health factors relative to the measured glucose levels, as shown underneath the temporal display of glucose levels on the same time scale. In particular, fluctuations in glucose levels can be correlated to consumption of carbohydrates, injection of insulin, medications taken by the patient, patient's exercise schedule, patient's stress, sickness, and other factors that may, for example, be inputted through tags including text data and voice notes. The actual glucose levels and their fluctuations are displayed over a colored background that reflects the low, target, and high analyte level range, e.g., which can be defined by the patient using the interface. Providing such a detailed and comprehensive picture on a single screen with a properly selected granularity can, for example, enable the user to determine the effects of a particular factor (e.g., a new medication, stress levels, exercise, etc.) on the patient's glucose levels. Further, such correlations can be analyzed to set alerts (or alarms or reminders) to predict, prevent and/or mitigate adverse effects of such factors before glucose levels reach a critical limit In some embodiments, a caregiver is alerted to a particular glucose level fluctuations through a text message, a phone call, an email or other communication methods.

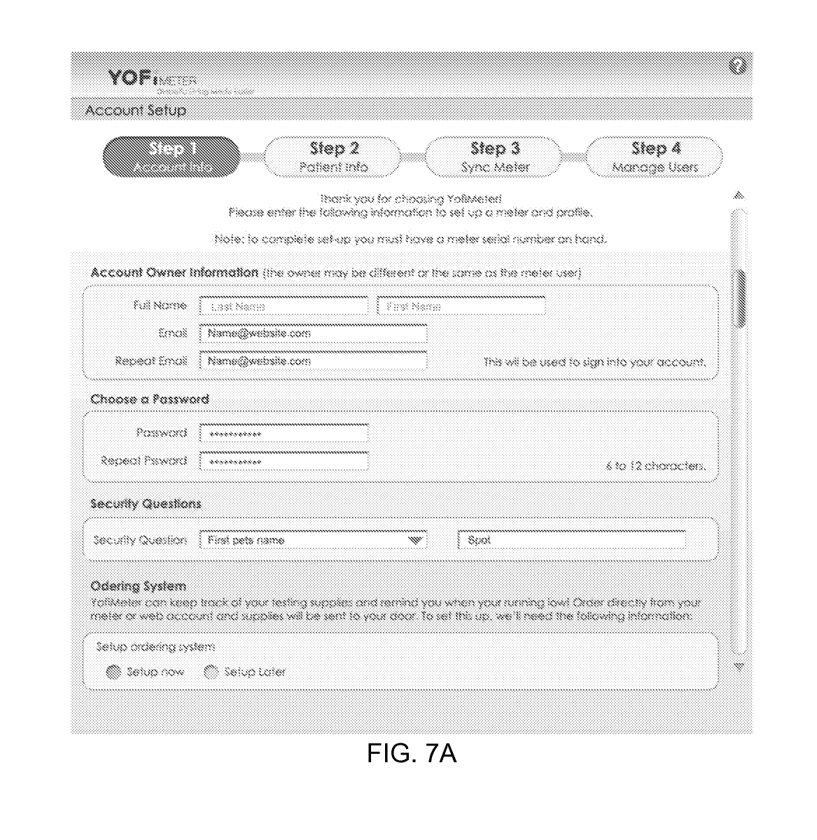

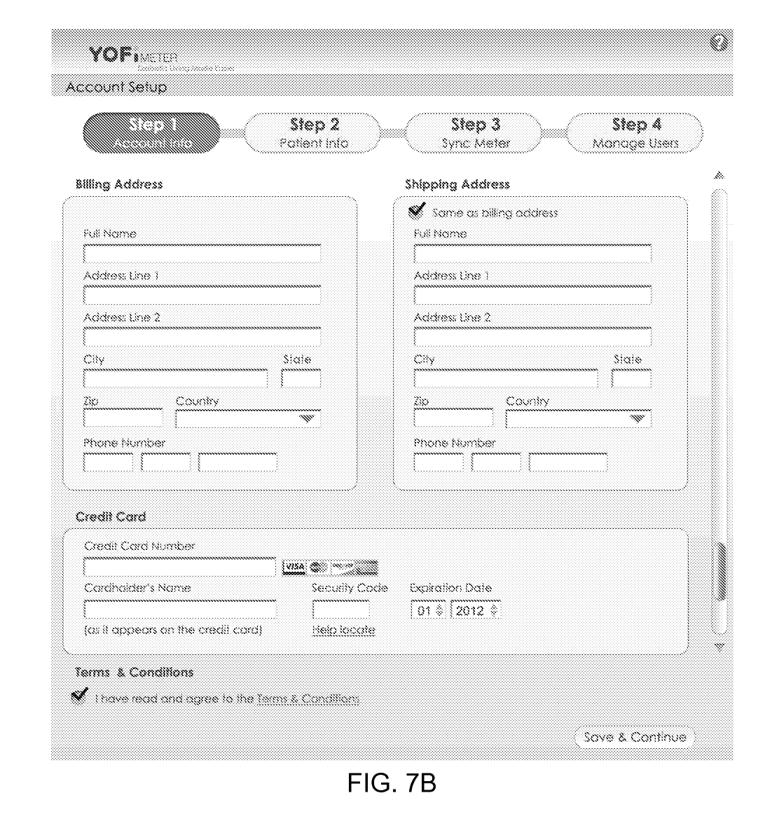

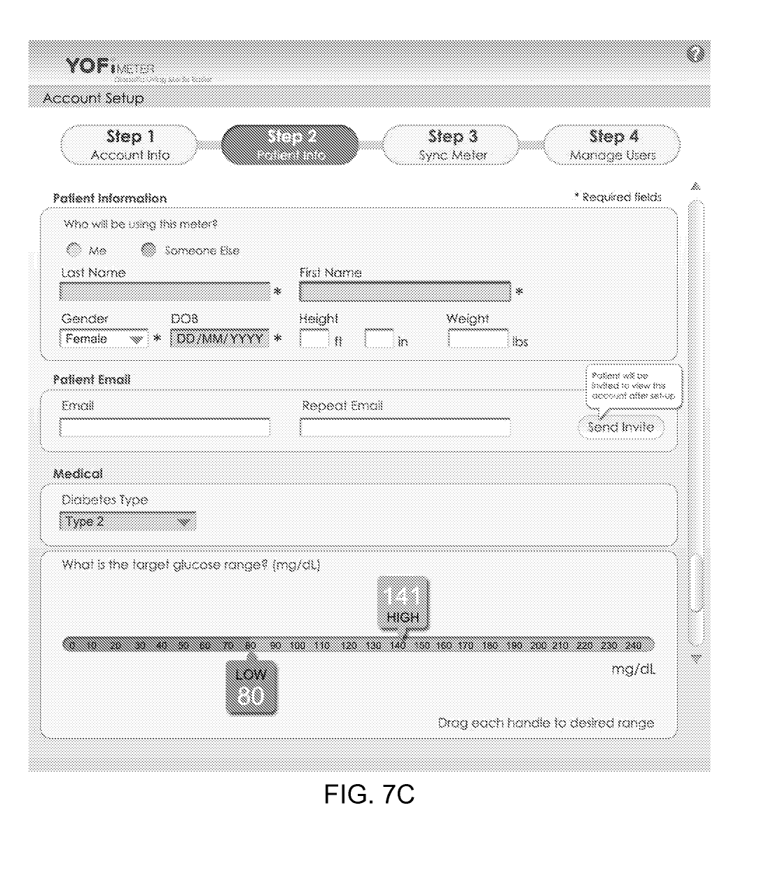

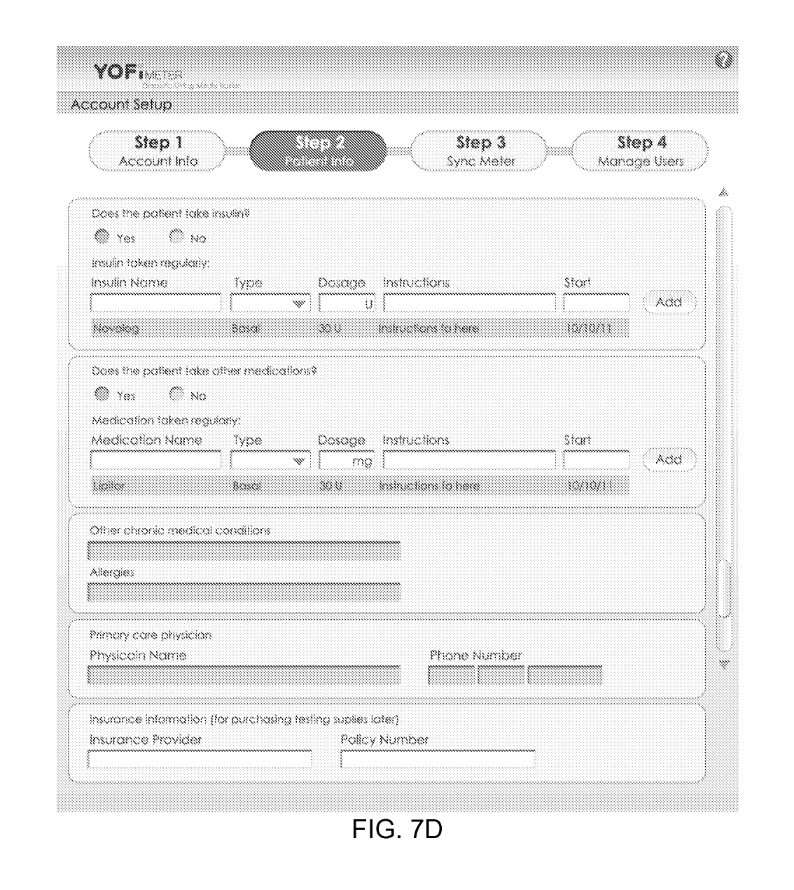

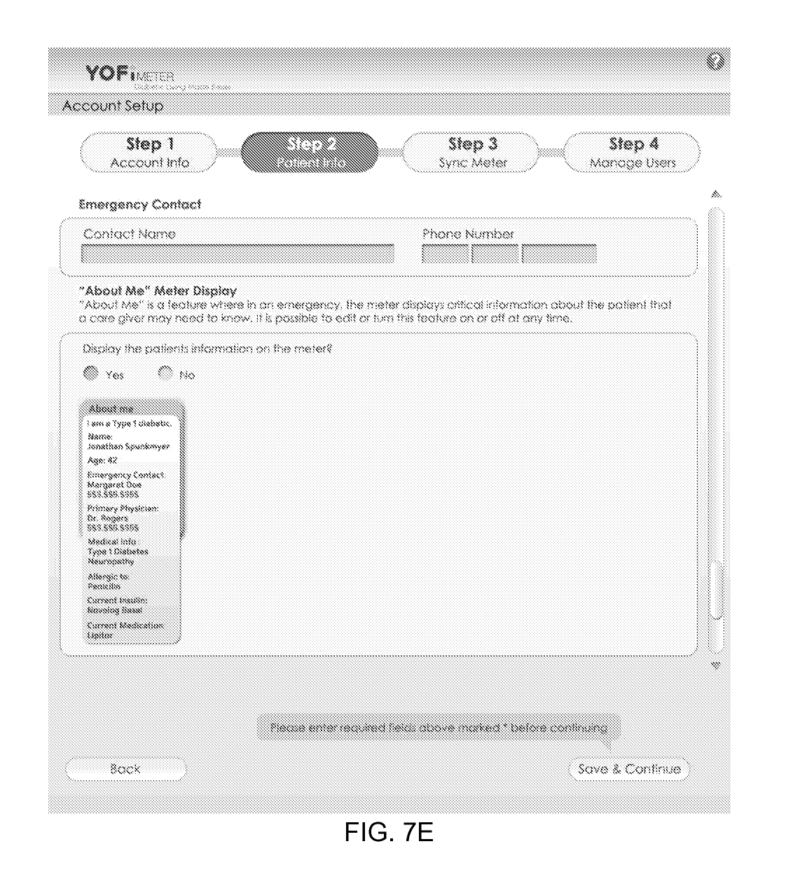

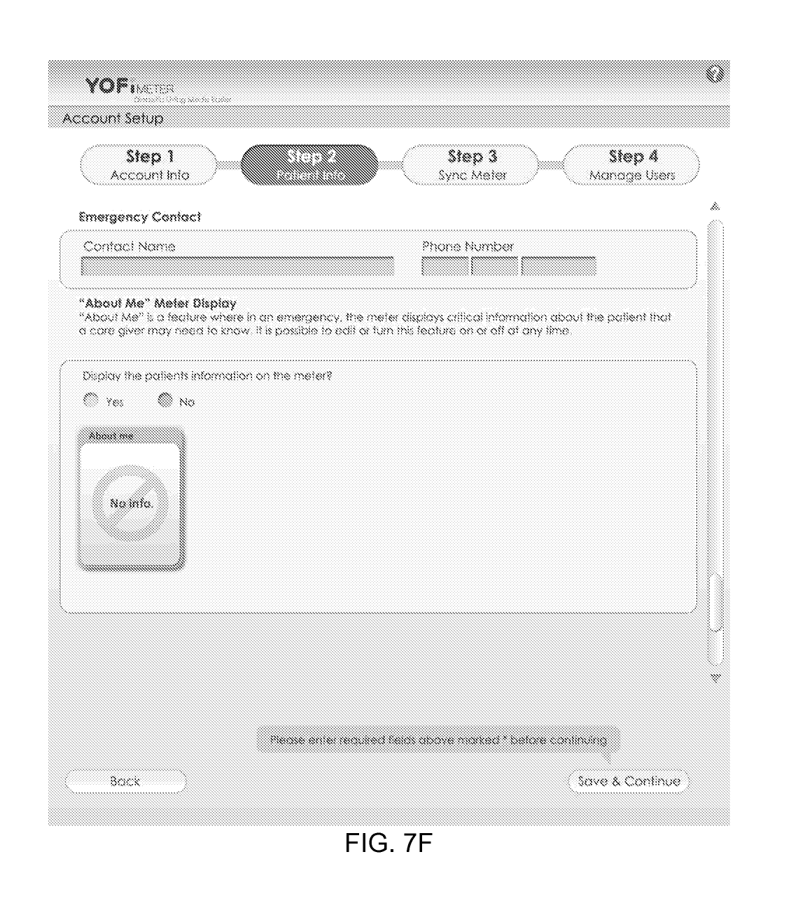

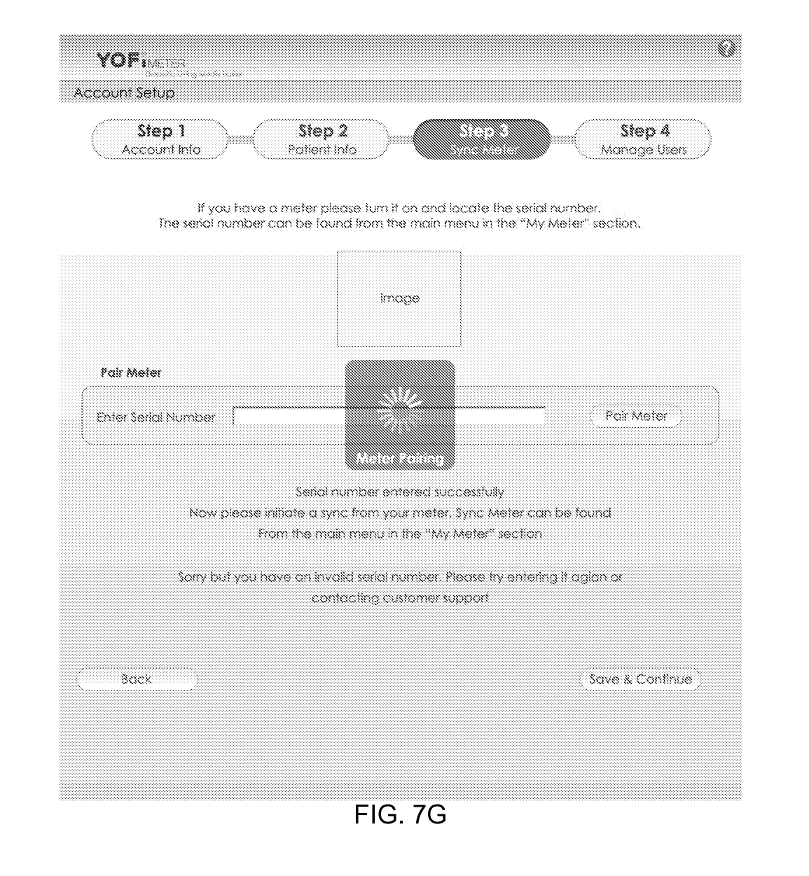

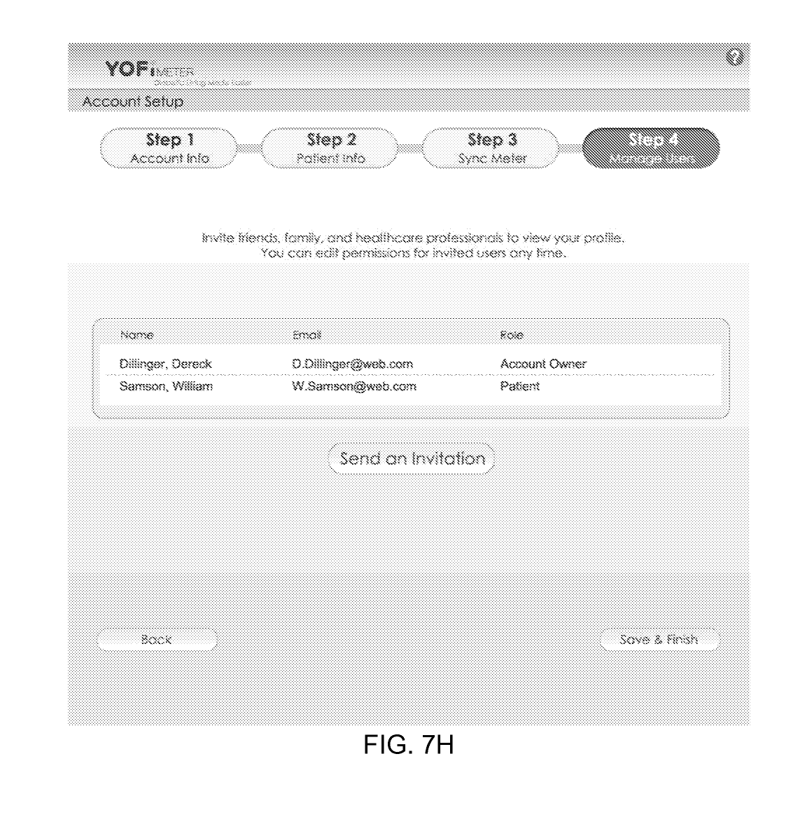

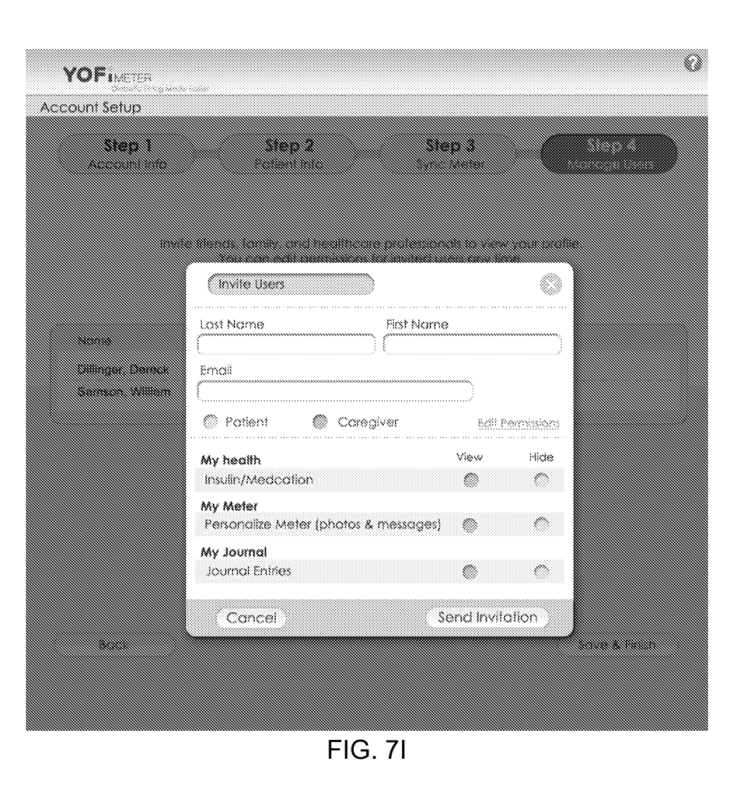

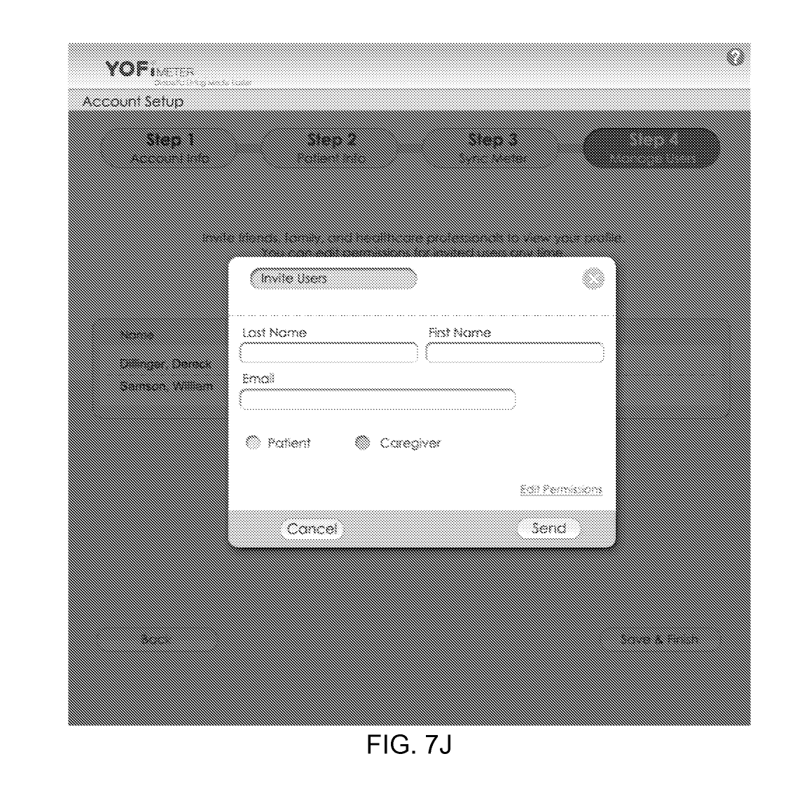

FIGS. 7A-19B show examples of display screens of the disclosed user interface implemented on the exemplary web portal. The same or variations of exemplary user interface modules shown in FIGS. 7A-19B can also be implemented on a mobile device.

The disclosed interactive user interface can include an account set-up module for a user to input information about a patient user who monitors his/her levels of particular analytes into a database, e.g., which can be stored on in the cloud, and settings information to manage access to the information, e.g. which can be shared between any or all of the described devices operating the interface (e.g., the analyte meter device 301, mobile device 302, and computer device 303 operating the web portal), as well as between other patient users to monitor and/or manage health information of other patient users.

FIGS. 7A-7J show exemplary display screens of the account set-up and management module of the interactive user interface. In one embodiment, as shown in FIGS. 7A and 7B, the account set-up and management module can include an interface for the initial set up of a user account, e.g., including the user name, email, account security information (e.g., including password, security questions, etc.), ordering system information (e.g., for the ordering of device consumables such as lancets and/or test strips), billing, shipment, and payment information, and terms & conditions of use information. The account set-up and management module can enable later access to the initial account set up for editing, for example. As shown in FIGS. 7C-7F, the account set-up and management module can also include an interface for the initial set up of a patient information, e.g., patient name, gender, date of birth, height, weight, and email and/or other form of contact information. Additionally, the patient information set up interface can enable the user to enter medical information, for example, which include, but is not limited to, medical conditions, e.g., Type 2 Diabetes and/or other medical conditions; a target range for the measured analyte level, e.g., such as setting a low range to 80 mg/dL or less and a high range to 141 mg/dL or greater; medicines used and their amounts and frequencies taken; caregiver information; payer information; emergency contact information; and meter device display settings. For example, as shown in FIGS. 7E and 7F, the account set-up and management module includes an “About Me” meter display functionality that can provide patient information taken during an account setup to be displayed on the analyte meter device of the patient, e.g., which can be available for display on the analyte meter device in cases of an emergency when the patient user is not able to convey critical information, e.g., such as the patient's health condition (e.g., Diabetic type), name, age, emergency contact person and contact information, physician name and contact information, medications used (e.g., type of insulin and/or other medicine), allergies to medications, etc. The account set-up and management module can also include privacy controls to limit or not allow information entered for the “About Me” meter display to be displayed. As shown in FIG. 7G, the account set-up and management module can also include an interface for the automatic initial set up of the analyte meter device (e.g., synchronization of the meter device with the database of health information). The account set-up and management module enables the user to enter, access, and manage to a determined extent the health information of patients, e.g., which can include the user (patient user), as well as other patients, e.g., which could be relatives or friends in the instance of a patient user, or which could be a group of patients in the instance of a caregiver user. As shown in FIGS. 7H-7J, the account set-up and management module can also include an interface for providing a list of other users that can view the user's profile, for setting viewer access settings including sharing restrictions, and for sending an invitation to join the list. For example, the list can include all types of users, e.g., including patients, caregivers, etc.

For example, the account set-up and management module may be operated by a caregiver, e.g., such that the caregiver can access the health information (e.g., including past and current, real-time analyte concentration measurement inputs, food and diet inputs, activity inputs, among other inputs) for a plurality of users (e.g., patients) subscribed to an analyte monitoring service. In some embodiments, the caregiver can further receive alerts when a patient performs an analyte test. Such an alert can be provided in the form of a text message, a voice/phone message, etc., to enable the caregiver to access the web portal at any time subsequent to the test. In some embodiments, the absence of a test can also trigger an alert, thereby informing the caregiver that a patient may need further attention and/or reminders to conduct the test. In another exemplary embodiment, the caregiver and the patient can engage in an interactive communication through, for example, an on-line chat functionality that is incorporated as part of the disclosed user interfaces. For example, the exemplary user interface can include a patients list module for a user (e.g., a caregiver) to view a multitude of patient data and access that data for each of the patients on the list.

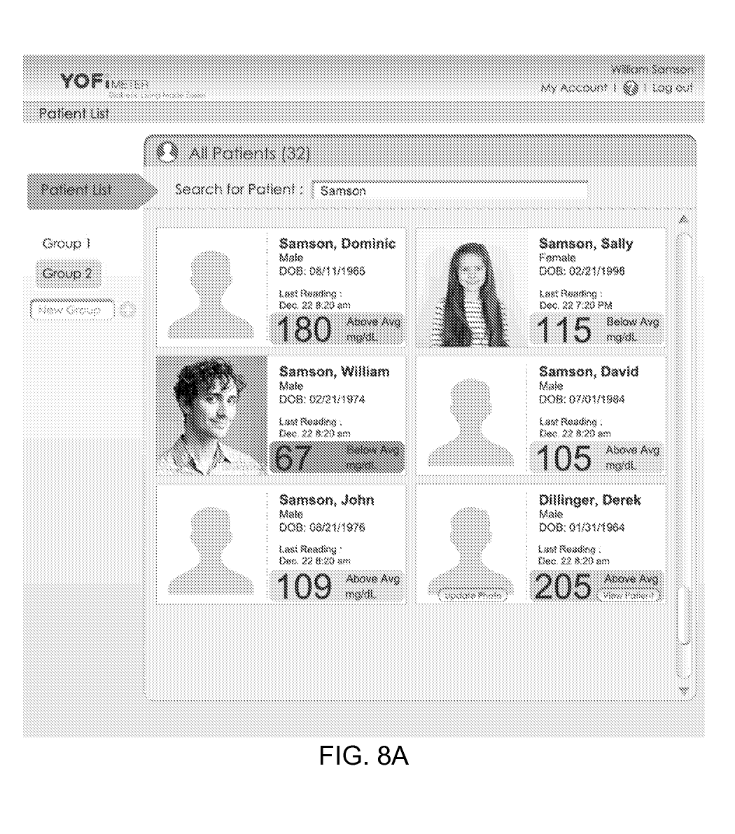

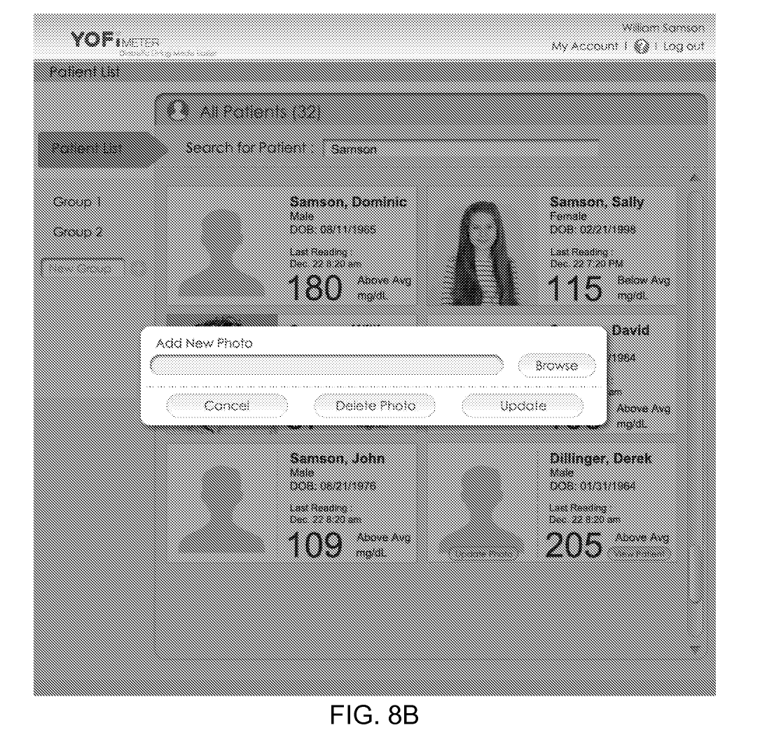

FIGS. 8A-8B show exemplary display screens of the patients list module of the interactive user interface. The patients list module can include an interface that shows patients identification information (e.g., name, gender, date of birth, picture, etc.) and a summary of the patients' current health condition, e.g. including a recent and/or averaged measured analyte level. For example, the patients list module can organize the list of patients into user-defined groups.

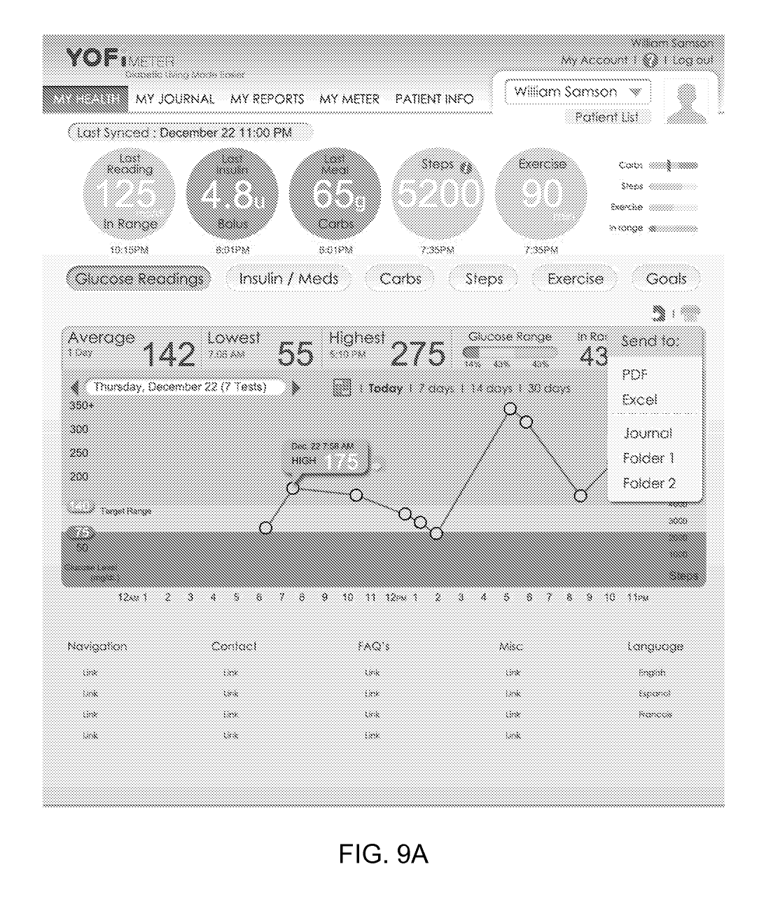

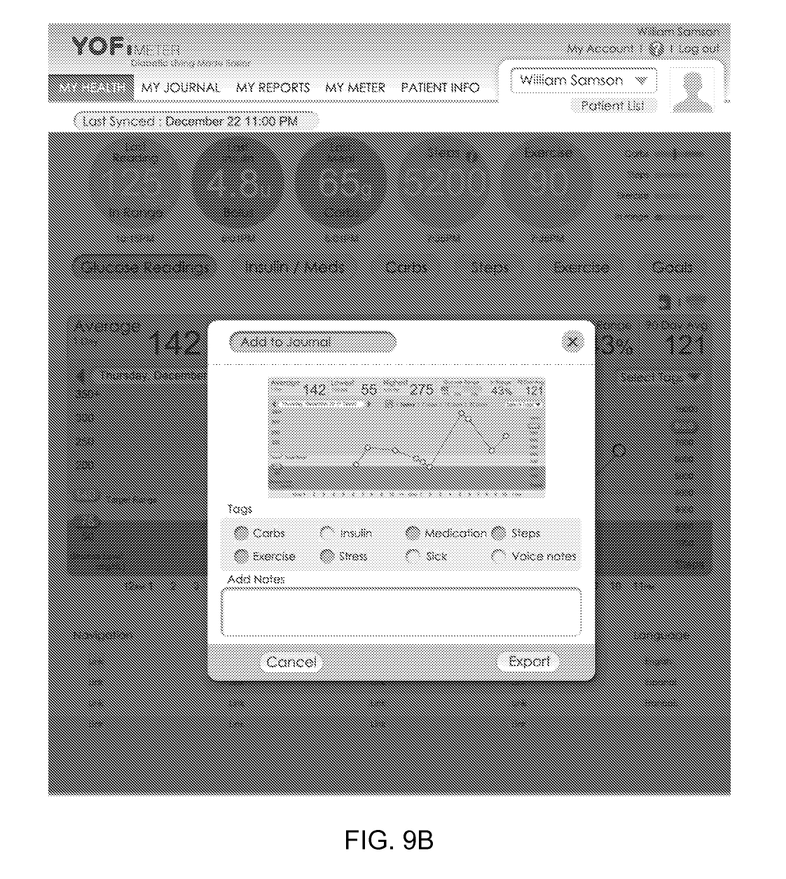

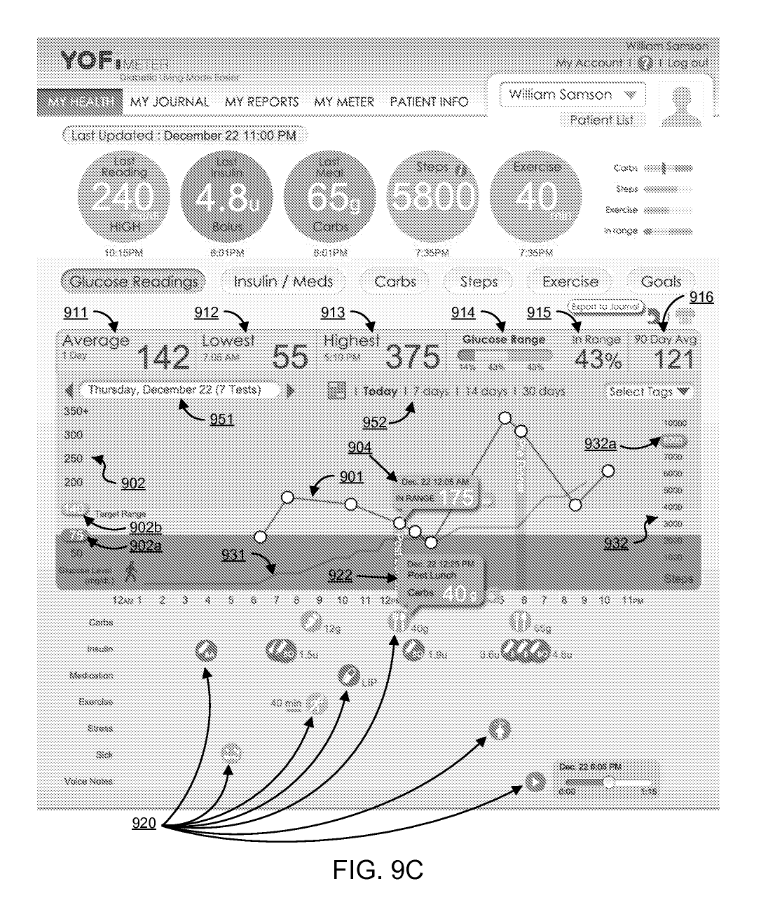

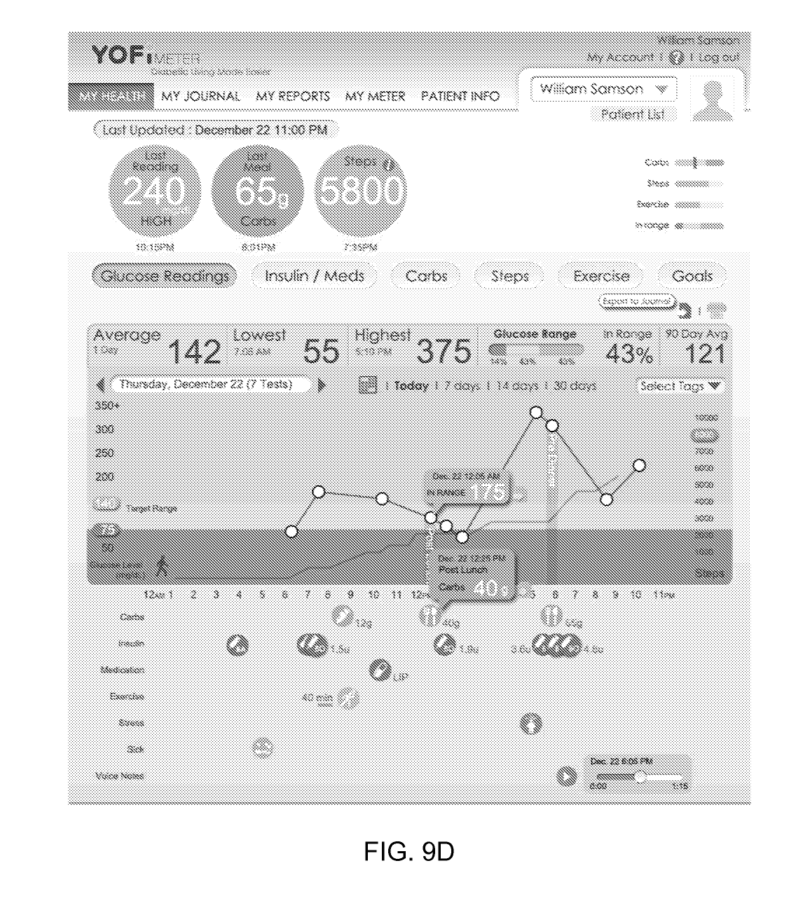

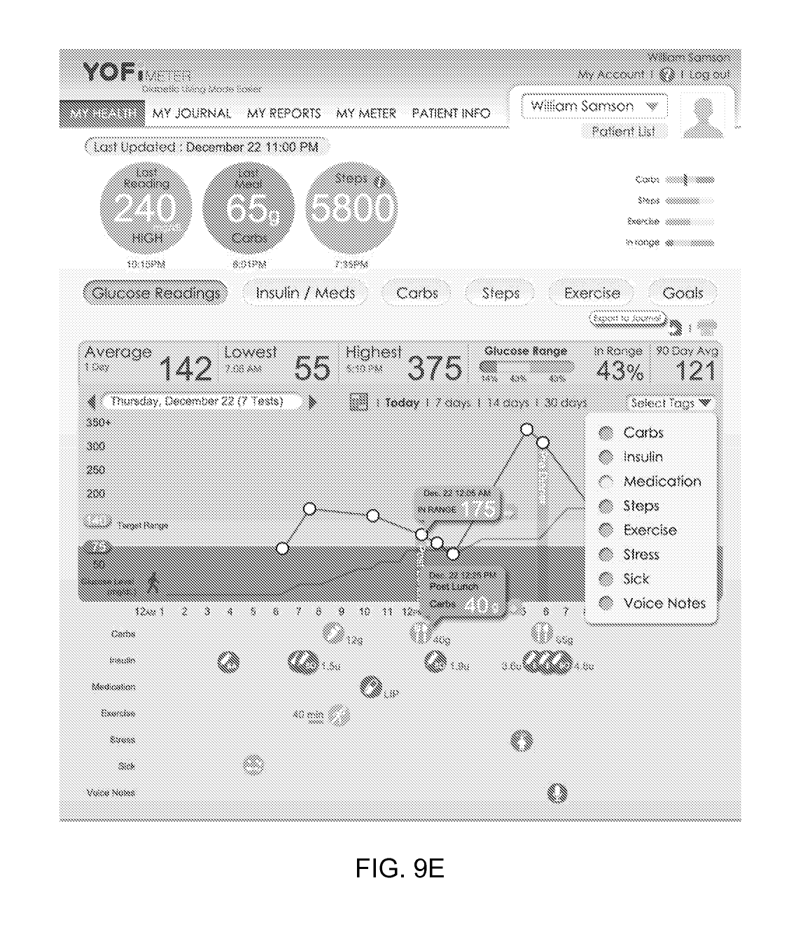

FIGS. 9A-13D show exemplary display screens of the exemplary health information modules for an exemplary patient, e.g., which can be selected from the patients list module by a user including a caregiver user. For example, the health information module can include multiple subcategorized data modules, e.g., such as a measured analyte level module (e.g., Glucose Readings), a medication module (e.g., Insulin/Meds), a dietary or nutrition module (e.g., carbohydrates (Carbs)), physical activity or fitness module(s) (e.g., including the number of steps in a Steps module, or other inputted physical activity in an Exercise module), and/or other health information modules. For example, the exemplary health information modules can include functionality to input user notes and information (‘tag’) about various data. Also, for example, the display interface of each or any of the exemplary health information modules can include a summary of the latest analyte level and additional health information data (e.g., summary data of the measured analyte level, medication injection, nutrition information, and fitness information including steps taken and exercise duration).

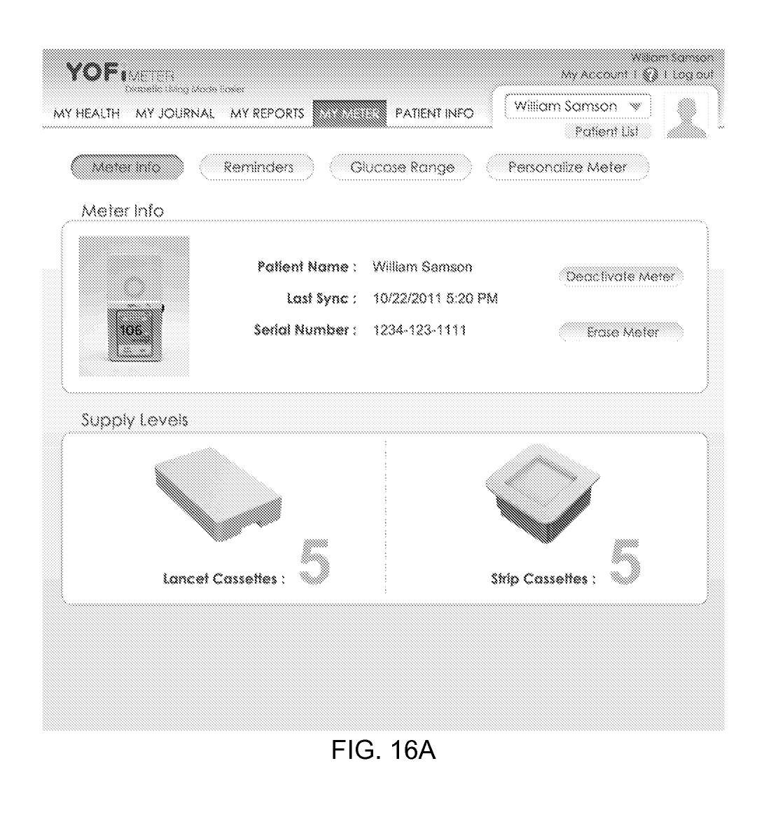

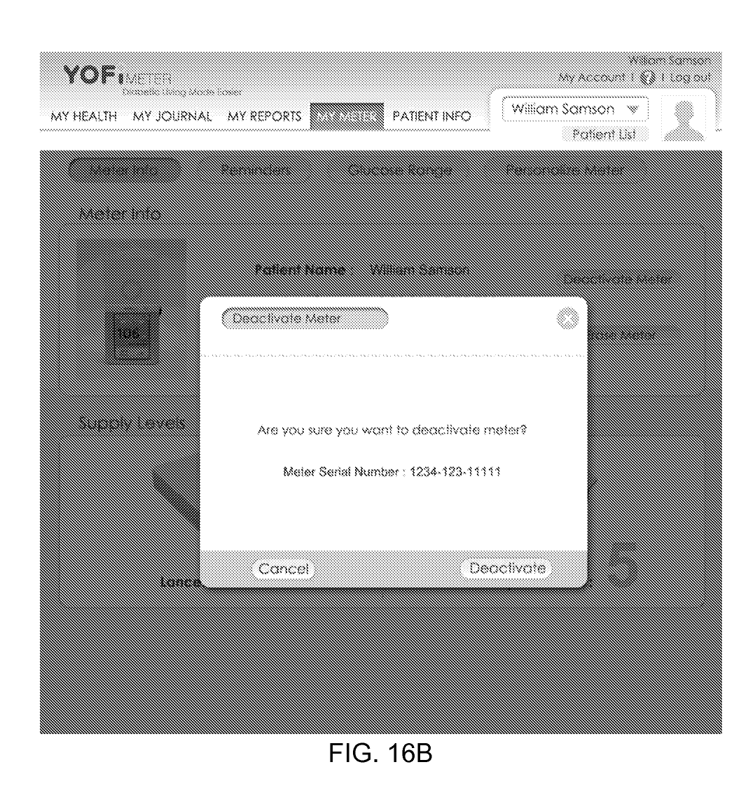

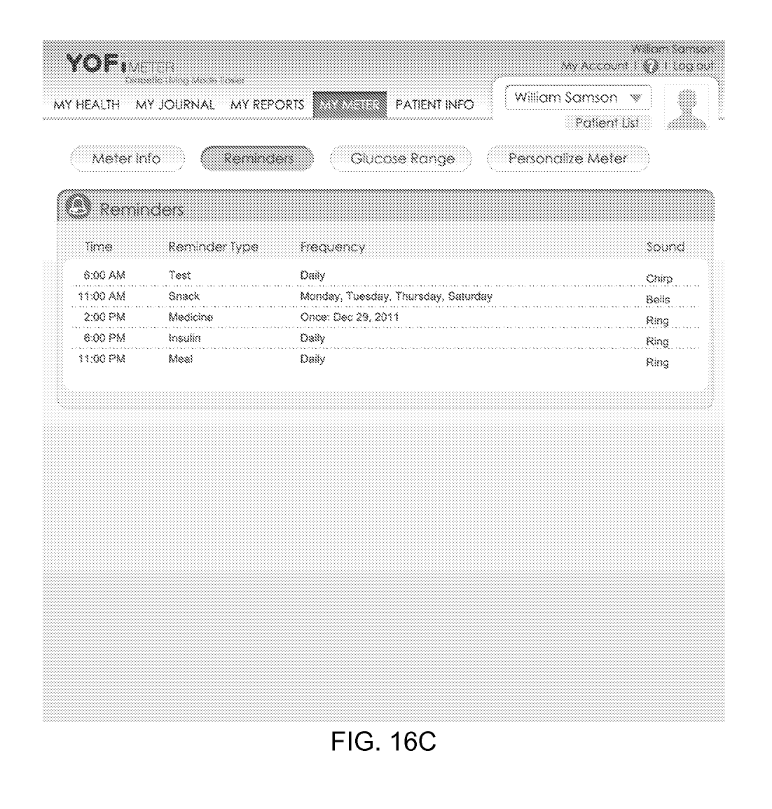

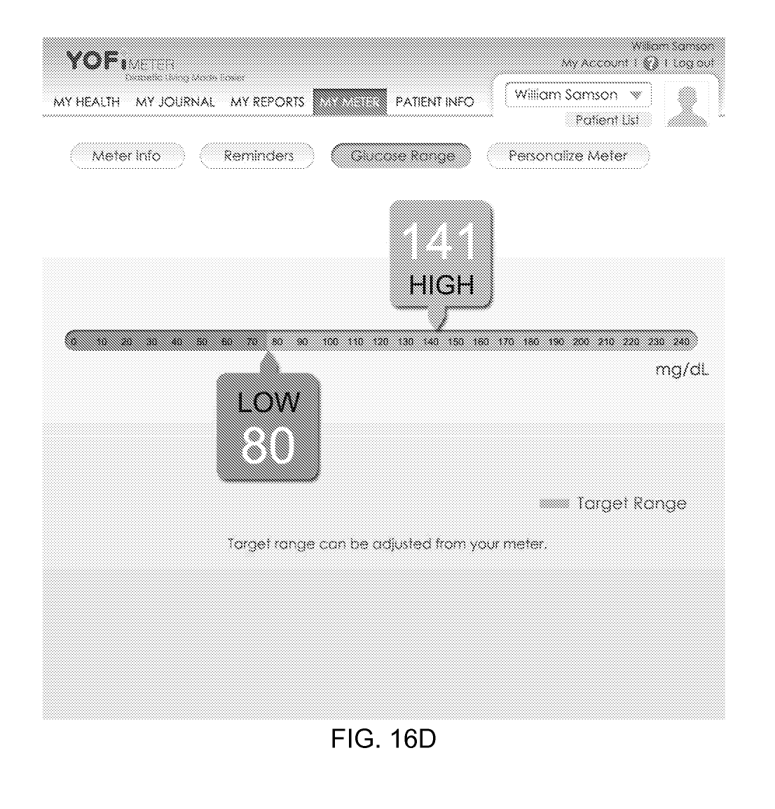

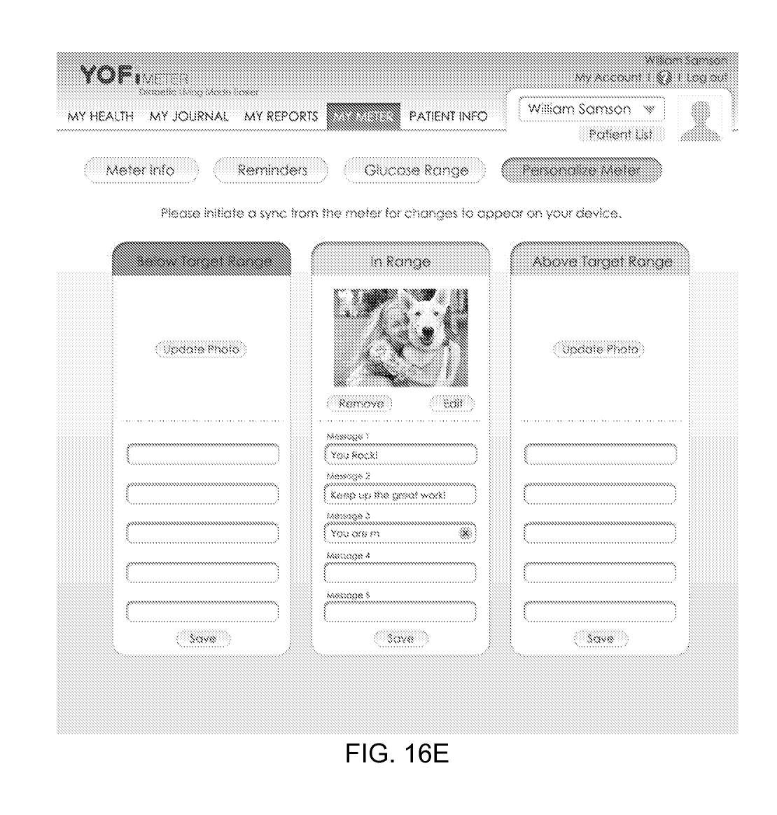

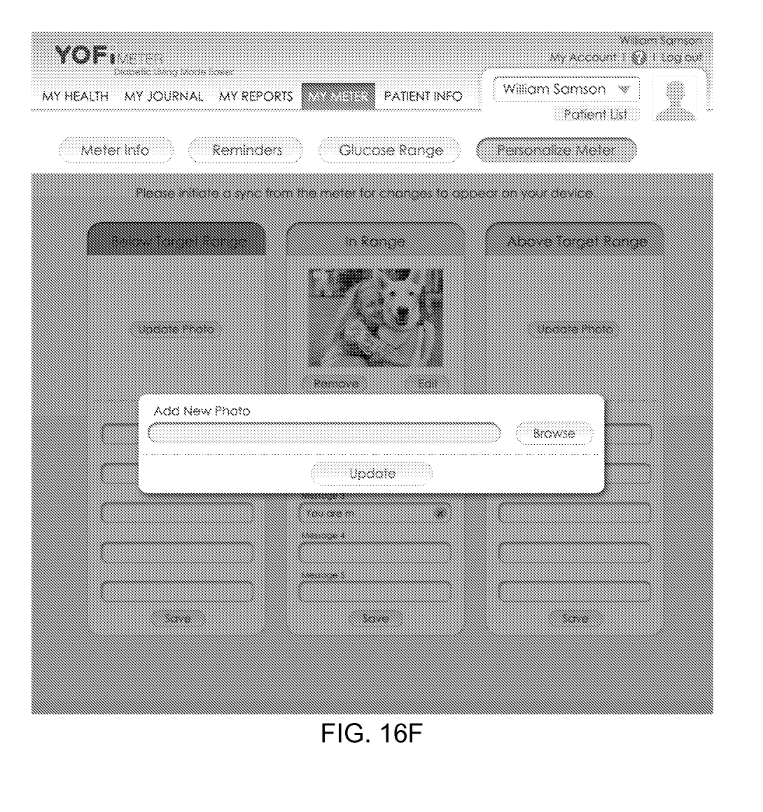

As shown in FIG. 9A, the exemplary measured analyte level (e.g., Glucose Readings) module includes a user interface showing various glucose level readings, such as an average reading (e.g., averaged over one day or multiple days), a lowest level reading (e.g., for a given day or multiple days), a highest level reading (e.g., for a given day or multiple days), and a percentage of time spent in a particular glucose level range (e.g., such as % time spent in a low range, target range, or high range). For example, the exemplary Glucose Readings module includes a user interface that can enable a user to change the threshold levels that define the ranges, as shown later in FIG. 16D. Referring to FIG. 9A, the information displayed on the display screen of the exemplary Glucose Readings module can be exported to other data formats, e.g., which can be transferred to and/or stored in a journal module and/or report data module of the disclosed user interface technology and/or sent to other devices, e.g., via wireless communication links. For example, as shown in FIG. 9B, the exemplary Glucose Readings module includes a user interface that can export the measured glucose levels shown on the Glucose Readings display and additional health information data that can be selected from a selectable list, e.g. including nutrition, medicine and/or insulin, stress, illness, fitness including exercise and steps, and/or voice notes. The exemplary measured analyte level module can include functionality to display summarized data of the health information, which can include all or a selected subset of the health information categories, as shown in FIG. 9D. The exemplary measured analyte level module can include functionality to input user notes and information (‘tag’) about various data featured in the analyte readings, as shown in FIG. 9E.

As shown in FIG. 9C, the interface of the exemplary measured analyte level module (e.g., Glucose Reading module) presents the various glucose level readings 911-916 (e.g., single day average 911, lowest level 912, highest level 913, range percentage 914, percentage within the ranges 915, and multiple day average 916) in graphical and quantitative formats with tagged icons 920 representing patient information (e.g., inputted by the patient) at various instances during a day (e.g., or in other examples, a week, month, or year, etc.). The exemplary tagged icons 920 can be presented in different colors and designs for ease of viewing. The exemplary tagged icons 920 can be selected to present information related to the type of icon in a bubble text icon 922. For example, the information of the exemplary tagged icons 920 can include the type and amount of medication taken at a particular instance, the type and amount of nutrient taken at a particular instance, the amount of physical activity performed by the patient, or whether the patient felt stressed or sick, voice memos, among other user tagged inputs. Additionally, the additional health information can also be graphically represented on the display interface of the exemplary measured analyte level module. For example, the fitness module can share the fitness data including steps taken and/or duration of exercise performed by the user with the measured analyte level module such that multiple types of data can be displayed on the same display interface. For example, as shown in FIG. 9C, the user steps data 931 and glucose level data 901 are displayed on the same graph showing their respective levels on scales 932 and 902, respectively, during a single day on a time scale 903. For example, the interface of the measured analyte level module can allow the user to select the individual glucose tests of the graphically displayed glucose level data 901, which can present further detailed information about the individual test, e.g. in a bubble text icon 904. For example, the scales can also represent target values (e.g., goals and/or low/high threshold values, as exemplified by the steps goal data point 932a and the glucose level low threshold level 902a and high threshold level 902b). For example, the colors of the bubble texts 904 of analyte level data and 922 of health information tagged icon data can be represented in the corresponding colors to the tagged icons and analyte level range for ease of viewing, e.g., enabling the user to distinguish between multiple bubbles present on the same display screen. The interface of the exemplary measured analyte level module can present a menu 951 to select the date associated with the health information for display. Additionally, for example, the interface of the exemplary measured analyte level module can present a menu 952 to select the number of days in which the displayed health information represents, e.g., such as a current day data interface like the one shown in FIG. 9C, or a 7-day data interface, 14-day data interface, 30-day data interface, or other.

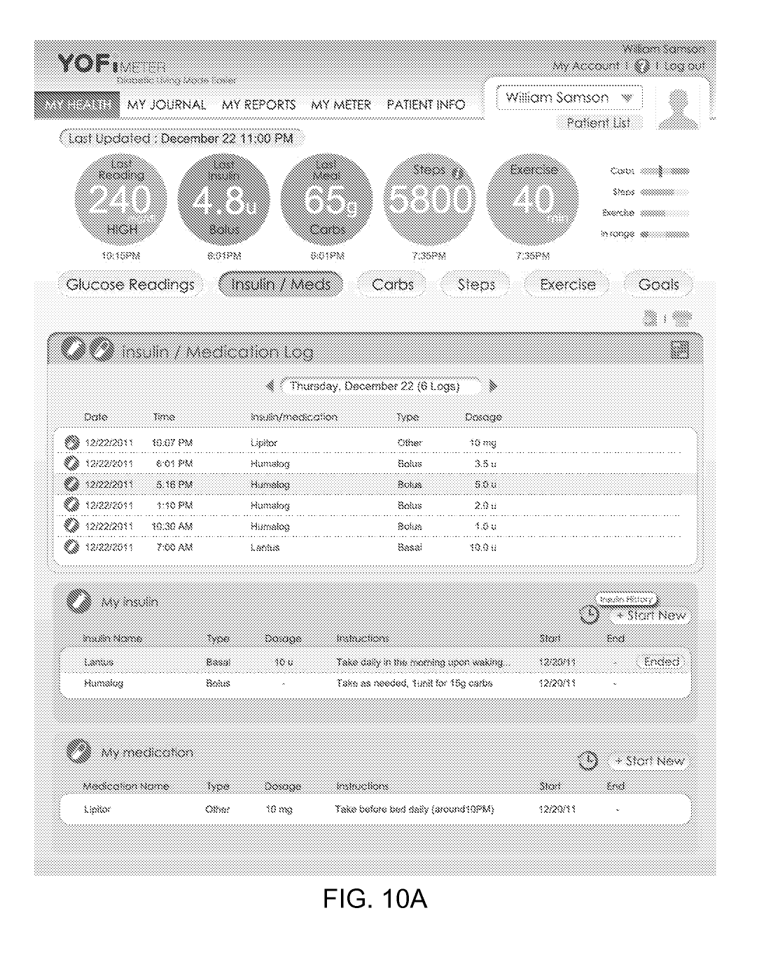

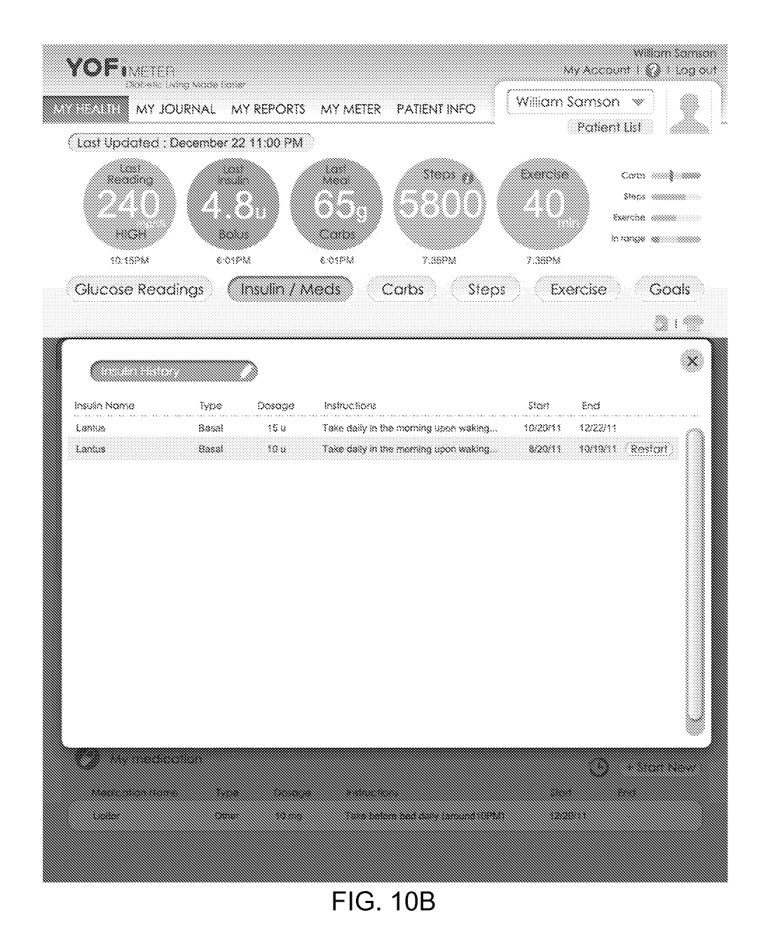

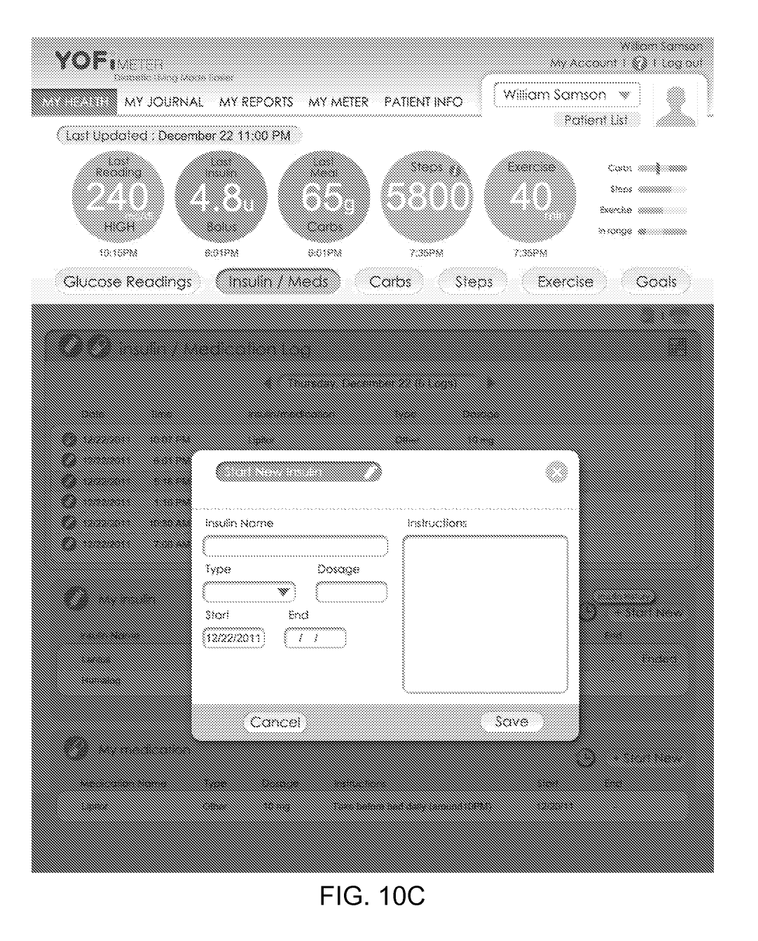

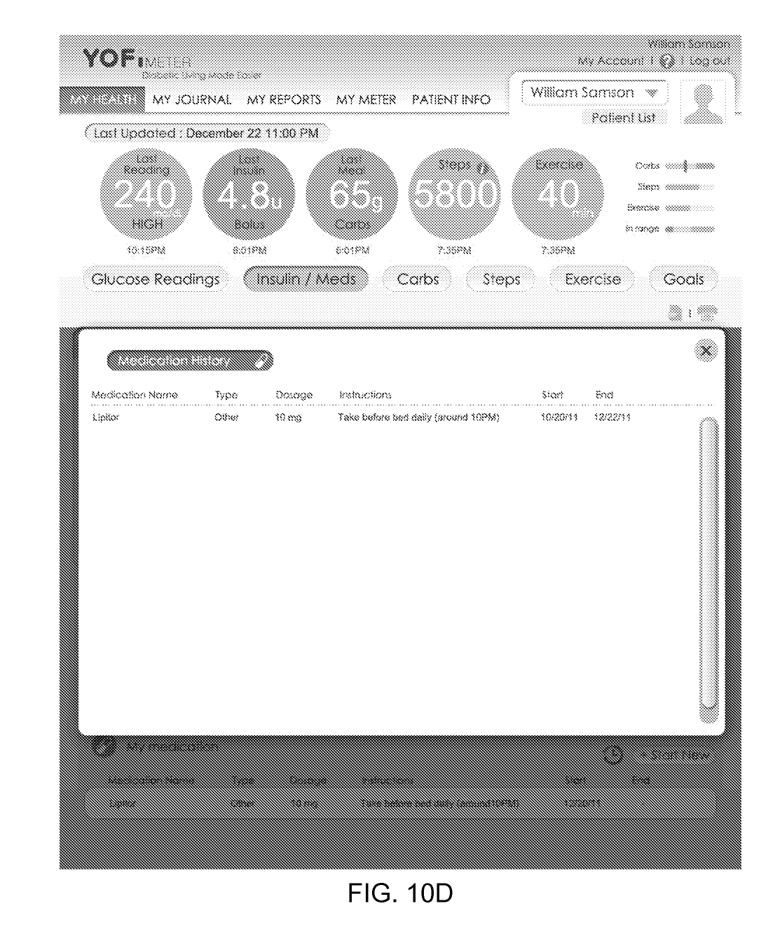

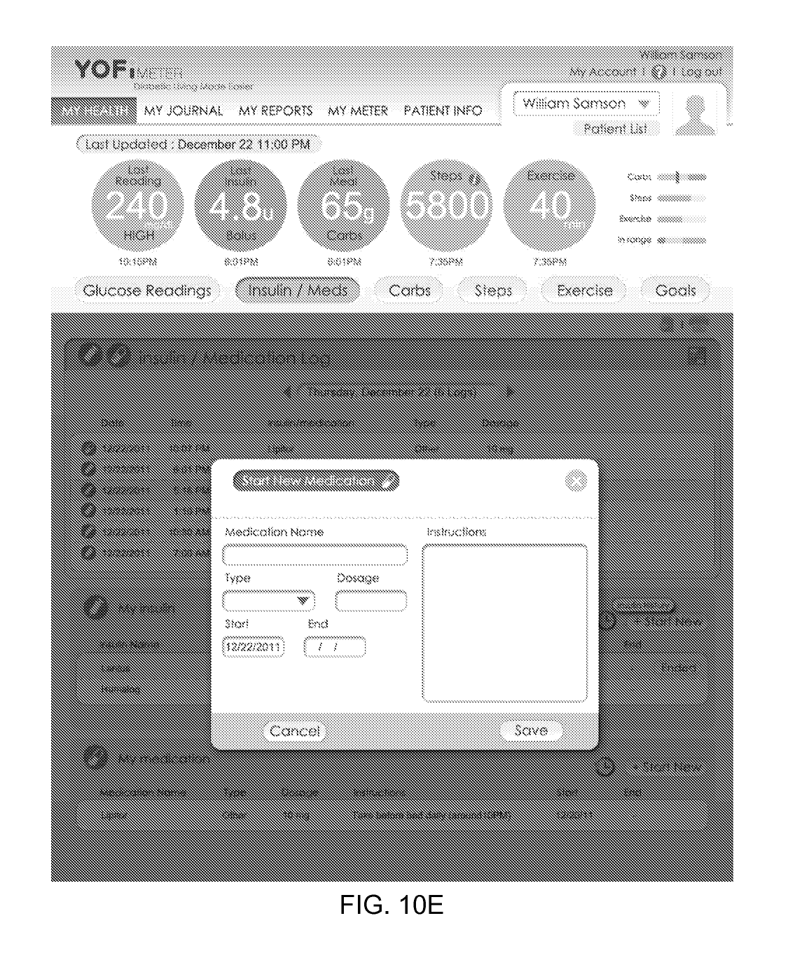

FIGS. 10A-10E show exemplary display screens of the exemplary medication (e.g., Insulin/Meds) module of the interactive user interface. For example, as shown in FIG. 10A, the display interface of the exemplary Insulin/Meds module can display a log (e.g., represented graphically and/or textually) of various data detailing insulin administration by the patient, e.g., including, but not limited to, data, time, type and subtype of medication, and dosage. For example, the exemplary medication module can store and display medication information for other types of medications taken by the patient, e.g., such as medications not directly related to the medical condition for which the user utilizes the analyte monitoring system. For example, as shown in FIG. 10B, the exemplary Insulin/Med module includes an interface to display the history of insulin medicine information, add a new type of insulin medicine information to the data module (also shown in FIG. 10C), and/or restart an existing insulin medicine to be shown as currently in use by the patient. For example, as shown in FIG. 10D, the exemplary Insulin/Med module includes an interface to display the history of other medicine information used by the patient, add a new type of other medicine information to the data module (also shown in FIG. 10E), and/or restart an existing other medicine to be shown as currently in use by the patient.

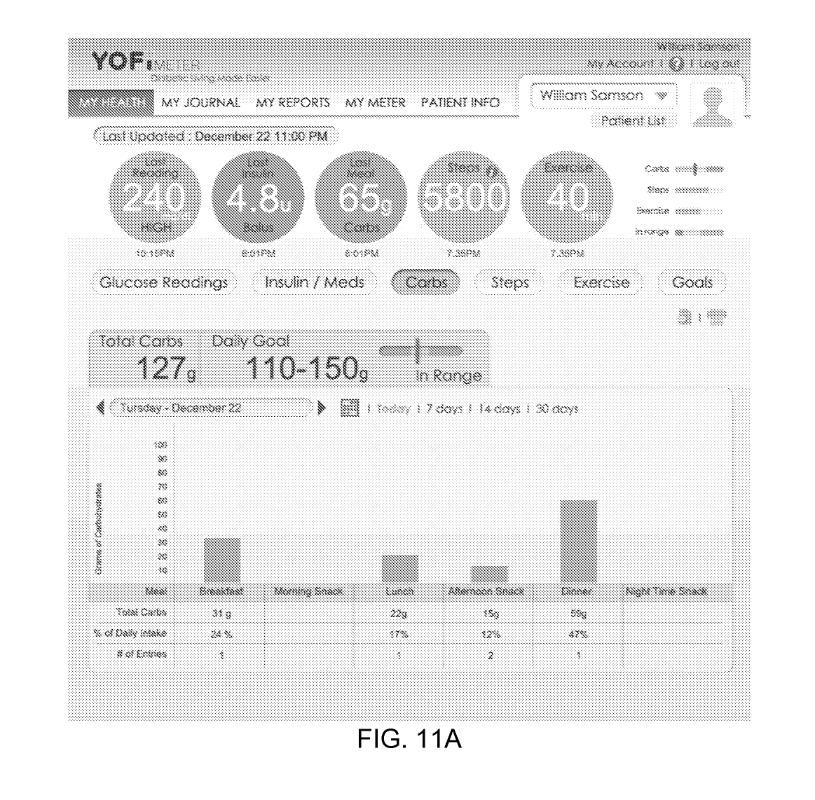

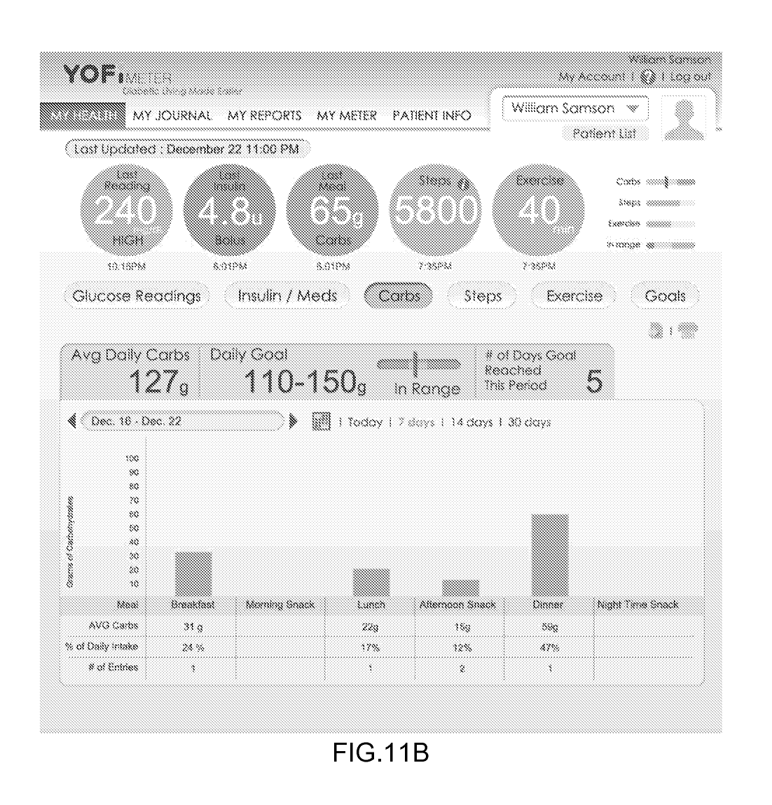

FIGS. 11A and 11B show exemplary display screens of the exemplary nutrition (e.g., Carbs) module of the interactive user interface. While the exemplary nutrition module is described here primarily based on carbohydrate nutrient intake to facilitate understanding of the underlying concepts, it is understood that the nutrition module can also include the monitoring of other nutrients in-taken by a patient, e.g., including, but not limited to, protein, fat, vitamins, minerals, and/or water. For example, the display interface of the exemplary Carbs module, as shown in FIGS. 11A and 11B, can display a log (e.g., represented graphically and/or textually) of various data detailing nutrition information based on food ingested by the patient on a single day (FIG. 11A) or over selected days (FIG. 11B). For example, the exemplary nutrition module can store and display nutrition information for each meal, e.g., breakfast, lunch, dinner, and snack(s) over a time course, such as a day, or week, etc. The nutrition information can be entered by the patient using any of the described exemplary devices including the disclosed user interface (e.g., the analyte meter device 301, the mobile device 302, and/or the computer device 303, e.g. via the web portal). The exemplary nutrition module can show the quantitative values of a nutrient (e.g., carbohydrates) including its amount or % of daily intake for a particular meal, or a multitude of meals over a time course. The data can be displayed graphically, as well as shown in a range (e.g., low, target, or high range) based on a user's goal.

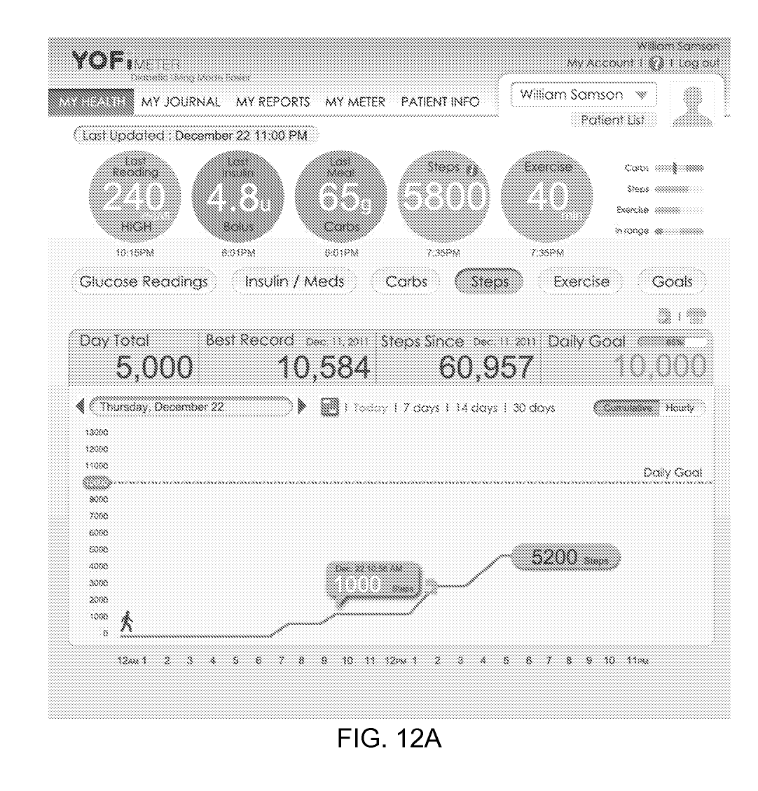

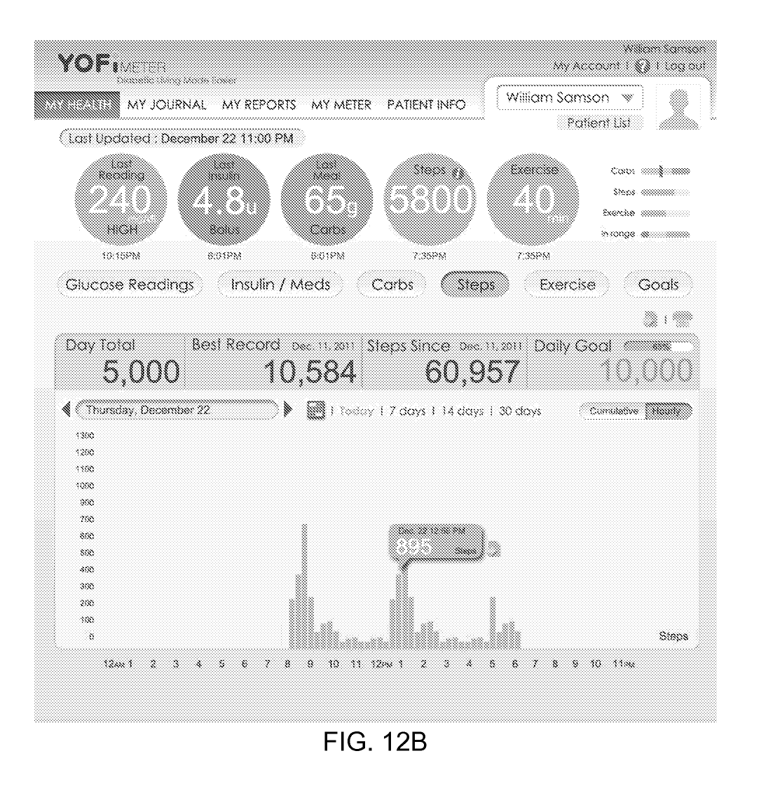

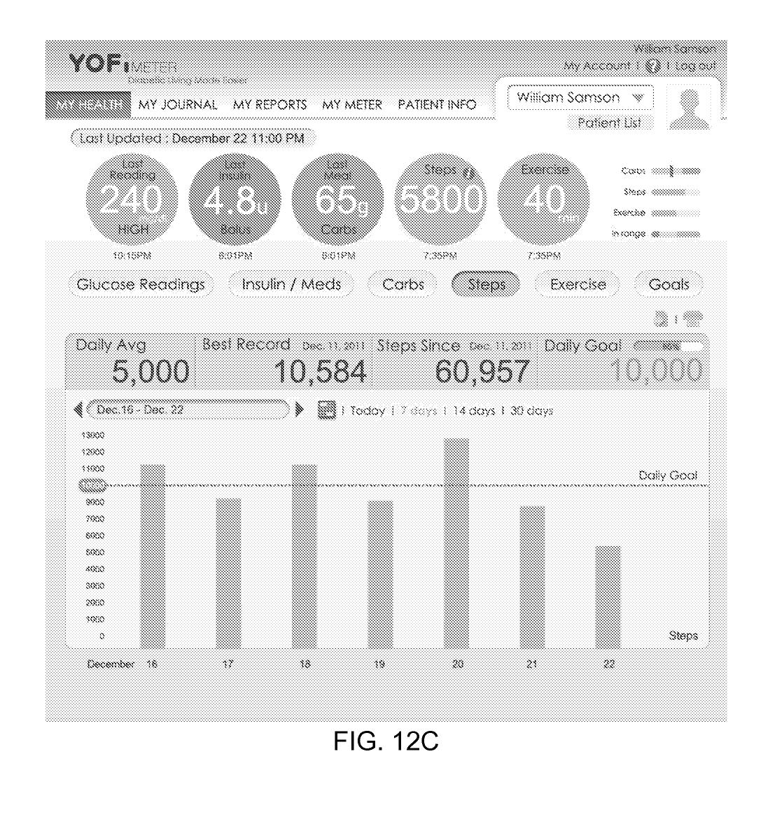

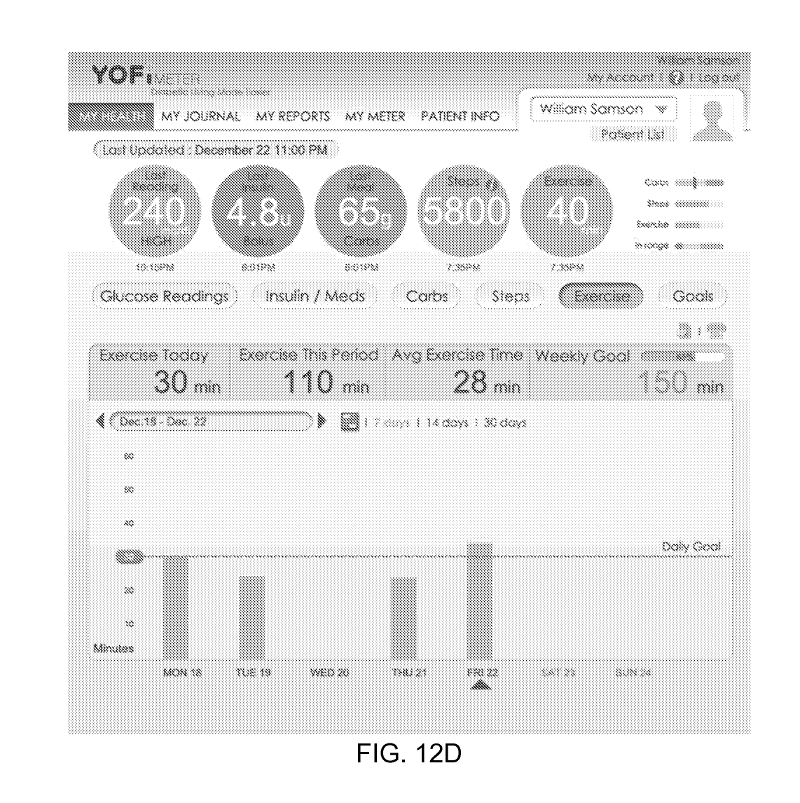

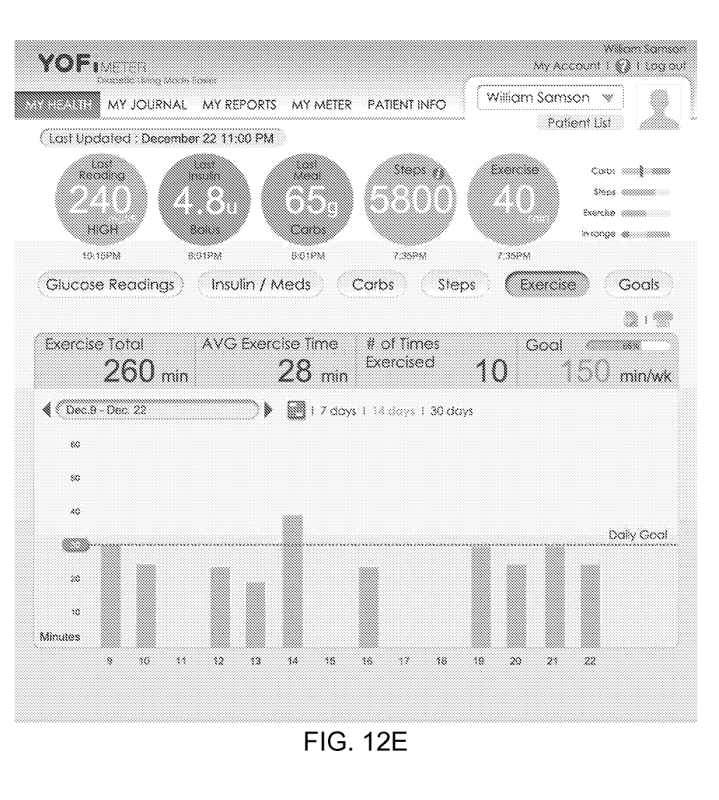

FIGS. 12A-12E show exemplary display screens of the exemplary fitness module (e.g., Steps module and Exercise module) of the interactive user interface. For example, the display interface of the exemplary Steps and Exercise modules can display a log (e.g., represented graphically and/or textually) of various data detailing physical activity information exhibited by the patient. For example, the number of steps a patient user takes can be recorded by a pedometer (e.g., such as a pedometer device included in the analyte meter device 301, or other device, such as a smart phone executing the disclosed user interface) and inputted into the Steps module, e.g., for analysis and display by the Steps module, as shown in FIGS. 12A-12C. FIG. 12A shows a cumulative display of steps data over the course of a single day, while FIG. 12B shows an hourly display of the steps data over the course of the single day. FIG. 12C shows the steps data displayed over a course of several days. For example, the number of steps can be analyzed and shown to the user as averaged over one day or multiple days, based on a goal or threshold having reached, e.g., and the steps data can be shown relative to the patient goal. For example, the pedometer included in the analyte meter device 301 can be configured to be continuously operative, e.g., which can perpetually track a patient user's steps without having to be activated or deactivated by the patient. The Steps module can be configured to automatically reset the number of steps for a given time interval. For example, the Steps module can be configured to reset the number of recorded steps by the pedometer in the analyte meter device 301 at the beginning of each day, e.g., 00:00:00 (h:m:s) or 12:00 AM.

Also, for example, the amount of time a patient user exercises can be recorded and inputted by the patient, e.g., for analysis and display by the Exercise module, as shown in FIGS. 12D and 12E. For example, the amount (e.g., minutes) of exercise readings can be analyzed and shown to the user as averaged over one day or multiple days, based on a goal or threshold having reached, such as a lowest or highest, and a percentage of time spent performing the physical activity.

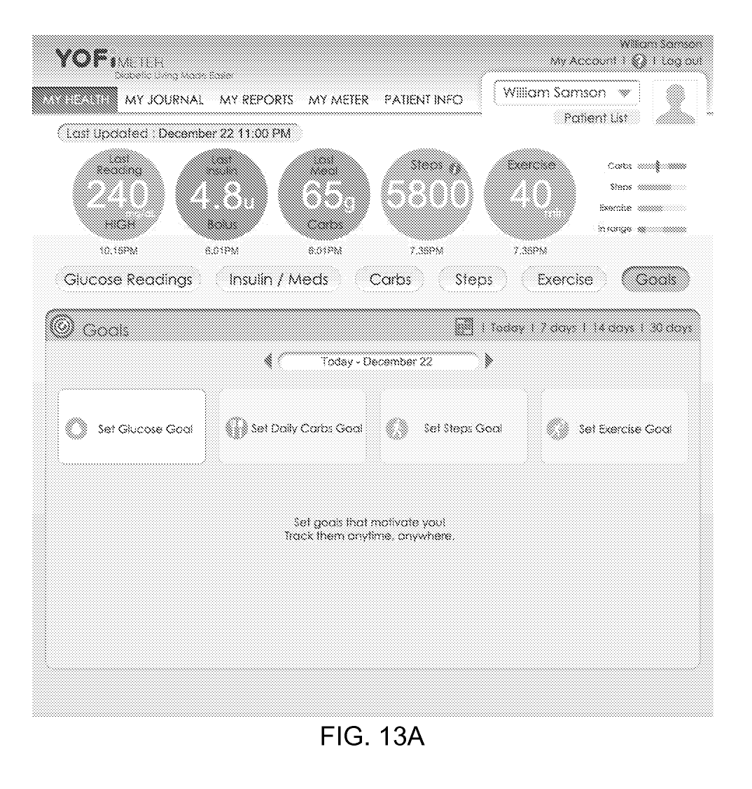

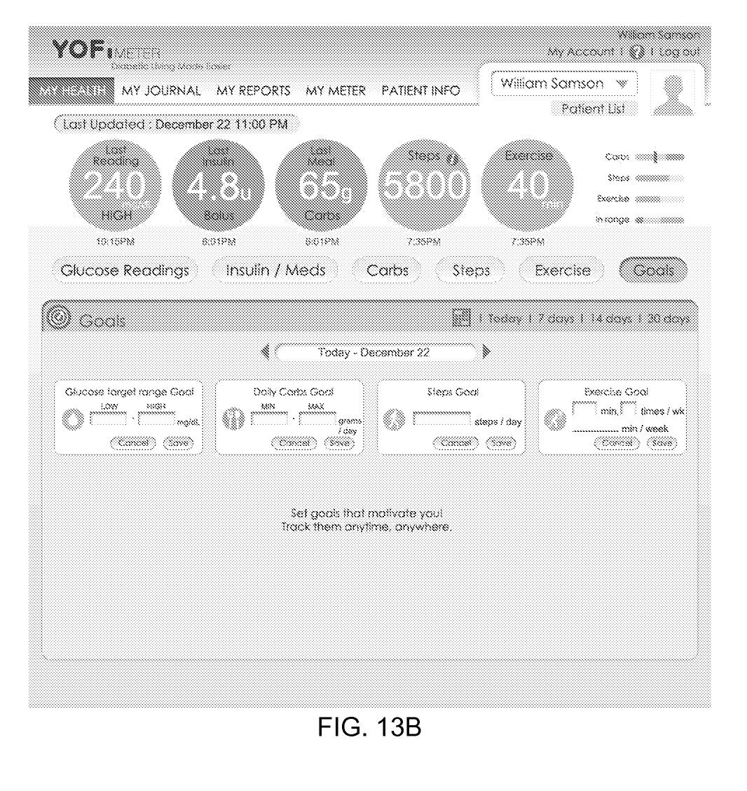

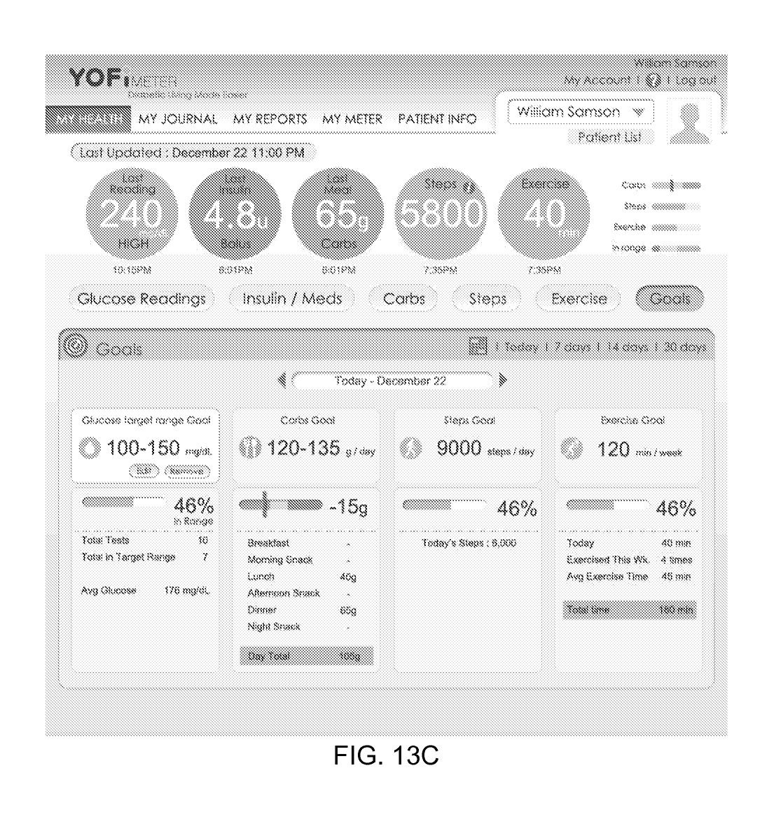

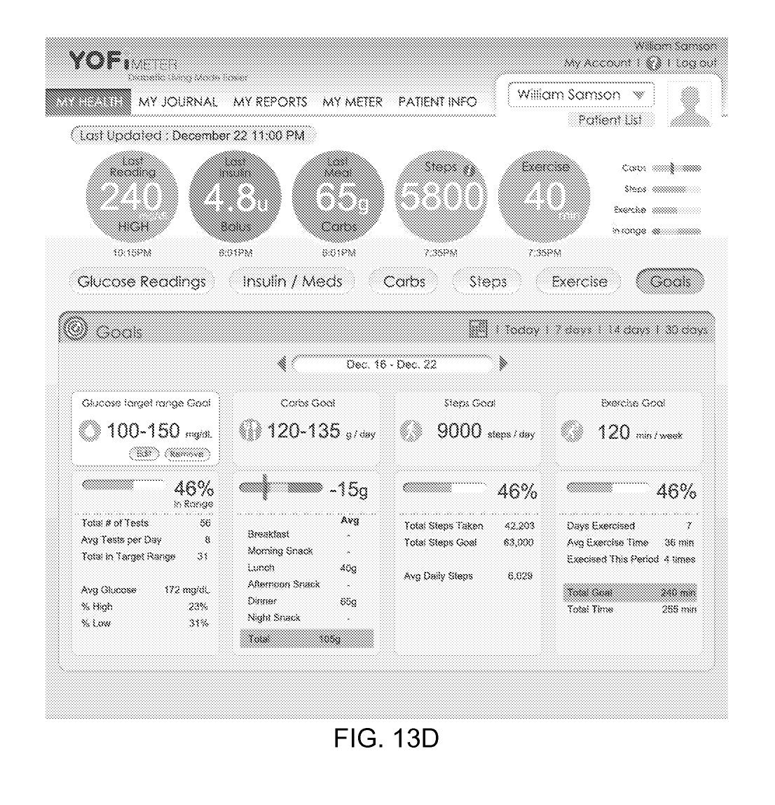

FIGS. 13A-13D show exemplary display screens of the exemplary goals module of the interactive user interface. As shown in FIGS. 13A and 13B, the Goals module can allow for a user to set thresholds of various user activities in which a user can access using other data modules, e.g., glucose level, nutrition intake, steps taken, and exercise duration. For example, thresholds can be set based on high, target, and low range values, amount of activity over a particular time duration, or total amount of activity, among other types of thresholds. Also for example, the thresholds for any of the health parameters can be set over a desired date range. As shown in FIGS. 13C and 13D, the Goals module can present the user health information data with the corresponding goals and further analyzed data that can show how low or how high the user health information data was below or above the target goal, for example. For example, the display interface of the exemplary Goals module can display various user health information data detailing each type of data and its corresponding goal data for a single day (FIG. 13C) or over selected days (FIG. 13D).

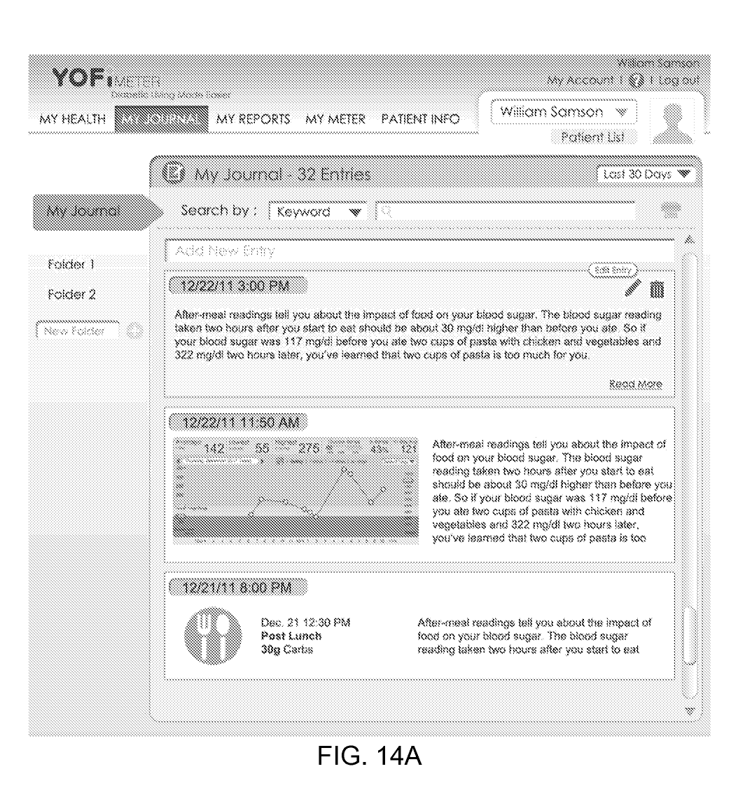

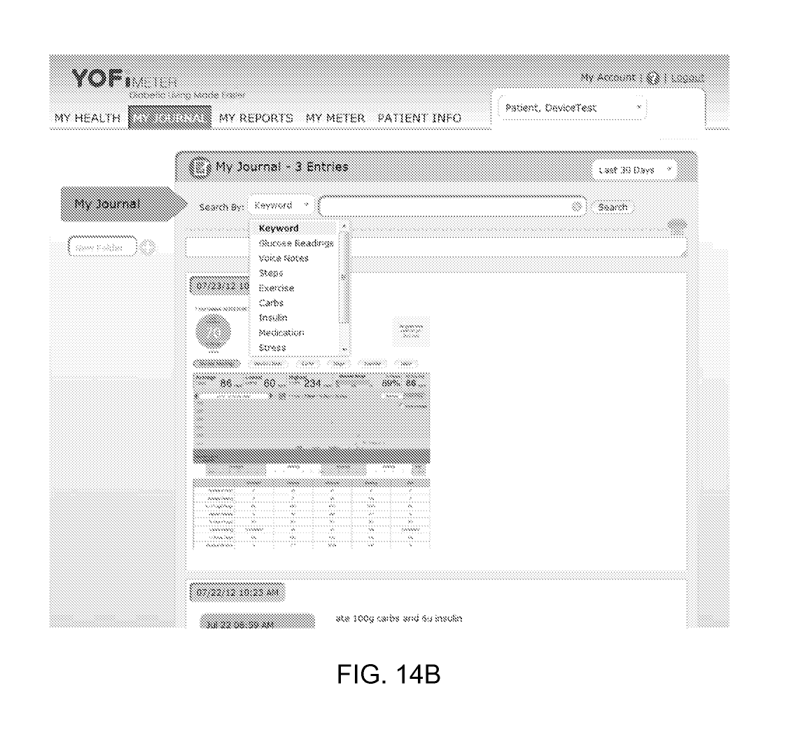

FIGS. 14A and 14B show exemplary display screens of the exemplary journal module of the interactive user interface. For example, as shown in FIG. 14A, the journal module can include user input data including text, images, and/or audio data and/or a snapshot image of the interactive user interface displayed on a display screen of the computing device, e.g., which can allow a user to make retrievable notes associated with events and/or particular health information that occurred at a particular date and time. The journal module can enable a user to enter information, e.g., such as narratives and health information, and review that information at any time. For example, the journal module can allow the user to provide personal notes and take snapshots of graphs and data in other modules (e.g., such as the health information modules). A user can select one or more types of data from the health information modules to be inputted into the journal associated with the date and time (e.g., data including analyte level measurements, insulin and/or medications, nutrition, exercise and/or steps, stress, illness, as well as voice notes and graphs, or other types of data not shown in the exemplary figures), as well as add notes, which can be associated with a test or various tests over a time course (such as a day), and add this information to the journal (e.g., which can be accessed in the journal module). Exemplary journal entries can be saved for future reference (e.g., in the database) by the user. For example, a patient can enter notes on his/her well-being, activity, medication, and analyte monitoring experiences for a caregiver to review. For example, a user can filter journal entries through keywords or data type to retrieve such stored information. In some implementations, for example, the user can perform a keyword search in the following exemplary ways. In one example, the user can type in a keyword to search through written text of the journal. In another example, as shown in FIG. 14B, the user can select one of any pre-stored keywords from a dropdown menu, e.g., such as, but not limited to, Glucose Readings, Insulin, Medication, Carbs, Steps, Exercise, Stress, Sick, Voice Notes, and Graphs, to search through the items, images, and data exported to journal. For example, snapshot images (e.g., of a displayed graph including one or more types of a patient's health information plotted over a particular period of time) exported into the journal can include dynamic data that provides the ability for retrieval based on a search of the data. For example, if a user exports a snapshot of health information to the journal relating to a patient's steps over time, e.g., which can be exported from various modules of the exemplary interactive user interface, then the user can search for those entries by searching “Steps” from the keyword dropdown menu, since the journal module can filter through all of the journal entries and retrieve and present only items relating to steps.

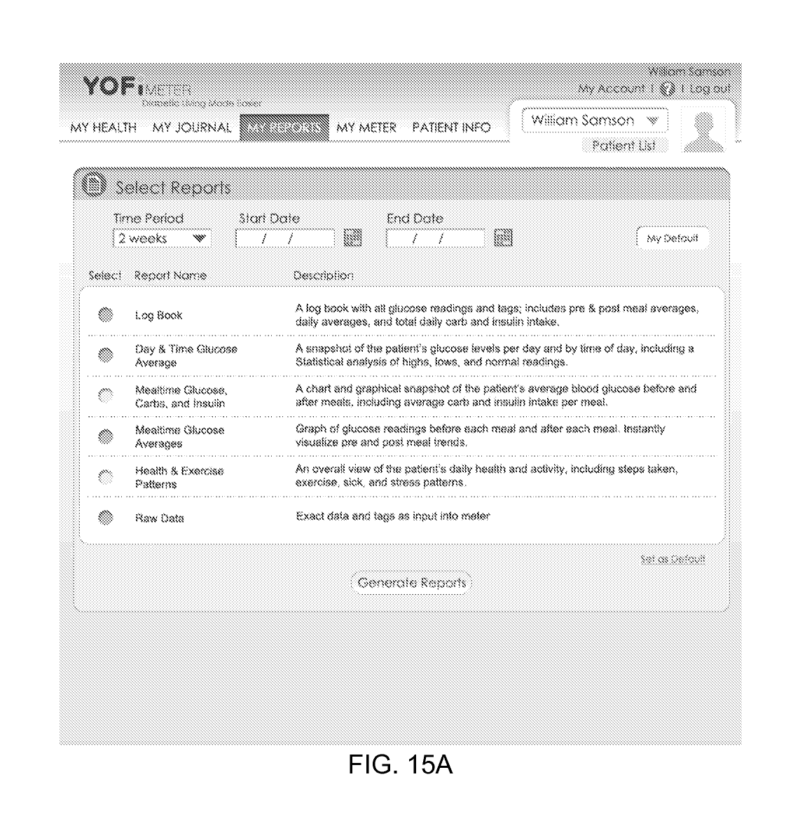

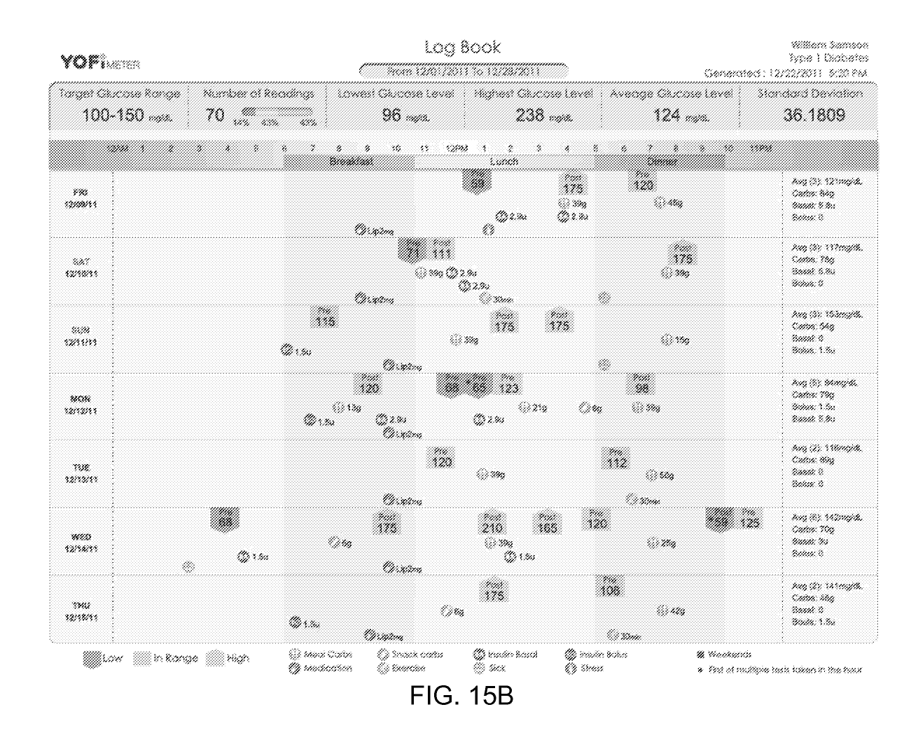

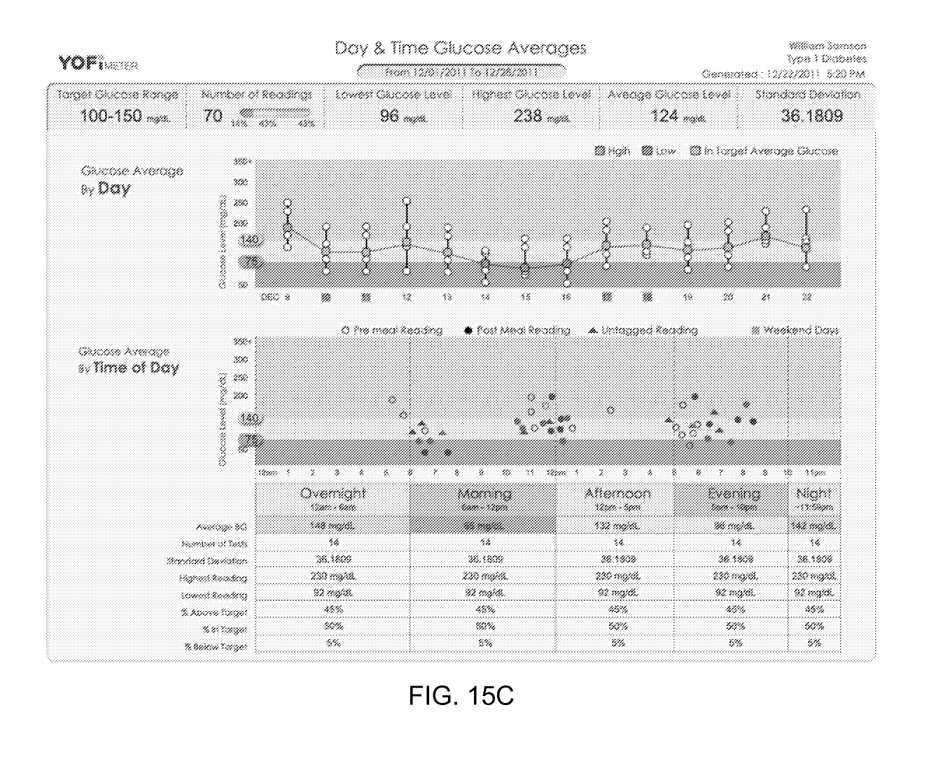

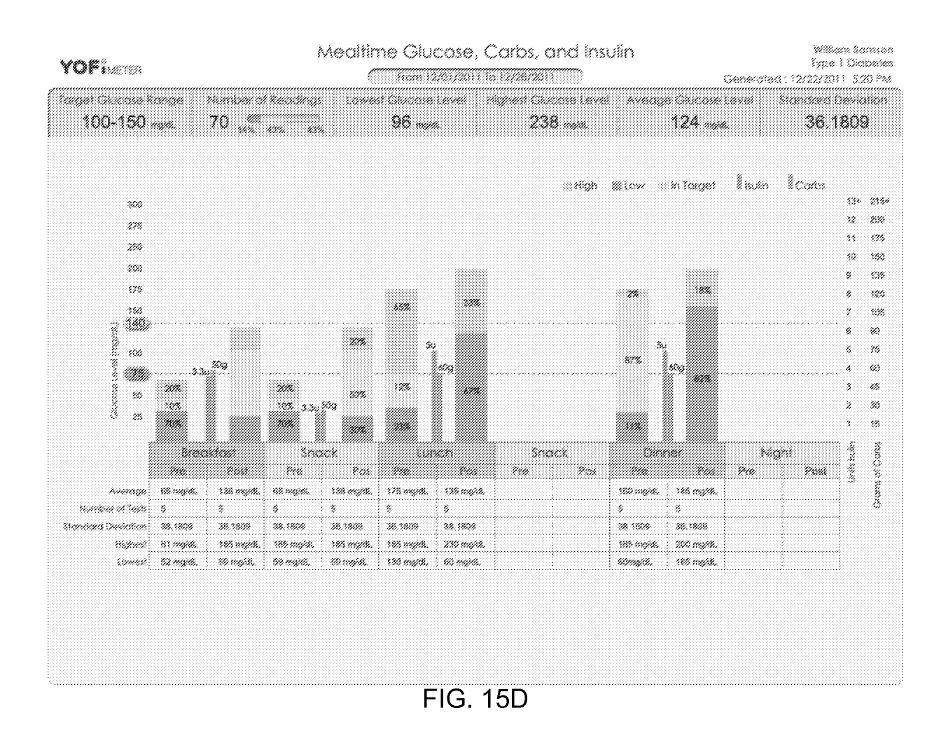

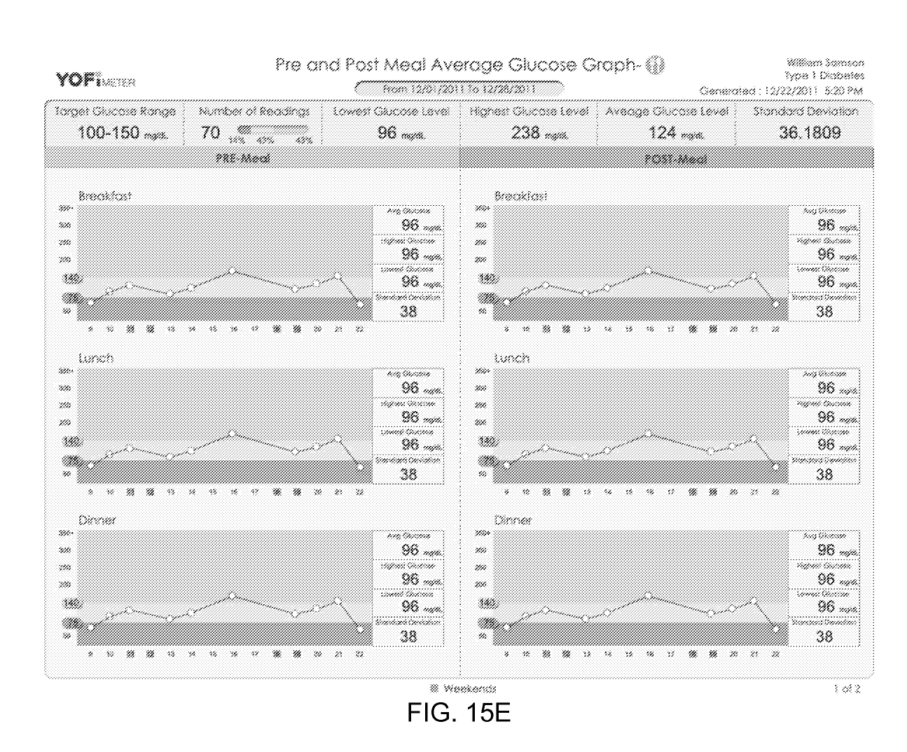

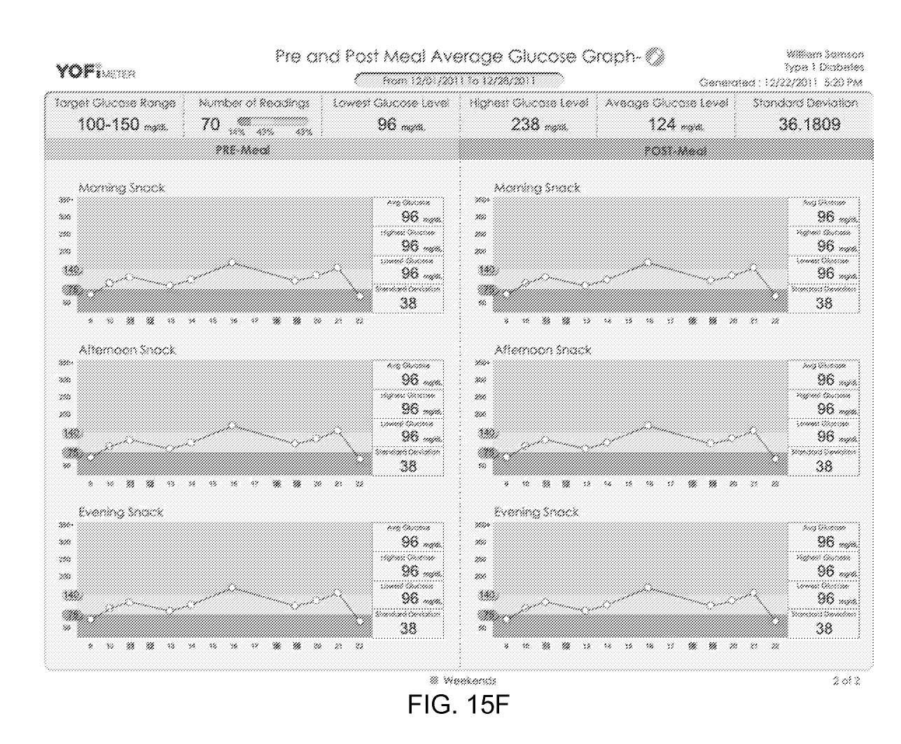

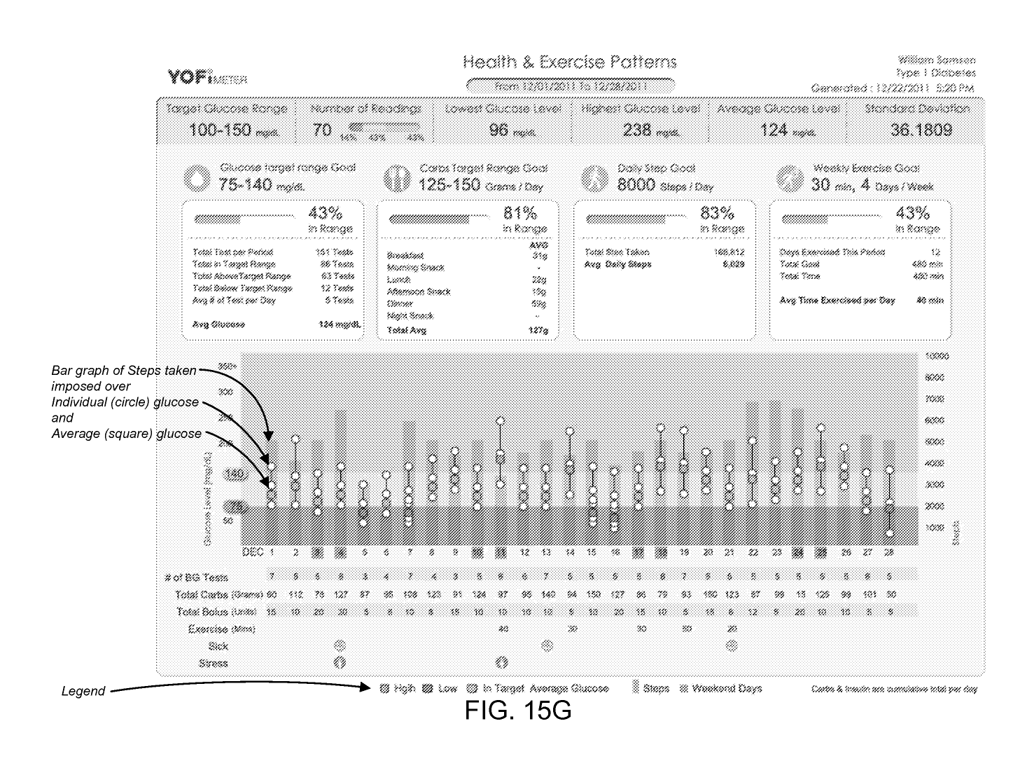

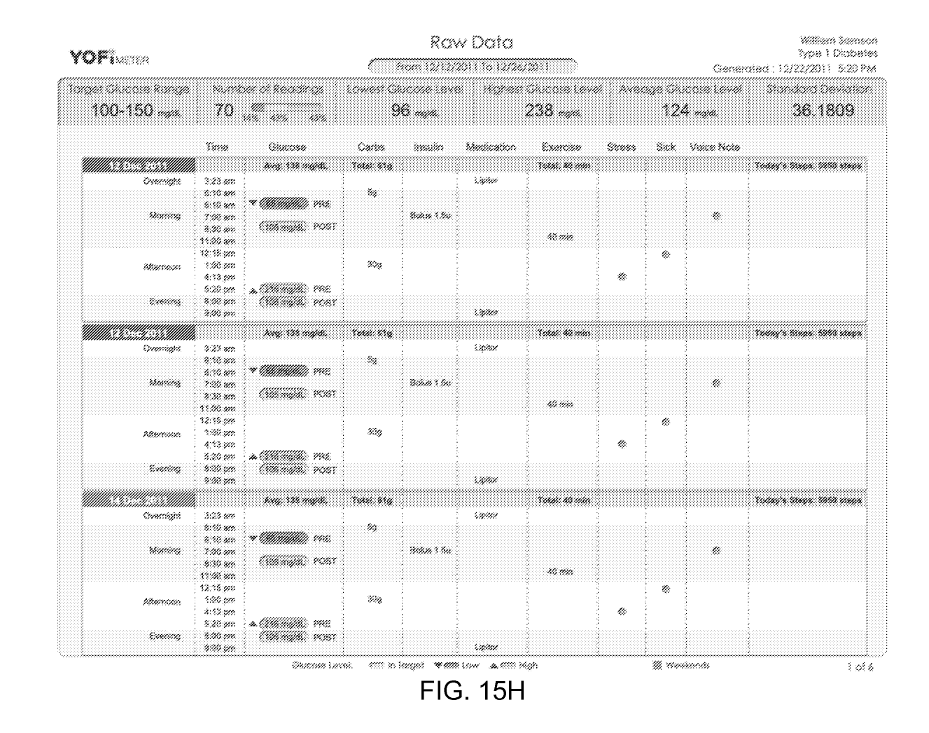

FIGS. 15A-15H show exemplary display screens of the exemplary reports module of the interactive user interface. The reports module can enable a user to export data reports on any of the health information stored in the database, e.g., similar to or the same as the health information displayed in the health information module previously described. For example, the data reports that include the textually and graphically represented health data that includes analyte level, medication, nutrition, steps taken, and exercise duration information over a time course, a range, and other representations. For example, the data reports can be formatted to be all-inclusive of the health data and events and organized based on temporal parameters (e.g., such as, in the case of a table-like format in a log book, having the time of day horizontally displayed and the day or selected time frame vertically displayed), in which the health data and events are identified in different color and shaped icons and can include associated text or symbols.

As shown in FIG. 15A, the reports module can include an interface for the user to select data parameters of the generated report, e.g., including the time period and/or a start date and end date, and a report type. For example, the report type can include, but is not limited to, a Log Book report; a report of Day & Time Analyte Averages; a report of Mealtime Analyte, Nutrition, and Medication values, a report of Mealtime Analyte Averages; a Health & Exercise Patterns report; and/or a Raw Data report, in which any of these reports can be combined in a single report. For example, the Log Book report can include analyte (e.g., glucose) readings and health information tags, pre- and post- meal averages, daily averages, and a total daily intake of nutrition (e.g., carbohydrates) and medicine (e.g. including insulin and other medicine). For example, the Day & Time Analyte Averages Report can include analyte (e.g., glucose) levels per day and by time of day including statistical analysis of highs, lows, and normal readings. For example, the Mealtime Analyte, Nutrition, and Medication Report can include average analyte (e.g., glucose) levels before and after meals including average intake of nutrition (e.g., carbohydrates) and medicine (e.g. including insulin and other medicine) per meal. For example, the Mealtime Analyte Averages Report can include analyte (e.g., glucose) readings before each meal and after each meal, e.g., enabling visualization of pre- and post- meal analyte level trends. For example, the Health & Exercise Patterns Report can include an overall view of the health and fitness activity including steps taken, exercise, sickness, and stress patterns. For example, the Raw Data Report can include the raw data and tags as input into the meter and/or data modules of the interactive user interface.

FIGS. 15B-15H shows examples of a display interface for the Log Book report (FIG. 15B), the Day & Time Analyte Averages report (FIG. 15C), the Mealtime Analyte, Nutrition, and Medication values report (FIG. 15D), the Mealtime (Pre- and Post-Meal) Analyte Averages report for meals (FIG. 15E) and for snacks (FIG. 15F), the Health & Exercise Patterns report (FIG. 15G), and the Raw Data report (FIG. 15H), respectively. The exemplary reports module can present the display interface of the respective data reports including tables, textual descriptions, various types of plots/graphs, or combinations thereof.

FIGS. 16A-16F show exemplary display screens of an exemplary meter interface module of the interactive user interface. For example, the meter interface module can provide information on the serial number of the analyte meter device, the patient assigned to use the device, the meter's last data synchronization with the database interacting with the described user interface, as well as the device's supply levels of analyte test strip cassettes, lancet cassettes, and/or other device components, as shown in FIG. 16A. Additionally, for example, the meter interface module can provide the user with the capability to deactivate the analyte meter device associated with the patient profile, as shown in FIGS. 16A and 16B. Referring to FIG. 16A, in one exemplary embodiment, the lancets or any other consumable in the meter device can be auto-ordered if the inventory of remaining consumable reaches a set threshold. This way, the patient does not have to manually keep track of and order supplies, which can be especially beneficial if the patient is traveling or cannot otherwise place an order. In another exemplary embodiment, the lancets or any other consumable in the meter device can be ordered by the analyte meter device owner using the analyte meter device or the web portal or mobile application on another device (e.g., computer device 303 or mobile device 302), if the inventory of remaining consumable reaches the set threshold. Such a functionality can be implemented as part of the meter interface module, or another module, such as patient information module. For example, the meter interface module, which can be accessed by the analyte meter device 301 or web portal on the mobile device 302 or other computer device 303, provides alerts and reminders to the analyte meter device 301, e.g., including reminders to the patient to have a snack or meal, take/administer medication, perform an analyte test, etc., as well as when and in what frequency to perform such actions, as shown in FIG. 16C.

In one exemplary embodiment, which can be implemented as part of the analyte meter device, the device can automatically sense a change in time zone and accordingly adjust the alerts based on the new time zone. For instance, the new time zones can be detected when the analyte meter device is connected to a cellular network or to the Internet. Upon detection of the new time zone, the user may be prompted to confirm whether or not the existing alerts should be adjusted according to the new time zone.

In another example, the meter interface module enables a user to change the threshold levels that separate target versus high versus low levels of the analyte (e.g., glucose). As the exemplary display interface in FIG. 16D shows, a first adjustable threshold (e.g., Low set to 80 mg/dL), and a second adjustable threshold (e.g., High set to 141 mg/dL) can be used to delineate the range of low glucose levels (below 80), target levels (between 80 and 141), and high levels (above 141). Another feature of the disclosed embodiments relates to assigning different coloring schemes for presentation of low, target and high ranges of analytes. For example, the differing color schemes can be configured such that they are distinguishable in black and white format, e.g., such as a black and white print out of an exemplary graphic of the analyte data plotted with or without other health related factors. In another example, the meter interface module can enable a user to enter personal information that can be associated with his/her analyte meter, e.g., including, but not limited to, pictures or messages that can be sent to the user when the user's data has fallen within a particular range, as shown in FIGS. 16E and 16F.

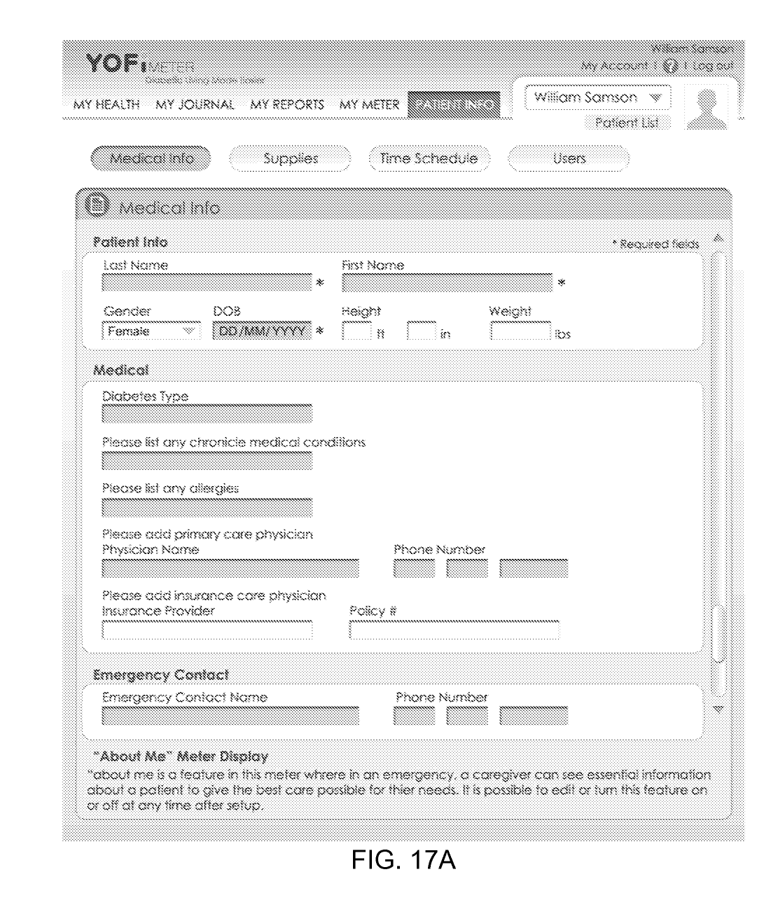

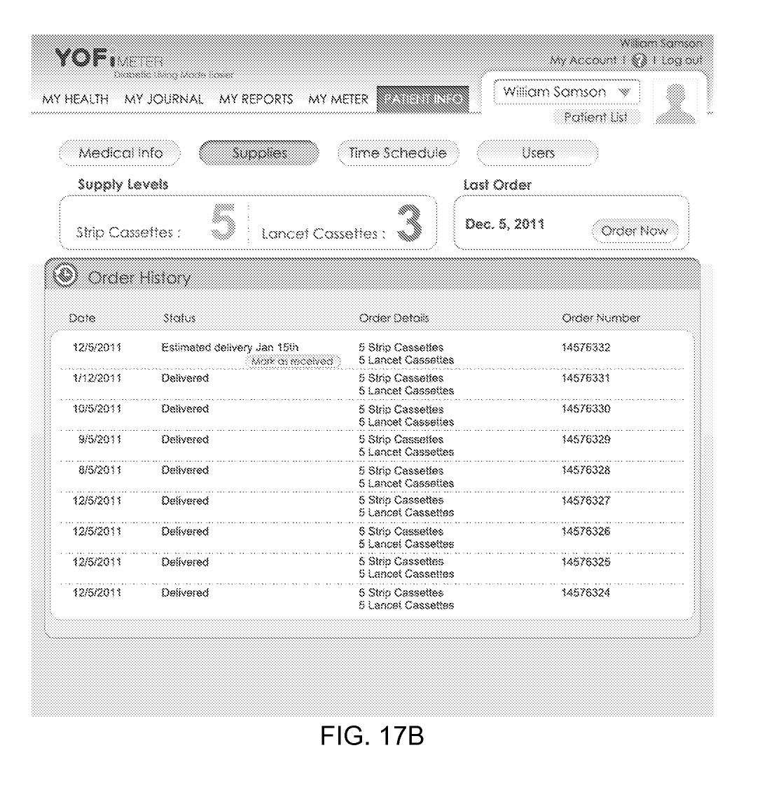

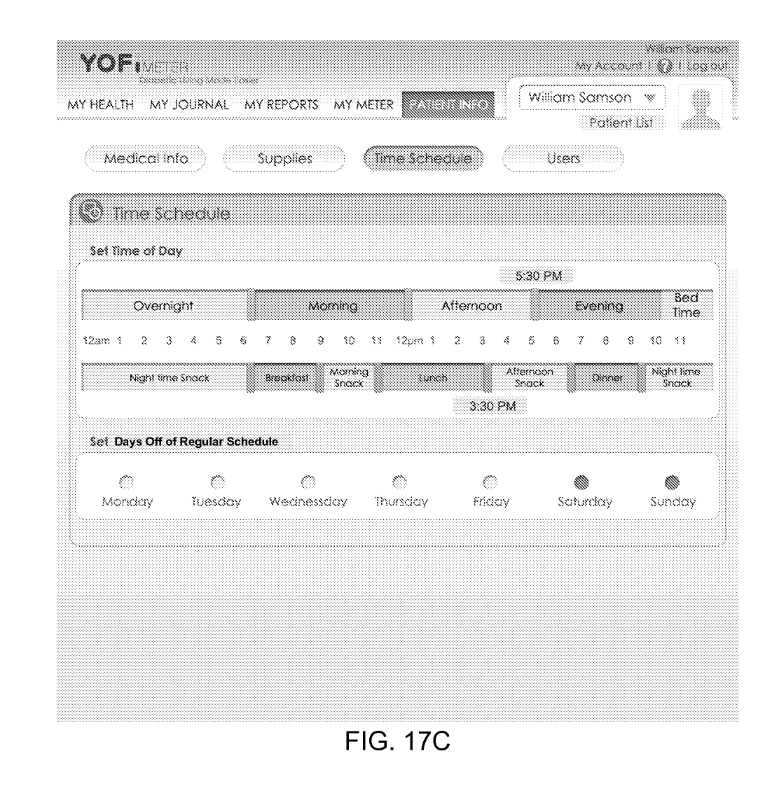

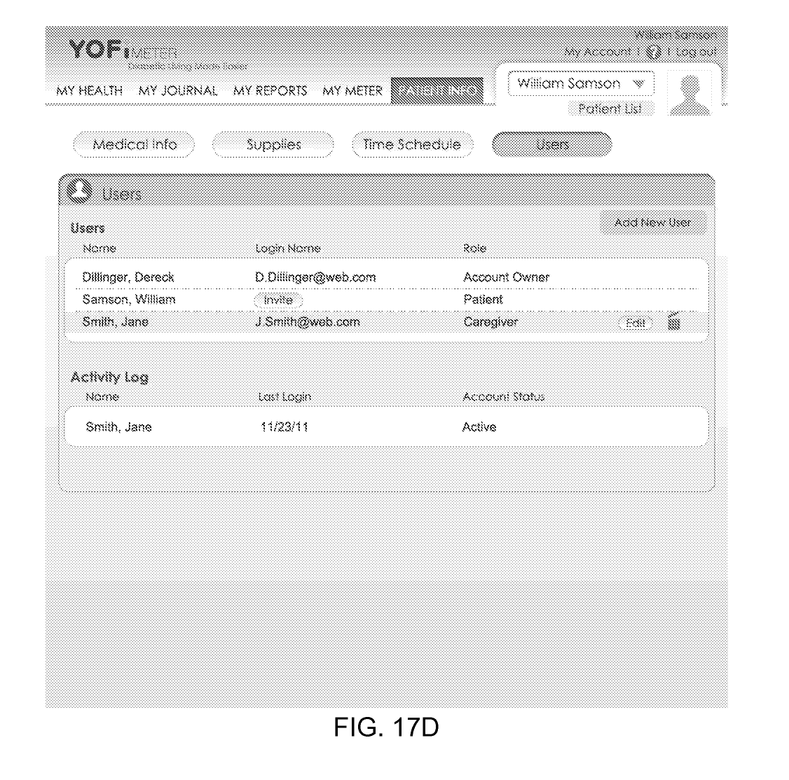

FIGS. 17A-17D show exemplary display screens of an exemplary patient information module of the interactive user interface, e.g., for an exemplary patient that can be selected from the patients list module by the caregiver user. As shown in FIG. 17A, the patient information module can provide a user with medical information about a patient (e.g., such as name, gender, date of birth, height, weight, disease type, list of chronic medical conditions, list of allergies, name(s) and contact information of doctor(s) and other health care provider(s), emergency contact information, etc. The patient information module can provide a user with supply information about a patient's analyte meter device or other biomedical devices, as shown in FIG. 17B, e.g., such as how many device components are currently in the device, as well as an order history of such components including delivery date and status, as well as other order details. As shown in FIG. 17C, the patient information module can provide a user with time schedule information about a patient, e.g., such as when a patient eats particular meals, administers tests and medications, etc., which can be used to alert the patient of a scheduled event (e.g., a meal time, a glucose testing time, or insulin injection time). The patient information module can enable the user to determine the hours for time schedule intervals, e.g., such as overnight, morning, afternoon, evening, and bed time. In some embodiments of the patient information module, for example, the patient's meal or nutrition intake information can be automatically assigned and organized based on time of intake during these user-defined intervals. For example, breakfast can be the first meal of the morning interval, and a subsequent food intake in the morning interval can be organized as a morning snack. This can advantageously provide a user (e.g., such as a caregiver) pre- and post-meal analysis of the user's glucose levels and how the food intake affects the glucose levels. In some embodiments, for example, the patient information module can include a selection option to set ‘days off’ from the regular schedule. For example, if the patient has a typical lifestyle routine or schedule during the weekdays (e.g., going to work) that differs from his/her lifestyle on the weekend, then the patient can deselect Saturday and Sunday from the schedule. For example, knowing a patient's regular schedule can help a caregiver better understand fluctuations in the patient's health data (e.g., measured glucose levels). As shown in FIG. 17D, the patient information module can provide a user with list of users (or entities) that play a role with the patient's health, e.g., such as a patient's caregiver, account manager, the patient him/herself, etc. Additionally, for example, the patient information module can provide the user with information about the login activity of any of the users using the exemplary interactive user interface.

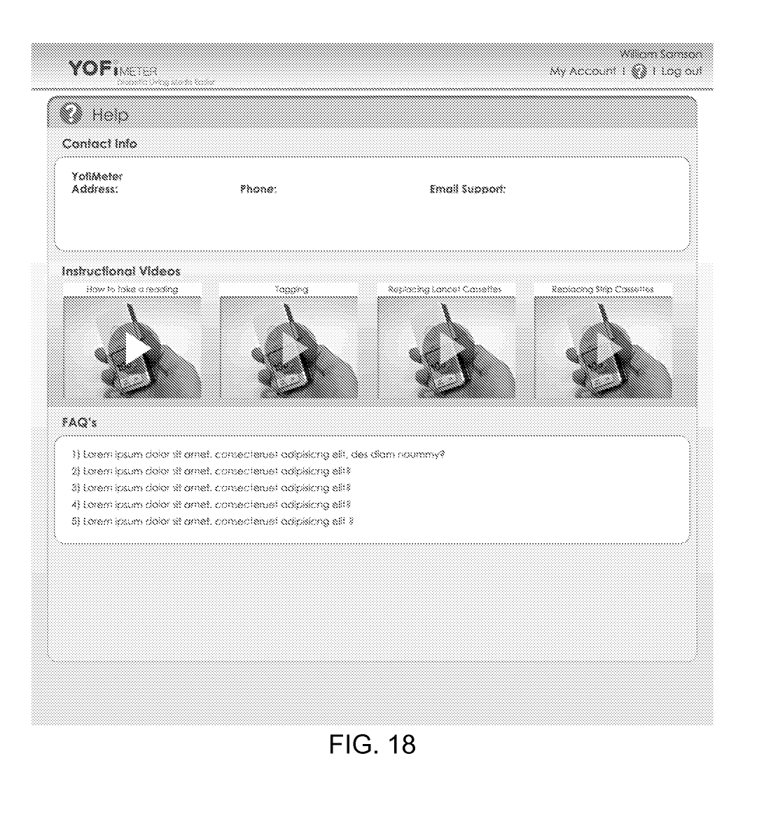

FIG. 18 shows an exemplary display screen of a help module of the disclosed interactive user interface for a user to attain instructional information (e.g., including videos and text), FAQ information, and technical support contact information.

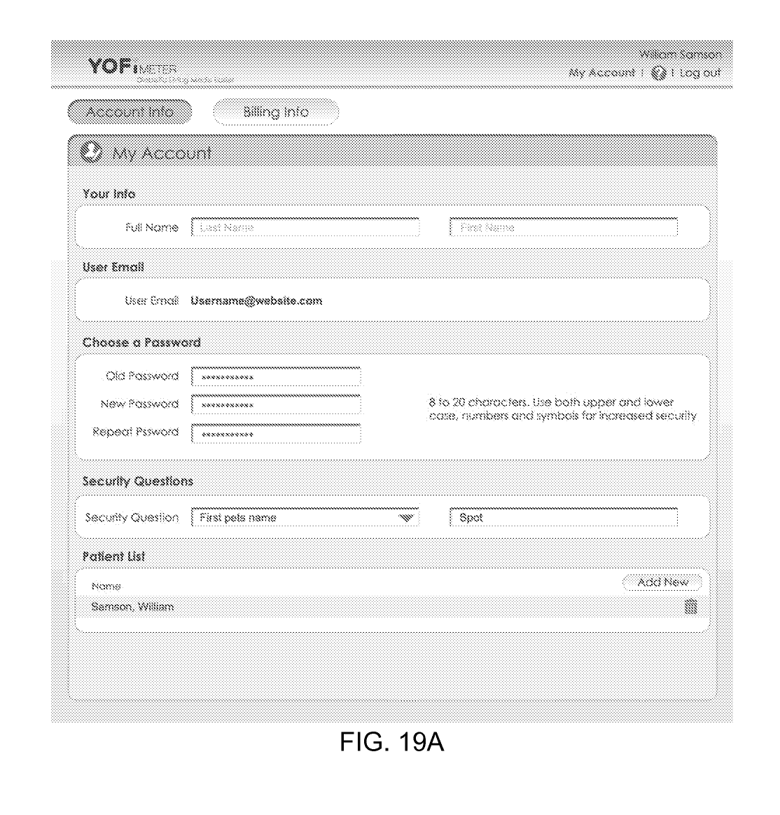

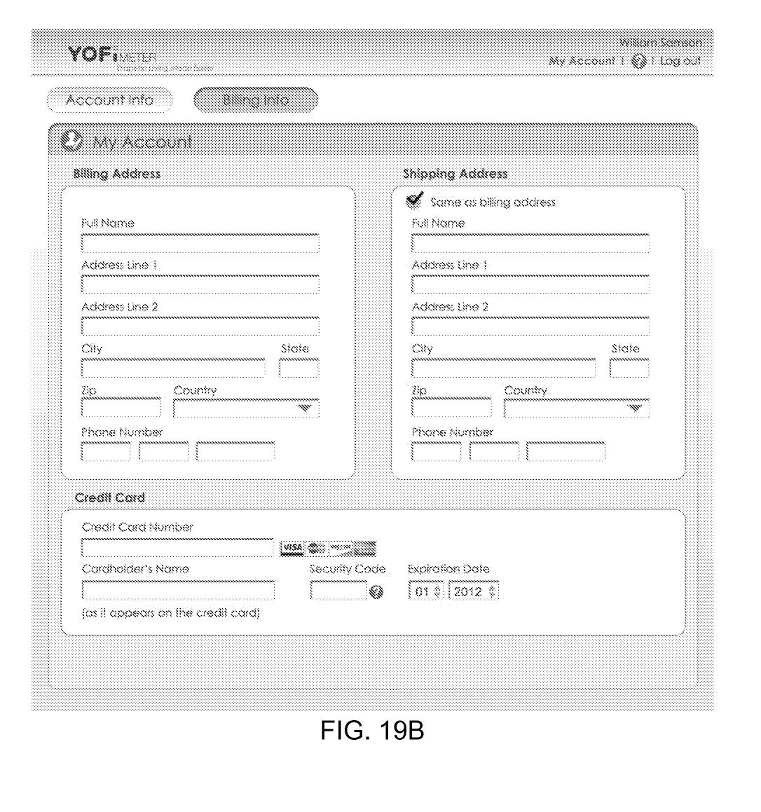

FIGS. 19A and 19B show exemplary display screens of an exemplary account and billing information module of the disclosed interactive user interface for a user to attain account and billing information, e.g., associated with the analyte meter device 301 and/or analyte monitoring services. For example, the account and billing information module can include an interface for the initial set up or editing of the user account information, e.g., including the user name, email, account security information (e.g., including password, security questions, etc.), patient lists, and billing, shipment, and payment information (e.g. credit card information).

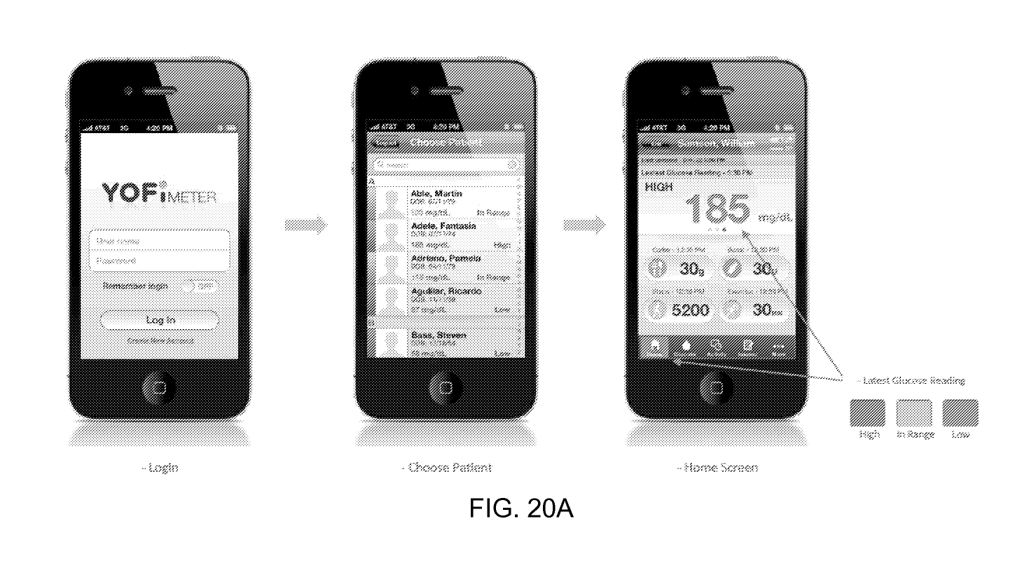

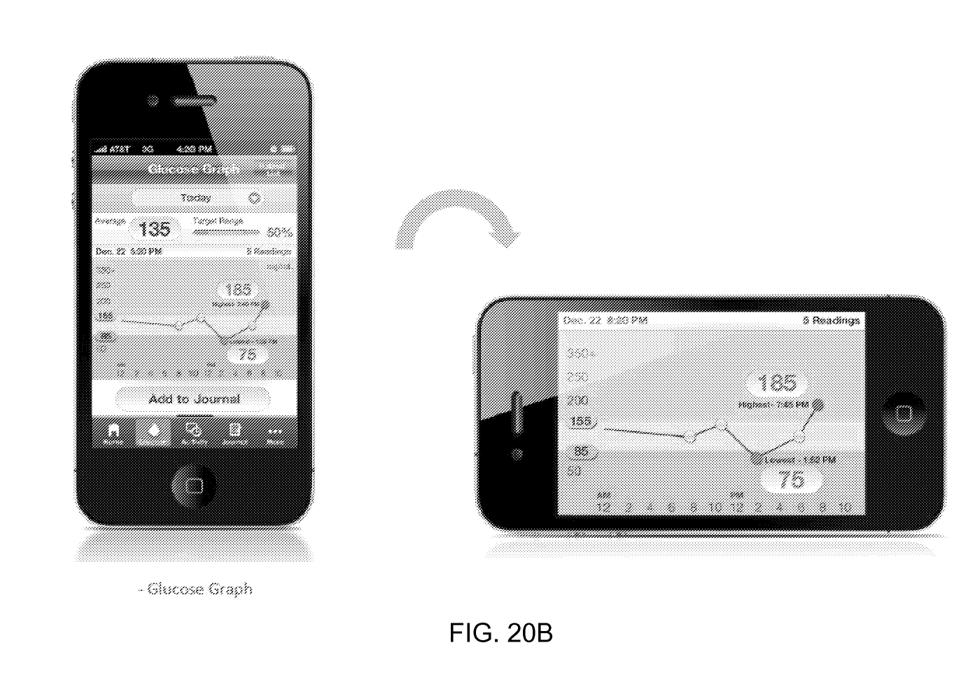

FIGS. 20A and 20B shows various exemplary display screens of an exemplary mobile software application to implement the disclosed interactive user interface on a mobile device. As shown in FIG. 20A, the mobile application interactive user interface can include data modules that display various display interfaces, e.g., including a login interface, a list of patients interface, and a home (screen) interface configured for a mobile display screen. FIG. 20B shows a display screen of the mobile device presenting an exemplary measured analyte level interface, e.g., including an analyte level data graph module. For example, the analyte level data graph module can include a patient's analyte level for one or more analytes (e.g., such as glucose) during the course of a day. The exemplary glucose level graphical interface features quantitative glucose measurements plotted in a range of low, desired range, and high glucose levels.

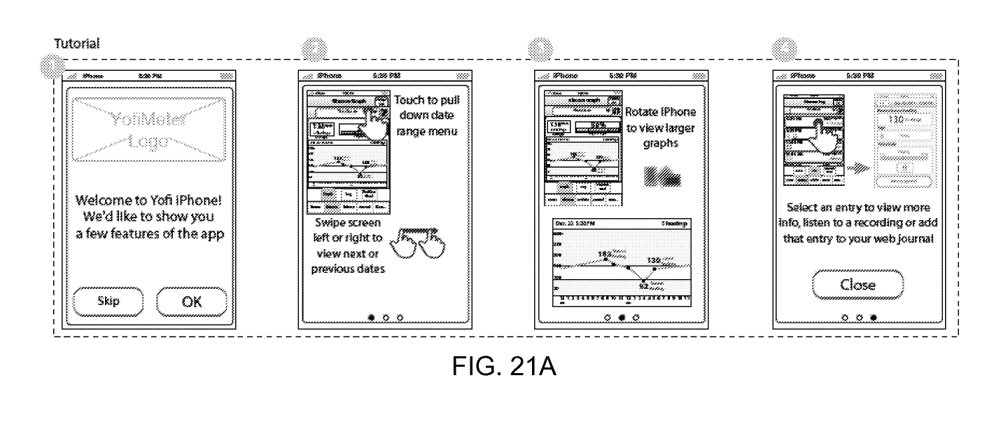

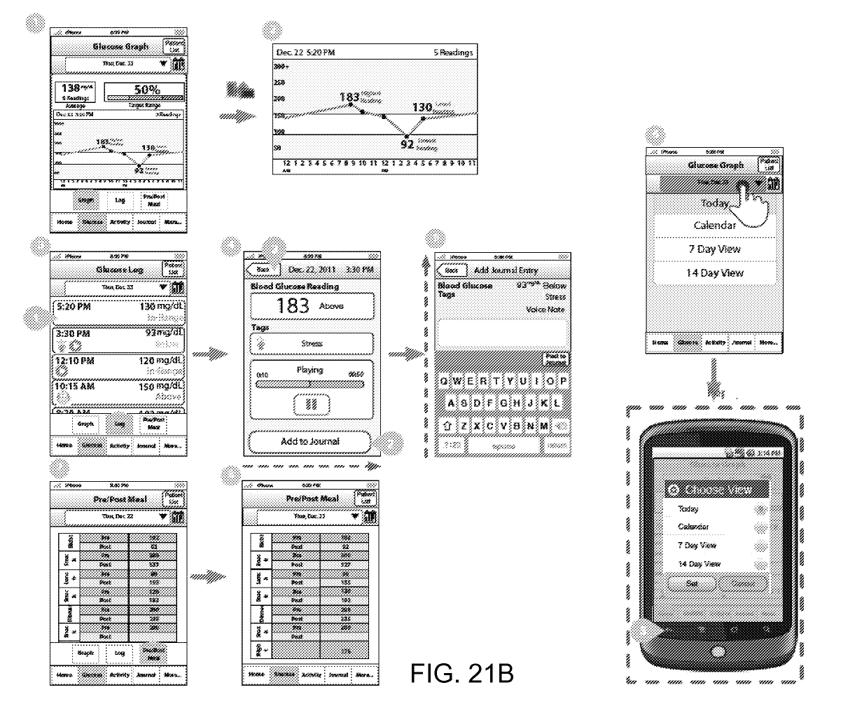

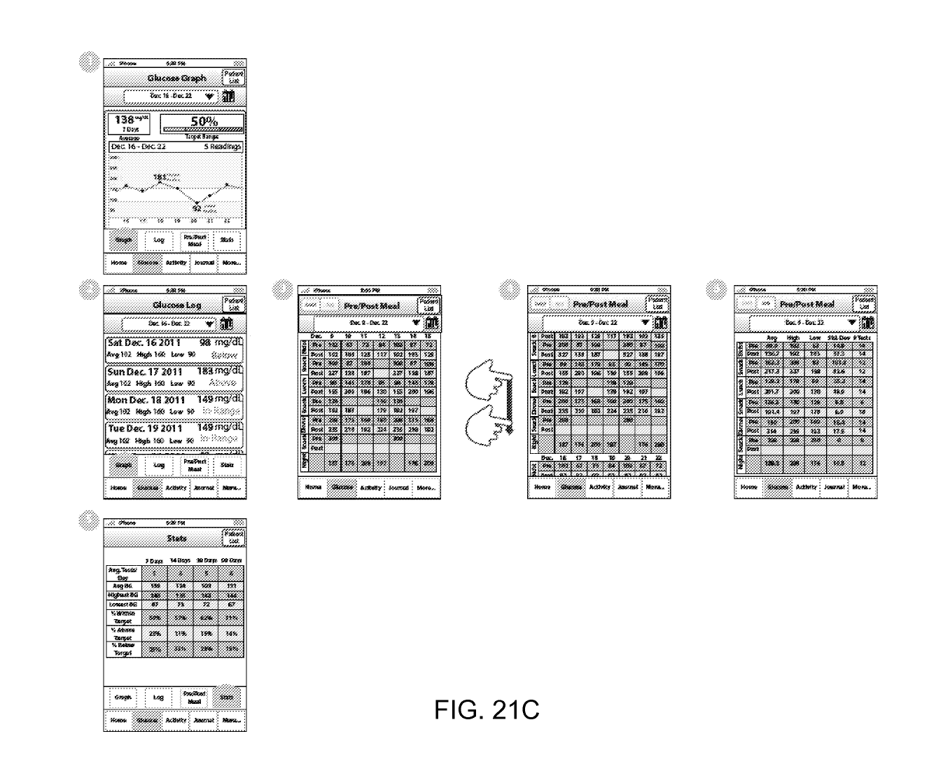

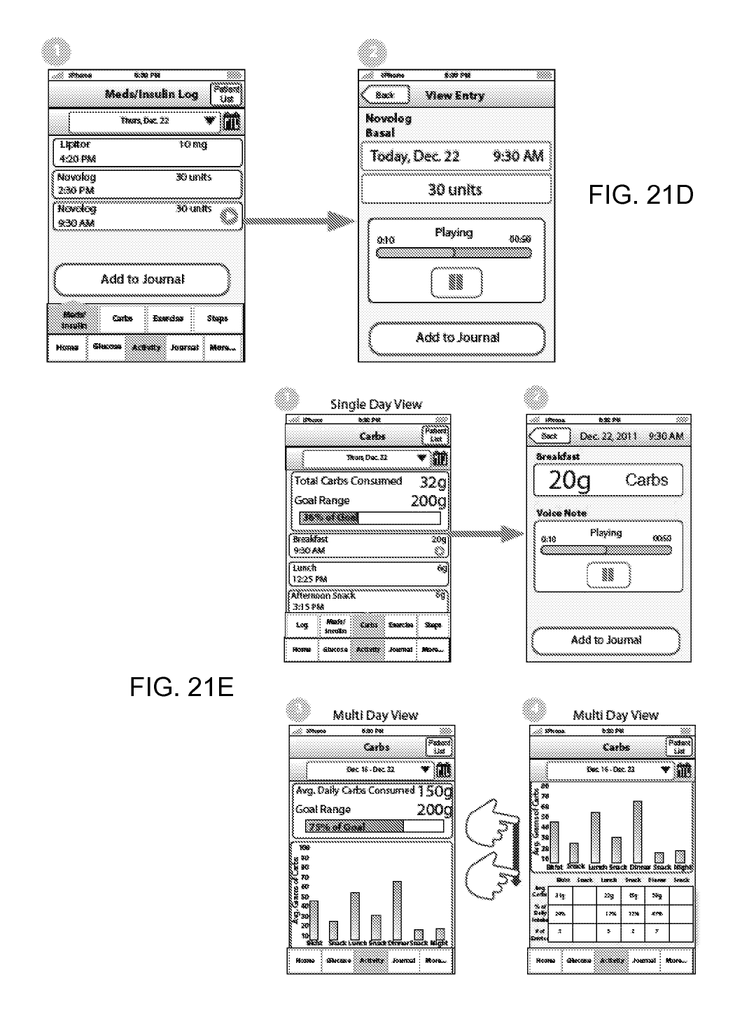

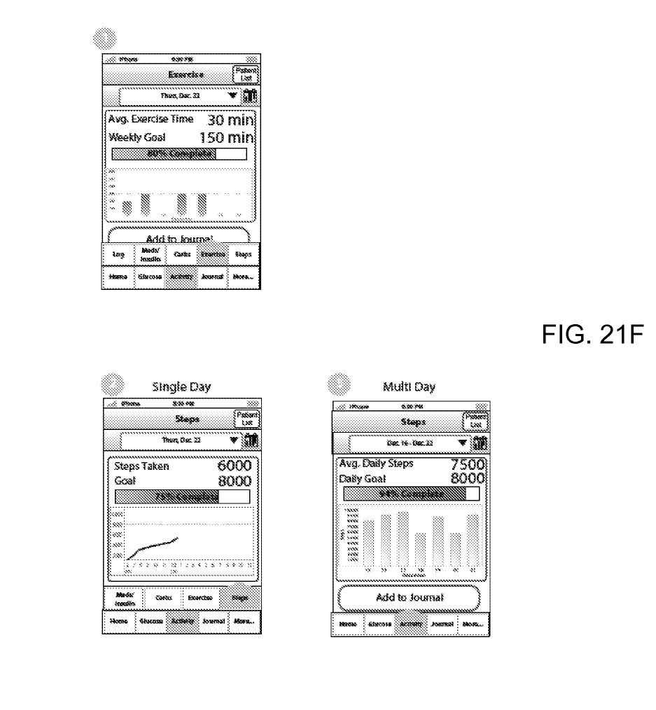

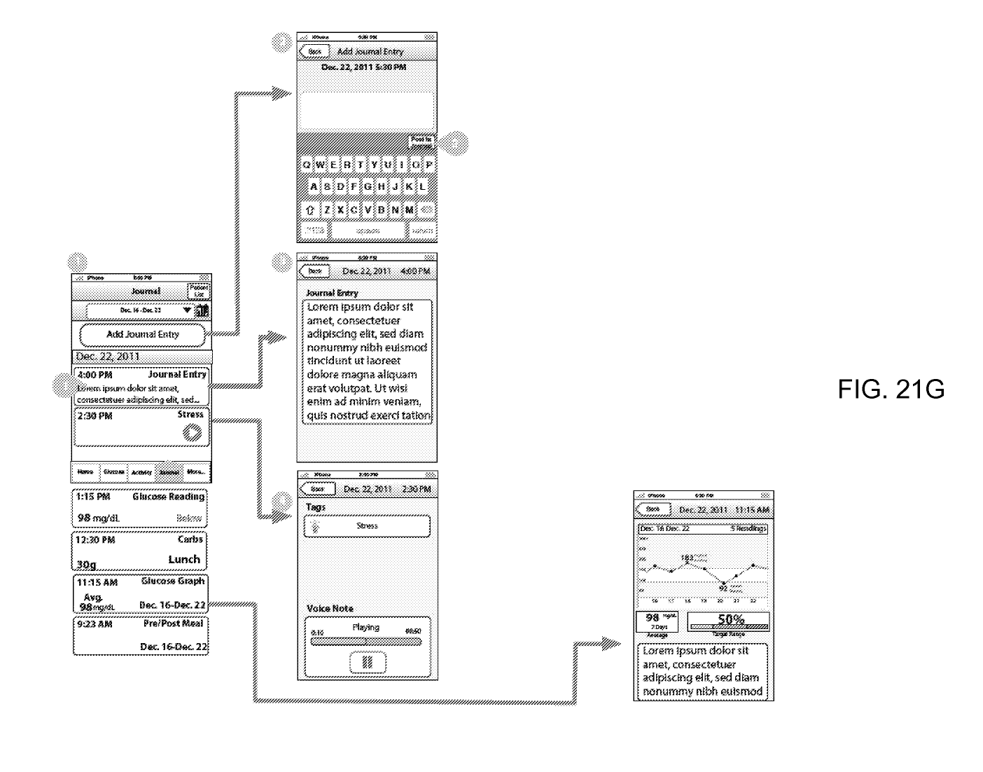

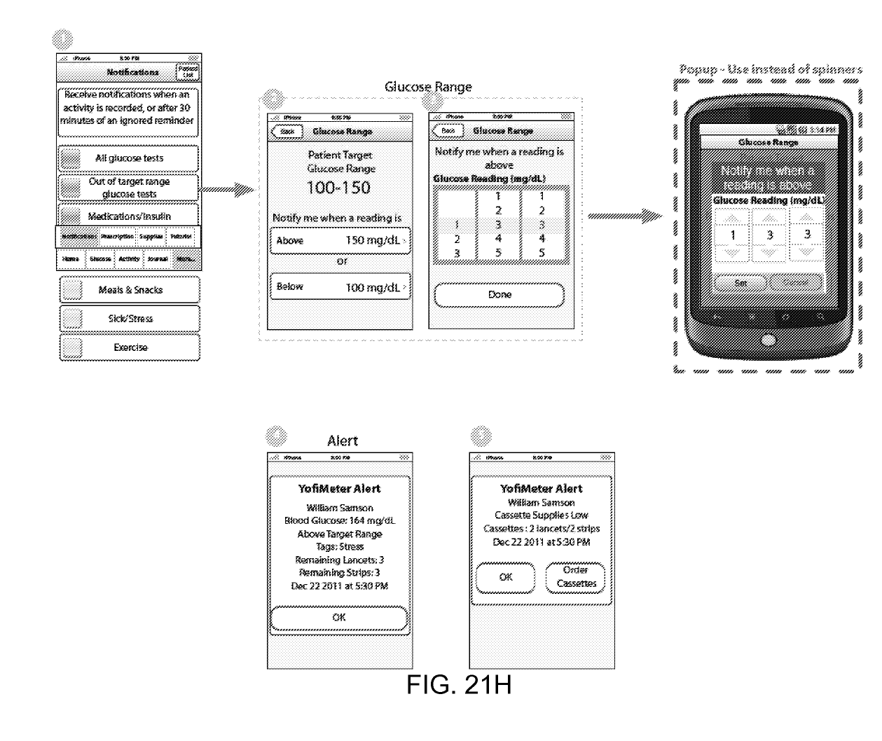

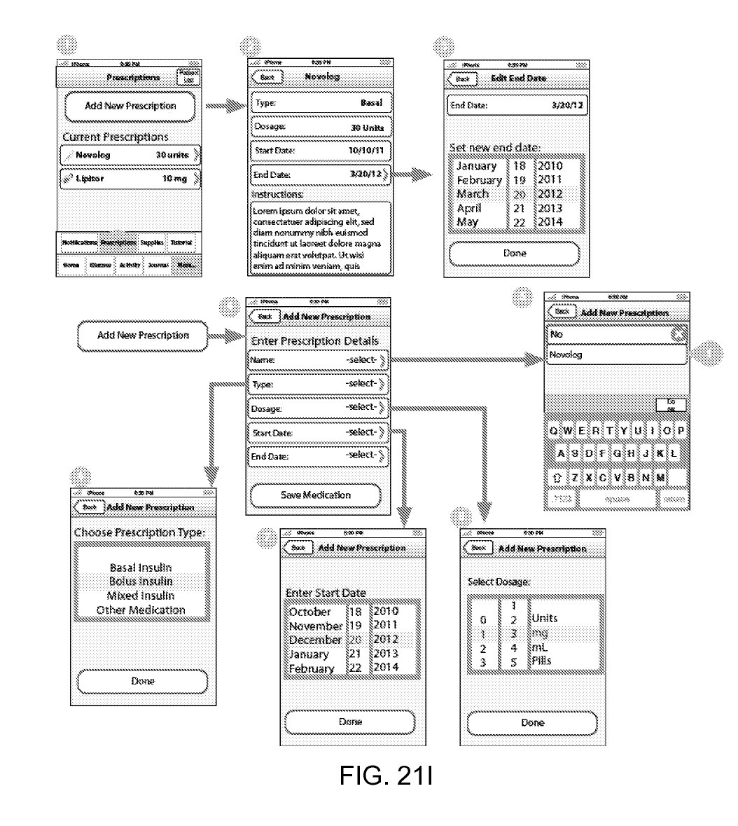

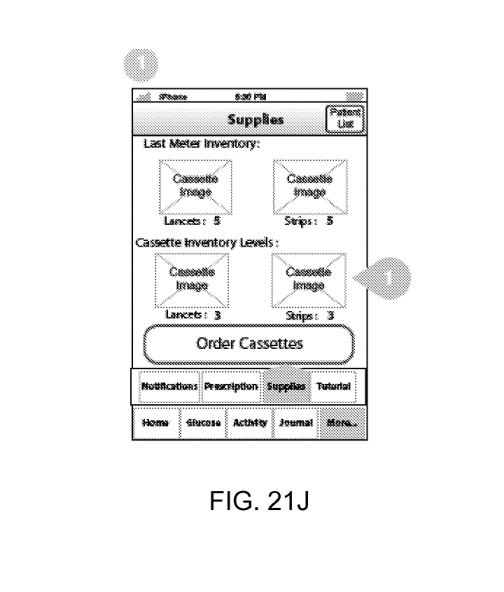

FIGS. 21A-21J show examples of display screens of the disclosed interactive user interface configured for operation using a software application implemented on the mobile device. The exemplary software application is stored on the mobile device and can access the database in the cloud, e.g., via wireless communication, to transmit and receive the health information data. The exemplary display screens of the user interface provided by the mobile software application include all or at least some of the functionalities of the disclosed user interface implemented on the exemplary web portal. As shown in FIGS. 21A-21J, the appearance of the user interface implemented through the mobile application may appear different than that of the user interface implemented through the web portal, but the user interface implemented through the mobile application can retain the same functionalities as those previously described.

FIG. 21A shows exemplary display screens of an exemplary tutorial to the exemplary mobile software application implemented on the mobile device, e.g., showing a user how the display screen can be rotated, enlarged, and navigated, among other functionalities. FIGS. 21B and 21C show exemplary display screens of an exemplary interactive user interface for the exemplary mobile software application presenting various health information data, e.g., including graphical, textual, and audio analysis of a patient's glucose information, log, journal, and other analyses. FIGS. 21D-21F show exemplary display screens of the exemplary interactive user interface for the exemplary mobile software application presenting various health information data, e.g., including graphical, textual, and audio analysis of a patient's medication and exercise information. FIG. 21G shows exemplary display screens of the exemplary interactive user interface presenting the journal module on the exemplary mobile software application, e.g., including journal entries of snapshot and inputted data, such as text entries, voice recordings, graph snapshots, etc. FIG. 21H shows exemplary display screens of an exemplary notifications module of the exemplary interactive user interface for the exemplary mobile software application showing notification setup interfaces, e.g., to set notification settings based on analyte level target ranges and/or thresholds and other health related factors, and notification/alert messages, e.g., sent to the patient user on his/her mobile device. FIG. 21I shows exemplary display screens of the exemplary medication module of the exemplary interactive user interface for the exemplary mobile software application showing medication prescription setup interfaces. FIG. 21J shows an exemplary display screen of the exemplary meter interface module of the exemplary interactive user interface for the exemplary mobile software application showing current inventories of test strips, lancets or any other consumable in the meter device, e.g., which can be auto-ordered if the inventory of remaining consumable reaches a set threshold or ordered based on the user manually ordering the consumables using the exemplary interactive user interface displayed on the mobile device.

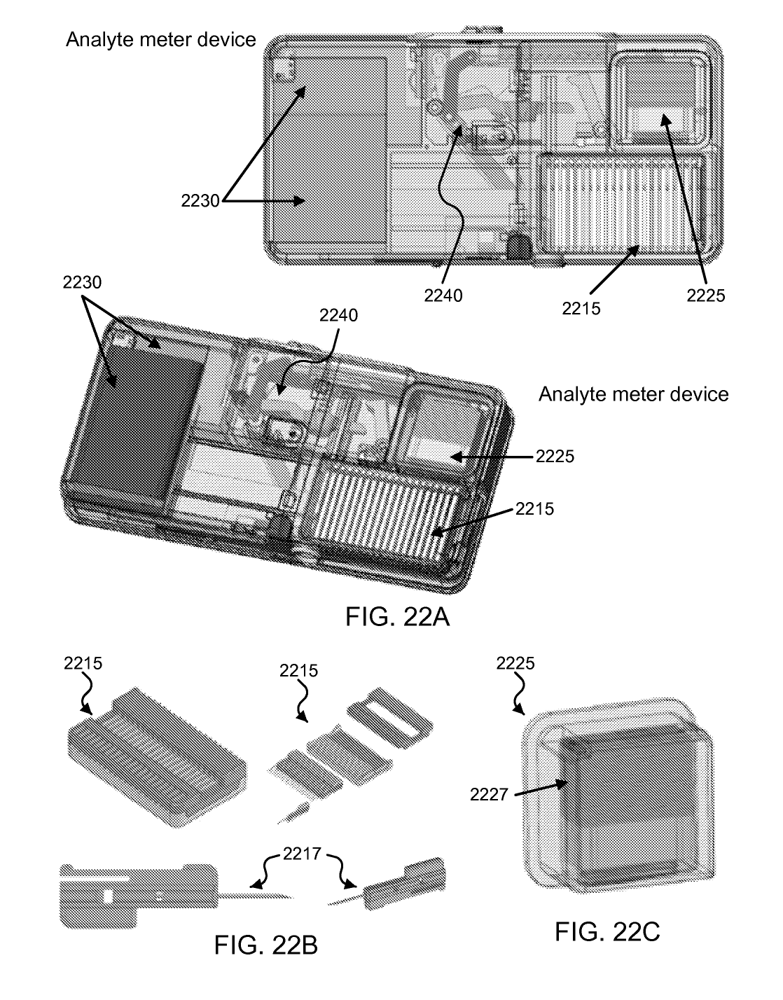

FIG. 22A shows schematic diagrams of an exemplary analyte meter device, e.g., showing some of the internal components of the device. The exemplary analyte meter device includes a housing that contains a compartment for storing a lancet cartridge 2215 and a compartment for storing an analyte sensor cartridge 2225. The exemplary analyte meter device also includes an electronics compartment(s) 2230 for housing electronics components capable of performing several functions, including, but not limited to, a data processing unit; a memory unit in communication with the data processing unit to store data; conversion electronics that are communicatively coupled to the data processing unit and the analyte sensor cartridge 2225, e.g., used in converting a signal from an analyte sensor into readable data (e.g., glucose levels); at least one accelerometer (e.g., used in implementing a pedometer device to track a user's steps); a transmitter and/or receiver to communicate to any of the disclosed devices (e.g., computer systems in the cloud, the computer device 303 via the web portal, and/or the mobile device 302). The exemplary analyte meter device includes an actuator 2240 configured to (i) ready the lancing device (e.g., cock a hammer), (ii) expose the analyte sensor, and (iii) advance the lancet cartridge for use.

In some exemplary embodiments, the actuator 2240 of the analyte meter device can include a mechanism that has a linkage that exposes the analyte sensor, advances the lancet for use, and cocks the hammer, all in a single motion of the actuator. In some exemplary embodiments, the single motion includes pulling or pushing a lever or pressing a button to allow motorized operation of the device. In some exemplary embodiments, the mechanism includes a first link that exposes the analyte sensor, and a second link, different from the first link, that advances the advancing the lancet. For example, exposing of the analyte sensor is preferably done independently relative to advancing the lancet. For example, the mechanism can include a disengagement control that is capable of disengaging the actuator from either exposing the analyze sensor or advancing the lancet.

FIG. 22B shows a view of an exemplary lancet cartridge 2215. The lancet cartridge 2215 can hold a plurality of lancets 2217. For example, a mechanical mechanism of the analyte meter device can contact one of the plurality of lancets 2217, and thus causing the lancet to partially exit the lancet cartridge 2215.

FIG. 22C shows a view of an exemplary analyte sensor cartridge 2225. The sensor cartridge 2225 can hold a plurality of test units 2227 (e.g., test strips). For example, a mechanical mechanism of the analyte meter device can enter an opening or slot on one side of the sensor cartridge 2225 and can push a portion of a test unit 2227 out of the opening, and thus exposing an analyte sensor for use.

It should be noted that some or all of the various user interface functionalities, modules and displays that were described in any of the above figures can be implemented as part of the mobile device user interface, the web portal user interface, and analyte meter device. However, some of the user interface functionalities, modules and displays may be omitted from one of more of the user interfaces of the mobile device, the web portal, and analyte meter device based on policy, implementation efficiency or other considerations.

In one exemplary embodiment, where a patient is prescribed with multiple types of medication (e.g., multiple types of insulin), information associated with each type of medication can be automatically generated and communicated to the appropriate device or database. For example, information related to dosage and time of administration of two different types of insulin can be communicated to the analyte meter device and/or the database. Such information are taken into account when providing different functionalities associated with the disclosed embodiments.

In one exemplary embodiment, the user interface on the web portal includes an additional functionality that allows erasure of the data and/or configuration settings of the analyte meter device. Such a functionality enhances the security of the data that is stored in the analyte meter device since private information can be remotely purged if, for example, the analyte meter is lost or stolen.

In some exemplary embodiments, the exemplary user interface operated on the analyte meter can provide features that can include, but not limited to:
1. Event time stamping and updating to web (e.g., in some examples, the pedometer is updated when a distinct event occurs). The event time stamping and updating to the database can include data from the analyte (e.g., glucose) test, pedometer (e.g., using accelerometer), voice notes (e.g., and other means to add to any tag activity), nutrition information (e.g., carbs, input meal type and number of carbs), insulin/medicine information (e.g., input type and quantity), in which a prescription list can be pulled from a web app for the patient, exercise information (e.g., confirming start time and set duration), patient stress information, patient sick information, and other times of events implemented by any of the devices using the disclosed user interface.
2. Event displaying in a running log.
3. Providing motivational messages and images displayed after test results (e.g., customization fed from web app).
4. Performing temperature checks (e.g., to confirm safe exposure—extreme high or low can damage stored strips).
5. Providing control solutions. In one example of a control solution, a test strip code can be associated to an expected control solution range. For example, the meter register can have a control solution range when a strip is read and automatically confirm device is working properly or displaying range and test result for patients confirmation.
6. Illuminating ports. For example, the analyte meter device can provide illumination to the lancet port and the analyte test strip port or other ports of the device.
7. Monitoring of disposables (e.g., lancets and test strips) inventory. For example, the monitoring of disposables can include the analyte meter device keeping track of unused lancets and test strip in the device, or the data being sent to the database such that a web-based application (web app) keeps track of remaining stock (e.g., packages), contacts (e.g., pings) the meter device when remaining stock is low, and re-orders disposables (e.g., meter communicates to the web app, capable of e-commerce to purchase more disposables from the appropriate vendors).
8. Tutorial animations. For example, the tutorial animation can include, but is not limited to, educating users on testing procedure, touch screen and gestures, and other major features, displaying personal information in case of emergency or if 911 is utilized, and customizing alarm sounds and tones.

In some exemplary embodiments, an exemplary user interface operated on the web portal can provide features that can include, but not limited to:
1. Registering an analyte meter device or devices and enabling customized settings, e.g., including patient information including emergency contact, ideal analyte range, meal times to structure reports, prescriptions, reminders, and pictures, among other settings.
2. Providing a user director for caregivers can caretakers (e.g., parent or family member) viewing of multiple analyte meter users.
3. Data uploading from an analyte meter device at every analyte test or every “x” minutes.
4. Presenting interactive graphical display pages representing a timeline of analyte level readings and activities and other health information data, including voice notes.
5. Re-ordering disposables.
6. Setting alerts to monitor meter activity- testing time, high/low reading alarm.
7. Exporting data in reports, e.g., with various report options and viewing preferences.
8. Providing journal functionality, e.g., including personal notes and snapshots of graphs and data throughout the application interface, which can be associated with a particular event and/or time/date and saved for future reference, as well as be filtered and searched through keywords or data type (e.g., test, voice note, exercise, etc.).

In some exemplary embodiments, an exemplary user interface operated on the mobile device (e.g., a smart phone) can provide features that can include, but not limited to:
1. Providing a user director for caregivers can caretakers (e.g., parent or family member) viewing of multiple analyte meter users.
2. Data uploading from an analyte meter device at every analyte test or every “x” minutes.
3. Presenting interactive graphical display pages representing a timeline of analyte level readings and activities and other health information data, including voice notes. For example, this can include a home page for each analyte meter device user that displays major activity for the day of the user.
4. Re-ordering disposables.
5. Setting alerts to monitor meter activity—testing time, high/low reading alarm.
6. Providing journal functionality.

Other exemplary features can include a horizontal bar to show percentage of test in range, high, and low and icons for activities. Additionally, for example, features can include, but are not limited to, the analyte meter device configured as an all-in-one blood glucose meter, e.g., having lancets, analytical test strips, and the meter in one compact device; alerts that can alert parents/guardian of children patients of every test result or missed test; wireless connectivity (e.g., in which the air time cost can be built into cassette);

customized high/low glucose level thresholds, mealtime clocks, and alerts; auto-set clock with time and date on-screen; night light on analyte meter device, color touch-screen, voice recording functionality (e.g., which can substitute/replace paper journals and allows alignment between meter reading and activity at that point in time); and auto refill notice.

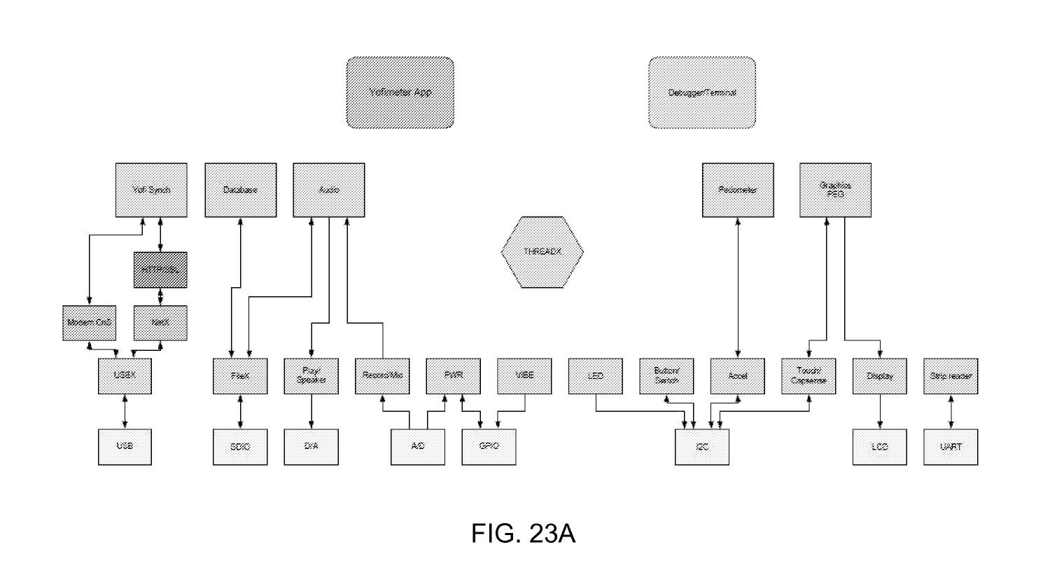

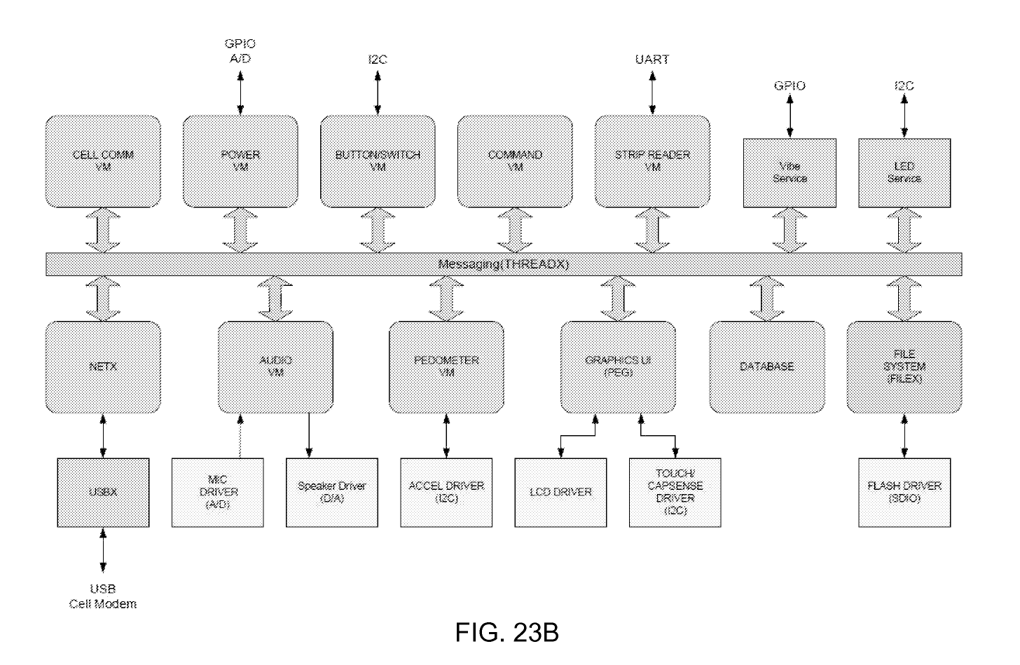

FIGS. 23A and 23B show exemplary software block diagrams for an analyte monitoring system of the disclosed embodiments. The exemplary software block diagrams relate to devices in the analyte monitoring system (e.g., including an exemplary analyte meter device, mobile device, and/or computer device) and can include an operating system, referred to as ThreadX. For example, the exemplary ThreadX operating system can be configured to control the devices or certain functionalities of the devices and applications of the devices in the analyte monitoring systems, e.g., such as those found on a web portal computer device or mobile device. For example, the ThreadX operating system controls system time and offers services, e.g., such as Mutexes, Semaphores, and Messages. The exemplary ThreadX operating system allows multiple threads to operate in parallel and provides synchronization between threads.

The software of the exemplary analyte monitoring system can be configured in several layers. For example, the first layer is the hardware driver layer. At this layer are the drivers to control the hardware interfaces. These can use DMA, interrupts, and register writes for control. The drivers can include, e.g., USB, SDIO, D/A, A/D, GPIO, I2C, LCD, and UART. For example, the next layer of drivers calls the lower level drivers via APIs specific to each interface. Most of these exemplary drivers can have one or more threads. Some of the drivers can be implemented as state machines. These exemplary drivers can include, but are not limited to:
USBX: USB control driver, which allows multiple USB endpoints to be controlled;
FileX: file system;
Play/Speaker: controls the voice playback to the speaker;
Record/Mic: controls the voice record from the microphone;
Power: controls the power states of the device and battery changing and status;
Vibe: turns on the vibration motor;
LED: controls the white LEDs using I2C to control on/off and brightness;
Button/Switch: returns status of the hardware buttons and switches in the exemplary analyte meter using I2C;
Accelerometer: retrieves Accelerometer status and controls its state using I2C;
Touch/Capsense: retrieves status of the touch screen and capsense BACK button using I2C and interrupts;
Display: controls graphics and text output to the LCD; and
Strip reader: interfaces to the strip reader board using the UART.

There are several extra layers for the modem control. For example, these extra software layers can include, but are not limited to:
Modem CnS: cell network control and status;
NetX: network protocol stack; and
HTTP/SSL: Internet protocol and secure communication layer.

On top of the exemplary drivers sits several control functions. For example, these top level drivers can be implemented in at least one thread. These exemplary drivers can include, but are not limited to:
Database: for example, this is where all the glucose readings and event data is stored. It can be stored in the file system and read into memory on power up;
Yofi Synch: for example, this is the control for synchronizing the database to the server. It can be informed of database changes and then send these changes to the server. When it connects to the server, it can receive back any settings changes or software updates. It can also send audio files to the server;
Audio: for example, this controls voice recording and playback and audio file storage and compression;
Pedometer: for example, this uses the accelerometer the count steps. Every hour the step count is stored in the database; and
Graphics/PEG: for example, PEG controls all graphics output and user interaction with the LCD. It can include its own message handler.

In some examples, there are two main applications (app) that run on the exemplary analyte monitoring system. For example, the first exemplary app can be referred to the Yofimeter App. The Yofimeter app can interacts with the various control functions and coordinates their activity. The Yofimeter app can also interface with the Power driver to bring the analyte testing device in and out of sleep. The second exemplary app is the Debugger and Terminal (Debugger/Terminal). For example, using the UART driver, this application allows access to all of the functions in the device. The Debugger/Terminal app can allow automated testing and error logging for debug.

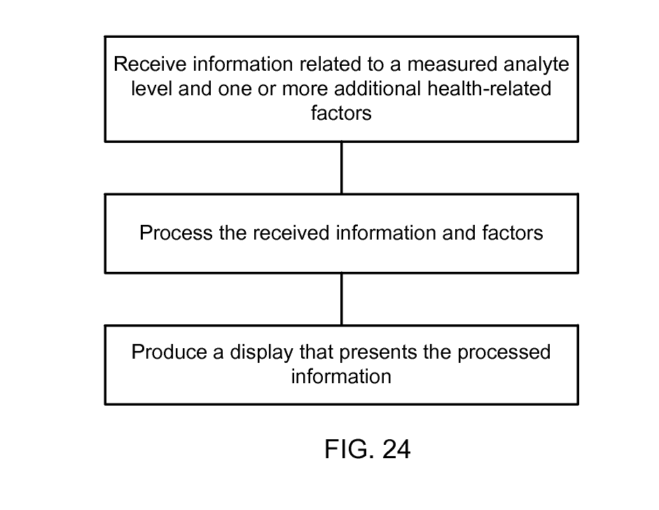

FIG. 24 shows a process diagram of an exemplary method for providing a user interface, e.g., which can present analyte test level data, medication, nutrition, activity, and other health-related information. The method can include a step to receive information related to a patient's measured analyte level(s) and one or more additional health-related factors. The method can include a step to process the received information and factors. The method can include a step to produce an interactive display that presents the processed information graphically with text, images, graphs, tables, audio, and/or video.

Implementations of the subject matter and the functional operations described in this patent document can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media and memory devices, including by way of example semiconductor memory devices, e.g., EPROM, EEPROM, and flash memory devices. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

What is claimed is:

1. A method for presenting patient information on a computing device, comprising:
processing health information of a patient using one or more computer processors of a computer or computer system in a communication network operating a web portal, wherein the health information includes the patient's analyte levels measured from an analyte meter device and health-related factors; and
providing an interactive user interface based on the web portal to present at least some of the processed health information on a computing device of a user and to enable user interaction, the interactive user interface including a plurality of data modules that organize the processed health information,
wherein the data modules include:
an analyte level module to provide one or both of a recent measurement and a history of the measured analyte levels,
a medication module to provide medication data of one or more medications being taken by the patient including at least one of a medication name or identifier, medication type taken, a date and time taken, and a dosage taken,
a nutrition module to provide carbohydrate intake data by the patient, and
a fitness module to provide fitness data including at least one of a number of steps taken or duration of exercise performed by the user.

2. The method as in claim 1, wherein the user includes one of the patient, a healthcare provider, a caregiver, a health data manager, or a healthcare payer.

3. The method as in claim 1, wherein the computing device of the user includes at least one of a desktop or laptop computer device, a mobile communications device including a smartphone or tablet, or the analyte meter device.

4. The method as in claim 1, wherein the interactive user interface enables the user to perform one or more of the following: (1) select a data history of the health information based on a user-selected time span, (2) personalize settings of the analyte meter device, (3) flag particular data of the health information in the data modules, or (4) submit questions related to particular data of the health information in the data modules.

5. The method as in claim 1, further comprising:
receiving patient goal information including a threshold corresponding to the health information in at least one of the data modules; and
processing the patient goal information to analyze the threshold with respect to the corresponding health information.

6. The method as in claim 5, wherein the patient goal information is organized in a goal module of the plurality of data modules.

7. The method as in claim 5, further comprising:
generating an alert when a data value of the health information exceeds the corresponding threshold.

8. The method as in claim 1, wherein the providing the interactive user interface includes displaying on a display screen of the computing device (i) summarized health information for each of the data modules, (ii) a graphical analysis of the health information from one or more of the data modules, and (iii) selection buttons corresponding to the data modules for selection of the health information to be displayed as the graphical analysis.

9. The method as in claim 8, wherein the displayed graphical analysis includes user-interactive tags that allow for the user to add at least one of text, images, or audio data.

10. The method as in claim 1, wherein the medication data of the medication module includes instructions for taking the one or more medications by the patient.

11. The method as in claim 1, further comprising:
acquiring, from the analyte meter device to the computer or computer system in the communication network via a communications link, step data collected by a pedometer unit of the analyte meter device that records the number of steps taken by the patient,
wherein the acquired step data is organized in the fitness module.

12. The method as in claim 1, wherein the plurality of data modules includes a journal module to provide journal data including one or both of (i) user input data including text, images, or audio data and (ii) a snapshot image of the interactive user interface displayed on a display screen of the computing device.

13. The method as in claim 12, wherein the providing the interactive user interface includes displaying on a display screen of the computing device (i) a dialog box to allow a user to enter text of the user input data, (ii) a listing of the journal data having a corresponding time and date to when the journal data was entered in the journal module, and (iii) a search box to allow a user to enter text to be searched in the journal data or select a keyword from a list of keywords to be searched in the journal data.

14. The method as in claim 1, wherein the plurality of data modules includes a report module to export at least some of the health information based on user selection to an external file including tables, textual descriptions, graphs, or combinations thereof, wherein the user selects a time period and type of the health information to be included in the external file.

15. The method as in claim 14, wherein providing the interactive user interface includes displaying on a display screen of the computer device a selectable list of report formats that include predetermined health information to be included in the external file.

16. The method as in claim 1, wherein the measured analyte levels include blood glucose levels and the one or more medications include insulin.

17. The method as in claim 16, wherein the processing the health information includes analyzing the health information to determine a correlation between actual measured glucose levels and their level of fluctuations and a correlation between the actual measured glucose levels and the health-related factors including one or more of carbohydrate consumption, amount of injected insulin, non-insulin medications taken by the patient, amount of exercise, an episode of stress, or an episode of an illness.

18. The method as in claim 17, further comprising:
processing the correlation to generate an alert when a particular data value exceeds a predetermined threshold.

19. The method as in claim 18, wherein the particular data value includes the blood glucose level.

20. The method as in claim 18, wherein the alert is in form of one or more of a text message, a phone call, an email, or a visual message or audio alarm on an application of the computing device or the analyte meter device.

21. The method as in claim 17, comprising:
processing the correlation to generate an alert when an event does not occur when expected.

22. The method as in claim 1, further comprising:
monitoring, by the computer or computer system in the communication network of the analyte meter device via a communications link, the amount of consumable components in the analyte meter device.

23. The method as in claim 22, further comprising:
determining when the amount of consumable components reaches a predetermined minimum threshold; and
ordering a quantity of the consumable components based on the amount,
wherein the ordering is performed by at least one of the analyte meter device, the computer or the computer system operating the web portal, or a mobile computer device operating an application in communication with the web portal.

24. The method as in claim 1, further comprising:
monitoring, by the computer or computer system in the communication network of the analyte meter device via a communications link, location information of the analyte meter device;
recognizing when the analyte meter device enters a different time zone; and
updating programmed alerts and time stamping information based on the different time zone.

25. The method as in claim 1, further comprising:
transmitting, from the computer or computer system in the communication network via a communications link, data updates of data of the web portal to the analyte meter device, the data updates including at least one of prescription information, dietary information, patient goal information, or user settings or profile information.

26. The method as in claim 1, wherein the interactive user interface includes a patient-accessible interface for access by the patient to manage the health information of the patient, and a caregiver-accessible interface for access by a healthcare provider or caregiver to manage the health information of the patient and one or more other patients.

27. The method as in claim 1, wherein the interactive user interface is an integrated graphical and audio user interface.

28. A computer program product comprising a computer-readable storage medium having code stored thereon, the code, when executed, causing a processor of a computer or computer system in a communication network to implement a method for presenting patient information on a user device via a web portal, wherein the computer program product is operated by the computer or computer system to implement the method comprising:
processing health information of a patient including analyte levels measured from an analyte meter device and health-related factors, wherein the health information is acquired by the computer or computer system in the communication network via a communications link; and
providing an interactive user interface based on the web portal to present at least some of the processed health information on a computing device operated by a user and to enable user interaction, the interactive user interface including a plurality of data modules that organize the processed health information,
wherein the data modules include:
an analyte level module to provide one or both of a recent measurement and a history of the measured analyte levels,
a medication module to provide medication data of one or more medications being taken by the patient including at least one of a medication name or identifier, medication type taken, a date and time taken, and a dosage taken,
a nutrition module to provide carbohydrate intake data by the patient, and
a fitness module to provide fitness data including at least one of a number of steps taken or duration of exercise performed by the user.

29. The computer program product as in claim 28, wherein the providing the interactive user interface includes displaying on a display screen of the computing device (i) summarized health information for each of the data modules, (ii) a graphical analysis of the health information from one or more of the data modules, (iii) a selection list of tags corresponding to the data modules that allow for the user to add at least one of text, images, or audio data as time-tagged data presented proximate the graphical analysis, and (iv) selection buttons corresponding to the data modules for selection of the health information to be displayed as the graphical analysis.

30. The computer program product as in claim 28, wherein the plurality of data modules includes a journal module to provide journal data including one or both of (i) user input data including text, images, or audio data and (ii) a snapshot image of the interactive user interface displayed on a display screen of the computing device.

31. The computer program product as in claim 30, wherein the providing the interactive user interface includes displaying on a display screen of the computing device (i) a dialog box to allow a user to enter text of the user input data, (ii) a listing of the journal data having a corresponding time and date to when the journal data was entered in the journal module, and (iii) a search box to allow a user to enter text to be searched in the journal data or select a keyword from a list of keywords to be searched in the journal data.

32. The computer program product as in claim 28, wherein the plurality of data modules includes a report module to export at least some of the health information based on user selection to an external file including tables, textual descriptions, graphs, or combinations thereof, wherein the user selects a time period and type of the health information to be included in the external file.

33. The computer program product as in claim 32, wherein providing the interactive user interface includes displaying on a display screen of the computer device a selectable list of report formats that include predetermined health information to be included in the external file.

34. A health management system, comprising:
an analyte monitoring device to measure a concentration level of an analyte;
a computing device including at least one of a desktop computer, a laptop computer, or a mobile communications device including a smartphone or tablet; and
a computing system in communication with the analyte monitoring device and the computing device, the computing system comprising a memory unit, and a processor configured to process data including health information of a patient comprising measured analyte concentration levels and health-related factors,
wherein the computing system is configured to provide an interactive user interface to present at least some of the processed health information on the computing device of a user and enable user interaction, the interactive user interface including a plurality of data modules that organize the processed health information, the data modules including:
an analyte level module to provide one or both of a recent measurement and a history of the measured analyte levels,
a medication module to provide medication data of one or more medications being taken by the patient including at least one of a medication name or identifier, medication type taken, a date and time taken, and a dosage taken,
a nutrition module to provide carbohydrate intake data by the patient, and
a fitness module to provide fitness data including at least one of a number of steps taken or duration of exercise performed by the user.

35. The system as in claim 34, wherein the user includes one of the patient, a healthcare provider, a caregiver, a health data manager, or a healthcare payer.

36. The system as in claim 34, wherein the interactive user interface presented by the computer system enables the user to perform one or more of the following: (1) select a data history of the health information based on a user-selected time span, (2) personalize settings of the analyte meter device, (3) flag particular data of the health information in the data modules, or (4) submit questions related to particular data of the health information in the data modules.

37. The system as in claim 34, wherein the computer system is configured to display on a display screen of the computing device one or more of the following: (i) summarized health information for each of the data modules, (ii) a graphical analysis of the health information from one or more of the data modules, (iii) a selection list of tags corresponding to the data modules that allow for the user to add at least one of text, images, or audio data as time-tagged data presented proximate the graphical analysis, and (iv) selection buttons corresponding to the data modules for selection of the health information to be displayed as the graphical analysis.

38. The system as in claim 34, wherein the plurality of data modules includes a journal module to provide journal data including one or both of (i) user input data including text, images, or audio data and (ii) a snapshot image of the interactive user interface displayed on a display screen of the computing device.

39. The system as in claim 38, wherein the computer system is configured to display on a display screen of the computing device (i) a dialog box to allow a user to enter text of the user input data, (ii) a listing of the journal data having a corresponding time and date to when the journal data was entered in the journal module, and (iii) a search box to allow a user to enter text to be searched in the journal data or select a keyword from a list of keywords to be searched in the journal data.

40. The system as in claim 34, wherein the plurality of data modules includes a report module to export at least some of the health information based on user selection to an external file including tables, textual descriptions, graphs, or combinations thereof, wherein the user selects a time period and type of the health information to be included in the external file.

41. The system as in claim 40, wherein the computer system is configured to display on a display screen of the computing device a selectable list of report formats that include predetermined health information to be included in the external file.
